(19) United States
(12) Patent Application Publication
(10) Pub. No.: US 2025/0113788 A1
(43) Pub. Date: Apr. 10, 2025

(54) WATERING SYSTEM AND CONTROL DEVICE

(71) Applicant: DENSO CORPORATION, Kariya-city (JP)

(72) Inventors: Naoya USHIGOME, Kariya-city (JP); Yusuke HIRONO, Kariya-city (JP); Naohisa NIIMI, Kariya-city (JP); Norihiro KURUMADO, Kariya-city (JP)

(21) Appl. No.: 18/982,387

(22) Filed: Dec. 16, 2024

Related U.S. Application Data
(63) Continuation of application No. PCT/JP2023/022625, filed on Jun. 19, 2023.

(30) Foreign Application Priority Data
Jun. 20, 2022 (JP) 2022-098721
Oct. 4, 2022 (JP) 2022-160454

(51) Int. Cl. A01G 25/16

(52) U.S. Cl. CPC A01G 25/165

(57) ABSTRACT

A watering system includes a pF sensor, a VWC sensor, and a control device that controls an irrigation operation. The control device controls the irrigation using the pF value detected by the pF sensor and the volume water content detected by the VWC sensor. The control device controls a start timing of the irrigation operation based on the pF value that is detected and a start threshold value. The control device controls a stop timing of the irrigation operation, which is in operation, based on the volume water content that is detected and a stop threshold value. The control device updates the stop threshold value based on fluctuation of the pF value that is detected.

### CROSS REFERENCE TO RELATED APPLICATION

The present application is a continuation application of International Patent Application No. PCT/JP2023/022625 filed on Jun. 19, 2023, which designated the U.S. and claims the benefit of priority from Japanese Patent Application No. 2022-160454 filed on Oct. 4, 2022 and Japanese Patent Application No. 2022-098721 filed on Jun. 20, 2022. The entire disclosures of all of the above applications are incorporated herein by reference.

### TECHNICAL FIELD

The present disclosure relates to a watering system and a control device for controlling supply of water to the soil.

### BACKGROUND

An automatic watering system performs first irrigation at start of prescribed period after seeding, and performs second and subsequent irrigation from the next day or later until end of the prescribed period. A processor determines timings of second and subsequent irrigation.

### SUMMARY

According to an aspect of the present disclosure, a watering system includes: a water supply path supplied with water to be released to a plant; a pF sensor that detects a pF value, which is an environment value related to a soil condition; a VWC sensor that detects a volume water content, which is an environment value related to a soil condition; and a control device that controls an irrigation operation of releasing water to a plant via the water supply path using the pF value detected by the pF sensor and the volume water content detected by the VWC sensor. The control device controls a start timing of the irrigation operation based on the pF value that is detected and a start threshold value, and controls a stop timing of the irrigation operation that is in operation based on the volume water content that is detected and a stop threshold value, and the control device updates the stop threshold value based on fluctuation of the pF value that is detected.

### BRIEF DESCRIPTION OF DRAWINGS

FIG. 1 is a configuration diagram of a watering system of a first embodiment.

FIG. 2 is a block diagram illustrating a monitoring unit that is an example of a control device.

FIG. 3 is a water supply path diagram illustrating a water source valve and various sensors.

FIG. 4 is a flowchart showing an example of an operation of the watering system.

FIG. 5 is a time chart showing control related to irrigation start and stop.

FIG. 6 is a view illustrating an example of moisture retention characteristic information obtained from a measurement value.

FIG. 7 is a view illustrating an example of moisture retention characteristic information obtained from a measurement value.

FIG. 8 is a flowchart showing an operation of the watering system of a second embodiment.

FIG. 9 is a water supply path diagram illustrating a water source valve of a third embodiment and various sensors.

FIG. 10 is a water supply path diagram illustrating a water source valve of a fourth embodiment and various sensors.

FIG. 11 is a configuration diagram of a watering system of a fifth embodiment.

FIG. 12 is a block diagram illustrating a monitoring unit.

FIG. 13 is a cross-sectional view illustrating a valve device applicable as a water source valve.

FIG. 14 is a view illustrating a configuration of a drive unit included in the valve device.

FIG. 15 is a perspective view illustrating a valve included in the valve device.

FIG. 16 is a view illustrating a relationship between a rotation angle and a flow rate in the valve device.

FIG. 17 is a water supply path diagram illustrating a relationship between the water source valve and the various sensors.

FIG. 18 is a flowchart showing an example of an operation at the time of an irrigation command.

FIG. 19 is a flowchart showing an example of an operation at the time of an irrigation command.

FIG. 20 is a flowchart showing an example of an operation at the time of an irrigation command.

FIG. 21 is a water supply path diagram illustrating a relationship between a water source valve in a sixth embodiment and various sensors.

FIG. 22 is a block diagram illustrating a monitoring unit of a sixth embodiment.

FIG. 23 is a flowchart showing an operation at the time of an irrigation command in a seventh embodiment.

FIG. 24 is a flowchart showing an operation at the time of an irrigation command in an eighth embodiment.

FIG. 25 is a flowchart showing an operation at the time of an irrigation command in a ninth embodiment.

FIG. 26 is a flowchart showing an operation at the time of an irrigation command in a tenth embodiment.

FIG. 27 is a water supply path diagram illustrating a relationship between a water source valve in an eleventh embodiment and various sensors.

FIG. 28 is a block diagram illustrating a monitoring unit of an eleventh embodiment.

FIG. 29 is a water supply path diagram illustrating a relationship between a water source valve in a twelfth embodiment and various sensors.

### DESCRIPTION OF EMBODIMENTS

There is a technique for enabling irrigation timing to be determined without measuring a moisture content in the soil in the field and quantity of solar radiation to the field. An automatic watering system performs first irrigation at start of prescribed period after seeding, and performs second and subsequent irrigation from the next day or later until end of the prescribed period. A processor determines timings of second and subsequent irrigation, by using: value obtained by subtracting a first supply amount that is an amount of supplied water in the first irrigation, from the maximum irrigation amount; and the disappearance amount.

There is an irrigation control method for measuring oxygen density in the soil, and if the measured oxygen density becomes equal to or less than a prescribed value, irrigation is suppressed. There is an irrigation method for supplying water to the field from a water source outside the field and adjusts a soil temperature to a specified temperature.

In the above-described technique, there is room for improvement in terms of performing irrigation operation control suitable for the soil condition. In order to eliminate factors that adversely affect the plant, this description proposes control at the time of an irrigation command.

The present disclosure provides a watering system and a control device that can perform irrigation operation control suitable for a soil condition.

The present disclosure provides a watering system and a control device that can perform irrigation with suppressed adverse effects on growth of the plant.

The plural aspects disclosed in this description employ different technical means to achieve the respective objectives. The reference signs in parentheses described in the scope of claims are examples indicating a correspondence relationship with specific means described in embodiments described later as one aspect, and do not limit the technical scope.

According to an aspect of the present disclosure, a watering system includes: a water supply path supplied with water to be released to a plant; a pF sensor that detects a pF value, which is an environment value related to a soil condition; a VWC sensor that detects a volume water content, which is an environment value related to a soil condition; and a control device that controls an irrigation operation of releasing water to a plant via the water supply path using the pF value detected by the pF sensor and the volume water content detected by the VWC sensor. The control device controls a start timing of the irrigation operation based on the pF value that is detected and a start threshold value, and controls a stop timing of the irrigation operation that is in operation based on the volume water content that is detected and a stop threshold value, and the control device updates the stop threshold value based on fluctuation of the pF value that is detected.

According to this, by updating the stop threshold value related to VWC using the pF value useful as an environment value of the soil condition, it is possible to provide irrigation operation reflected to the VWC having good irrigation responsiveness. Therefore, this watering system can perform irrigation operation control suitable for the soil condition by controlling the irrigation stop timing in which the pF value and the VWC are associated with each other.

According to an aspect of the present disclosure, a control device includes: an acquisition unit that acquires a pF value, which is an environment value related to a soil condition, detected by a pF sensor, and a volume water content, which is an environment value related to a soil condition, detected by a VWC sensor; and a processor that controls an irrigation operation of releasing water to a plant via a water supply path using the pF value detected by the pF sensor and the volume water content detected by the VWC sensor. The processor controls a start timing of the irrigation operation based on the pF value that is detected and a start threshold value, and controls a stop timing of the irrigation operation that is in operation based on the volume water content that is detected and a stop threshold value, and the processor updates the stop threshold value based on fluctuation of the pF value that is detected.

According to this control device, by updating the stop threshold value related to VWC using the pF value useful as an environment value of the soil condition, it is possible to provide irrigation operation reflected to the VWC having good irrigation responsiveness. Therefore, this control device can perform irrigation operation control suitable for the soil condition by controlling the irrigation stop timing in which the pF value and the VWC are associated with each other.

According to an aspect of the present disclosure, a watering system includes: a water supply path supplied with irrigation to be released to a plant; a temperature sensor that detects a temperature of the water supply path; a ground temperature sensor that detects a ground temperature; and a control device that controls an irrigation amount using a ground temperature detected by the ground temperature sensor and a temperature detected by the temperature sensor.

According to this watering system, the irrigation amount is controlled using the temperature of the water supply path and the ground temperature related to the water supply temperature. Therefore, it is possible to perform control in which the irrigation amount is changed between a case where the temperature of the water supply path is high and a case where the temperature of the water supply path is low with respect to the ground temperature. Therefore, when it is predicted that the water supply temperature adversely affects the growth of the plant, this watering system can perform irrigation for suppressing this.

According to an aspect of the present disclosure, at a timing of performing irrigation, the control device prohibits irrigation when the ground temperature exceeds a temperature of the water supply path and the temperature of the water supply path falls below an irrigation suppression threshold value, and performs irrigation when the ground temperature is equal to or less than the temperature of the water supply path or when the ground temperature exceeds the temperature of the water supply path and the temperature of the water supply path exceeds the irrigation suppression threshold value.

According to this watering system, it is possible to suppress irrigation when the temperature of the water supply path is a low temperature that does not rise to the ground temperature, and it is possible to postpone the irrigation until the time when the temperature of the water supply path rises. On the other hand, when the temperature of the water supply path exceeds the ground temperature, or when the ground temperature exceeds the temperature of the water supply path and the temperature of the water supply path exceeds an irrigation suppression threshold value, it is possible to, by performing irrigation, achieve appropriate moisture supply that promotes growth while suppressing adverse effects on the growth of the plant. Therefore, this watering system can perform irrigation with suppressed adverse effects on growth of the plant.

According to an aspect of the present disclosure, at a timing of performing irrigation, the control device performs irrigation after draining retained water in the water supply path without releasing the retained water to the plant when a temperature of the water supply path exceeds a drainage threshold value, and performs irrigation containing the retained water when the temperature of the water supply path falls below the drainage threshold value.

According to this watering system, it is possible to perform appropriate-temperature irrigation after draining high-temperature retained water without releasing the retained water to the plant when the temperature of the water supply path exceeds a drainage threshold value. On the other hand, by performing irrigation containing appropriate-temperature retained water when the temperature of the water supply path falls below the drainage threshold value, it is possible to achieve appropriate moisture supply that promotes growth while suppressing adverse effects on the growth of the plant. Therefore, this watering system can also perform irrigation with suppressed adverse effects on growth of the plant.

According to an aspect of the present disclosure, a control device includes: a processor that determines whether to perform irrigation using a temperature of a water supply path supplied with irrigation to be released to a plant and a ground temperature; and a signal output unit configured to: at a timing of performing irrigation, output a signal to prohibit irrigation when the processor determines that the ground temperature exceeds the temperature of the water supply path and the temperature of the water supply path falls below an irrigation suppression threshold value; and output a signal to prohibit irrigation when the processor determines that the ground temperature is equal to or less than the temperature of the water supply path, and outputs a signal to perform irrigation when the processor determines that the ground temperature is equal to or less than the temperature of the water supply path, or when the processor determines that the ground temperature exceeds the temperature of the water supply path and the temperature of the water supply path exceeds the irrigation suppression threshold value.

According to this control device, it is possible to suppress irrigation when the temperature of the water supply path is a low temperature that does not rise to the ground temperature, and it is possible to postpone the irrigation until the time when the temperature of the water supply path rises. On the other hand, when the temperature of the water supply path is higher than the ground temperature, or when the ground temperature exceeds the temperature of the water supply path and the temperature of the water supply path exceeds the irrigation suppression threshold value, control of performing irrigation makes it possible to achieve appropriate moisture supply that promotes growth while suppressing adverse effects on the plant. Therefore, this control device can perform irrigation with suppressed adverse effects on growth of the plant.

According to an aspect of the present disclosure, a control device includes: a processor that determines whether to perform irrigation using a temperature of a water supply path supplied with irrigation to be released to a plant; and a signal output unit configured to: at a timing of performing irrigation, output a signal to perform irrigation after outputting a signal to drain retained water in the water supply path without releasing the retained water to the plant when the processor determines that the temperature of the water supply path exceeds a drainage threshold value; and output a signal to perform irrigation containing the retained water when the processor determines that the temperature of the water supply path falls below the drainage threshold value.

According to this control device, it is possible to perform appropriate-temperature irrigation after draining high-temperature retained water without releasing the retained water to the plant when the temperature of the water supply path exceeds the drainage threshold value. On the other hand, by control of performing irrigation containing appropriate-temperature retained water when the temperature of the water supply path falls below the drainage threshold value, it is possible to achieve appropriate moisture supply that promotes growth while suppressing adverse effects on the growth of the plant. Therefore, this control device can also perform irrigation with suppressed adverse effects on growth of the plant.

Embodiments for carrying out the present disclosure will be described below with reference to the drawings. In each embodiment, parts corresponding to the matters described in the preceding embodiments are given identical reference signs, and redundant description may be omitted. In a case where only a part of the configuration is described in each embodiment, other parts of the configuration can be applied with other embodiments described above. It is possible not only to combine the parts that are explicitly described to be specifically combinable in each embodiment but also to partially combine the embodiments even if not explicitly described as long as there is no problem in the combination.

### First Embodiment

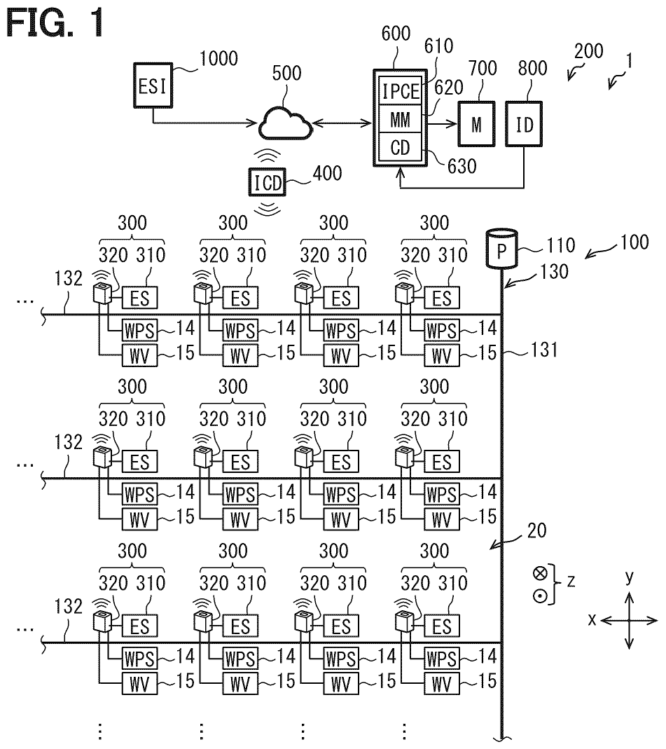

The first embodiment disclosing an example of a watering system will be described with reference to FIGS. 1 to 7. Hereinafter, three directions in an orthogonal relationship with one another are indicated as an x direction, a y direction, and a z direction. In this description, a plane defined by the x direction and the y direction is along a horizontal plane. The z direction is along the vertical direction.

### FIELD

A watering system 1 is applied to a field 20 that is outdoor cultivated in a hill or a plain. As illustrated in FIG. 1, the watering system 1 is applied to the field 20 cultivated in a plain. The field 20 is provided with growth places such as ridges extending in the x direction. The growth places extending in the x direction are arranged apart from one another in the y direction. Plant seeds and seedlings are buried in each of the growth places. The watering system 1 may have a configuration to be applied to the field 20 provided indoor such as a greenhouse. Therefore, the field 20 in this description can be applied to soil provided outdoor or indoor.

Plants are grown in one growth place. One growth place is a ridge where plural plants are grown. The plants are arranged in one row in the x direction. Hereinafter, the plants arranged in a row in the x direction is called a plant group. In the field 20, plural plant groups are arranged apart in the y direction. The shortest separation distance in the y direction of the plant groups is longer than the shortest separation distance in the x direction of the plants included in one plant group. The separation interval in the y direction of the plant groups is variously changed depending on the type of the growing plant and the undulations and climate of the field 20. Even if branches of the plant grow thick in the y direction, at least a width that allows a person to move in the x direction between two plant groups is secured.

### <Irrigation System>

The watering system 1 includes a water supply device 100 and a control device 200. The water supply device 100 supplies irrigation water to a plant in the field 20. The control device 200 determines a supply time and an amount of the irrigation water supplied from the water supply device 100 to the plant during an irrigation period. The control device 200 determines an irrigation schedule of the water supply device 100.

### <Water Supply Device>

The water supply device 100 includes a pump 110 and a water supply pipe 130. The pump 110 is a water supply source that causes irrigation water to flow down to the water supply pipe 130.

### <Pump>

The pump 110 is in a constantly driven state. Alternatively, the pump 110 is in a daytime driven state. Driving and stopping of the pump 110 are controlled by the control device 200. The pump 110 pumps out irrigation water stored in a tank or a reservoir and supplies the irrigation water to the water supply pipe 130. Examples of the irrigation water include well water, river water, rainwater, and tap water. The water supply pipe 130 is provided with water source valves 15 that can control a flow rate of irrigation water to be discharged to the field 20. When these water source valves 15 are in a closed state and no irrigation water is leaked from the water supply pipe 130, the water supply pipe 130 is filled with the irrigation water. At this time, the water pressure in the water supply pipe 130 becomes a value (hereinafter, pump pressure) dependent of a discharge capacity of the pump 110. When the water source valve 15 is brought into an open state from the closed state, the irrigation water is discharged from the water supply pipe 130 to the field 20. When a discharge amount of the irrigation water is stabilized on a time average, the water pressure in the water supply pipe 130 becomes a flow pressure that is lower in water pressure than the pump pressure.

### <Water Supply Pipe>

The water supply pipe 130 includes a main pipe. The main pipe is coupled to the pump 110. The pump 110 supplies the main pipe with irrigation water. The irrigation water is supplied to the field 20 via the main pipe.

### <Main Pipe>

The main pipe includes a vertical pipe 131 and a first coupling pipe 132. The vertical pipe 131 extends in the y direction. The first coupling pipe 132 extends in the x direction. The vertical pipe 131 and the first coupling pipe 132 are coupled to each other. With such a configuration, the irrigation water flows in the y direction and the x direction through the main pipe. In the example illustrated in FIG. 1, one vertical pipe 131 is coupled to one pump 110. The first coupling pipes 132 extend from the vertical pipe 131 extending in the y direction.

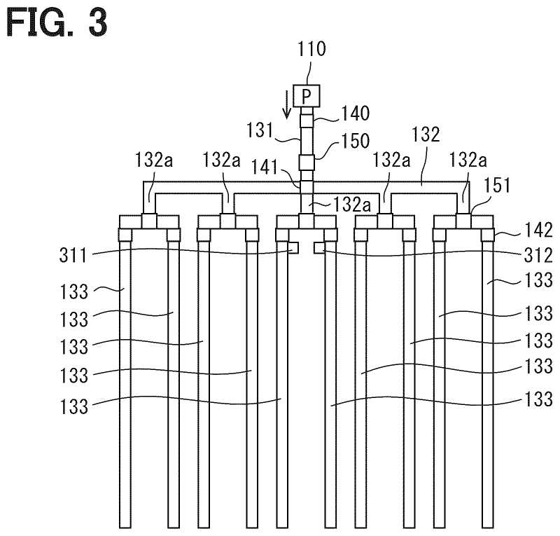

The configuration of the water supply path illustrated in FIGS. 1 and 3 is merely an example of a passage configuration related to irrigation. The number of the pumps 110 and the vertical pipes 131 provided in the field 20, the number of the vertical pipes 131 coupled to one pump 110, the number of the vertical pipes 131 coupled to one first coupling pipe 132, and the positions in the z direction of the first coupling pipe 132 and the vertical pipes 131 are not particularly limited.

The first coupling pipes 132 are arranged apart from one another in the y direction. The shortest separation distance in the y direction of the first coupling pipes 132 is set to be equal to the shortest separation distance in the y direction of the plant groups. One of the first coupling pipes 132 is provided corresponding to one of the plant groups. The first coupling pipe 132 extends along a direction in which the plants included in the plant group are arranged. A supply pipe is coupled to this first coupling pipe 132.

The watering system 1 includes distribution tubes 133 through which irrigation water is released more downstream in the water supply path than the first coupling pipe 132. Each distribution tube 133 is an example of a supply pipe for supplying irrigation water to the plant in the field 20. Each distribution tube 133 is installed at a position where irrigation water can be supplied to a ridge provided in the field 20. The distribution tube 133 may be configured to have a pressure correction mechanism that achieves a constant discharge amount regardless of a water pressure change, or may be configured not to have the pressure correction mechanism.

In the distribution tube 133, through holes causing the inside and the outside of the tube through which irrigation water flows to communicate with each other is formed. The through holes are provided side by side at predetermined intervals in an axial direction of the tube in each tube. The through holes may be configured to be provided side by side at predetermined intervals in a circumferential direction of the tube in each tube. The separation interval in the axial direction of the through holes (e.g., the x direction) is equal to the separation interval in the x direction of the plants. The separation interval of the through holes and the separation interval of the plants may be different.

### <Flow of Irrigation Water>

The irrigation water supplied to the vertical pipe 131 by the pump 110 flows through the vertical pipe 131. This irrigation water is supplied to each of the first coupling pipes 132 coupled to the vertical pipe 131. The irrigation water flows through each of the first coupling pipes 132. The irrigation water flowing through the first coupling pipe 132 flows down to the distribution tube 133 via a branch pipe 132a. The irrigation water is discharged from each through hole in the distribution tube 133 and supplied to the plant. The irrigation water supplied from each through hole of the distribution tube 133 is supplied mainly to a trunk or a root of the plant. The through hole is provided at a position higher than a part facing the ground in each distribution tube 133, for example. In this case, the irrigation water discharged from the through hole spreads in a direction radiating with respect to a center axis of the distribution tube 133, and can be sprayed to a position away from the tube.

### <Water Supply Valve>

The water source valve 15 is provided more upstream than the distribution tube 133 in the water supply path. When the water source valve 15 is brought into the open state, the water supply pipe 130 and each through hole of the distribution tube 133 communicate with each other. Due to this, irrigation water is discharged from the through hole. On the other hand, when the water source valve 15 is brought into the closed state, communication between the water supply pipe 130 and each through hole of the distribution tube 133 is interrupted. This stops the discharge of irrigation water from the through hole.

When the control device 200 controls a valve opening degree, the water source valve 15 controls the flow rate of the irrigation water to be discharged from the through hole of the distribution tube 133. The control device 200 controls the valve opening degree of the water source valve 15 to an arbitrary value from a predetermined opening degree to full opening. The water source valve 15 is a flow regulating valve or a pressure regulating valve that can precisely vary the flow rate passing therethrough by regulating the downstream or upstream pressure. The predetermined opening degree is set to a slightly opened opening degree or an opening degree of 0%, that is, a value including full close.

By controlling the valve opening degree of the water source valve 15, the control device 200 controls a discharge flow rate or a discharge flow velocity per unit time discharged from each through hole of the distribution tube 133. The control device 200 can control a water flying distance, which is a distance at which the irrigation water discharged from the distribution tube 133 lands away from the distribution tube 133, or a discharge amount. The water flying distance is a distance between a soil landing point of irrigation water flying out of the distribution tube 133 through the through hole and the distribution tube 133. According to the technology for controlling this water flying distance, it is possible to perform efficient irrigation to a place needing irrigation and also contribute to water saving. The water source valve 15 is an on-off valve that controls flowing down of water supply and interruption of water supply, and functions as a flow regulating valve that can control a water supply flow rate.

For example, the valve opening degree of the water source valve 15 is controlled to increase the water flying distance in a case where the plant has a wide root or a plowed soil layer is shallow and wide. The valve opening degree of the water source valve 15 is controlled so as to suppress the water flying distance to be small in a case where the plant roots deeply or the plowed soil layer is positioned near the distribution tube 133. The water flying distance can be paraphrased as an irrigation distance.

### <Water Pressure Sensor>

A water pressure sensor 14 is provided in a pipe included in the water supply pipe 130. The water pressure sensor 14 is a pressure sensor that detects a water pressure in the pipe. The water pressure detected by the water pressure sensor 14 is output to the control device 200. The water pressure sensor 14 is installed at a site more upstream than the distribution tube 133 in the water supply path. Furthermore, the water pressure sensor 14 may be configured to be installed at a site more downstream than the distribution tube 133 in the water supply path.

When the water source valve 15 is brought into the closed state and the pipe is filled with irrigation water, the water pressure sensor 14 detects the pump pressure. When the water source valve 15 is brought into the open state from the closed state, the irrigation water is discharged from the distribution tube 133. When a discharge amount of the irrigation water is stabilized on a time average, the water pressure sensor 14 detects the flow pressure. When the water source valve 15 is brought into the closed state from the open state, the discharge of irrigation water from water supply pipe 130 is stopped. The water pressure in the water supply pipe 130 gradually recovers from the flow pressure to the pump pressure. The water pressure sensor 14 detects the water pressure in a transition period in which the flow pressure gradually recovers to the pump pressure. The watering system 1 may be configured to include a flow rate sensor that detects the flow rate of the fluid flowing through the passage in place of the water pressure sensor 14. The watering system 1 performs feedback control of the valve opening degree of the water source valve 15 using detection values of the water pressure sensor 14 and the flow rate sensor.

### <Control Device>

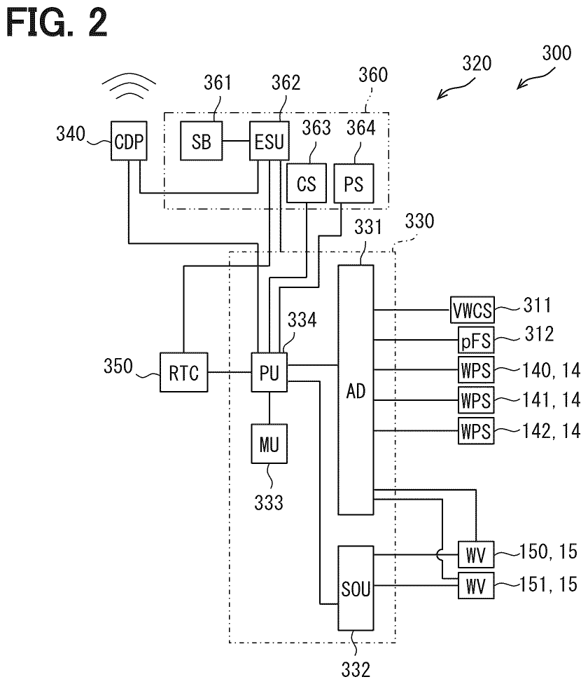

As illustrated in FIGS. 1 and 2, the control device 200 includes a monitoring unit 300, an integrated communication unit 400, an information storage unit 500, and an integrated calculation unit 600. In the drawings, the integrated communication unit 400 is denoted as ICD. The control device 200 includes the monitoring units 300. Each of the monitoring units 300 corresponds to a predetermined divided area assigned in the field 20. The divided area is assigned with, for example, a singular or a plurality of ridges.

The water pressure detected by the water pressure sensor 14 is input to the monitoring unit 300. The monitoring unit 300 detects an environment value that is a physical quantity related to the environment of the field 20. Each monitoring unit 300 outputs the water pressure and the environment value to the integrated communication unit 400 by wireless communication.

The integrated communication unit 400 outputs, to the information storage unit 500 by wireless communication, the water pressure and the environment value input from each monitoring unit 300. The information storage unit 500 stores the water pressure and the environment value. An example of the information storage unit 500 is what is called a cloud. The integrated calculation unit 600 reads various pieces of information such as the water pressure and the environment value stored in the information storage unit 500. The integrated calculation unit 600 appropriately processes the various pieces of information that are read, and displays the various pieces of information and processing results on a monitor 700 of a user's smartphone or personal computer.

The integrated calculation unit 600 is included in the user's smartphone, personal computer, or the like. The integrated calculation unit 600 includes information processing calculation equipment 610, a memory 620, and a communication device 630. In the drawings, the information processing calculation equipment 610 is denoted as IPCE, the memory 620 is denoted as MM, and the communication device 630 is denoted as CD. The information processing calculation equipment 610 includes a processor. The information processing calculation equipment 610 performs calculation processing related to irrigation operation control processing. Such a function is achieved by downloading an irrigation application program to the information processing calculation equipment 610. The integrated calculation unit 600 may be a calculation device mounted on a cloud. In this case, the integrated calculation unit 600 and the information storage unit 500 may be configured to be mounted together on the cloud.

The memory 620 is a non-transitory tangible storage medium that non-transitorily stores various programs and various types of information readable by a computer or a processor. The memory 620 includes a volatile memory and a nonvolatile memory. The memory 620 stores various pieces of information input to the communication device 630 and a processing result of the information processing calculation equipment 610. The information processing calculation equipment 610 executes various type of calculation processing using the information stored in the memory 620.

The communication device 630 has a wireless communication function. The communication device 630 converts a received wireless signal into an electrical signal and outputs the electrical signal to the information processing calculation equipment 610. The communication device 630 outputs a processing result of the information processing calculation equipment 610 as a wireless signal. Hereinafter, the technical content of the present embodiment will be described with the integrated calculation unit 600, which is a generic term for the information processing calculation equipment 610, the memory 620, and the communication device 630. The information processing calculation equipment 610 corresponds to a processing calculation unit.

The user inputs a user instruction related to the irrigation operation control processing to the integrated calculation unit 600 using input equipment 800 such as a touchscreen or a keyboard. The integrated calculation unit 600 outputs an irrigation operation control processing command based on this user instruction and various pieces of information read from the information storage unit 500. When there is no instruction from the user, the integrated calculation unit 600 determines irrigation start and irrigation end based on various pieces of information. When the irrigation schedule arrives, the integrated calculation unit 600 determines the irrigation start along with establishment of an irrigation start condition. The integrated calculation unit 600 determines irrigation stop along with establishment of an irrigation stop condition during performing of irrigation.

When detecting a forcible irrigation operation control processing command or determining that the irrigation start condition is established, the integrated calculation unit 600 outputs an instruction signal for controlling the water source valve 15 to the information storage unit 500. This instruction signal is input from the information storage unit 500 to the monitoring unit 300 via the integrated communication unit 400. The monitoring unit 300 controls output and non-output of a water supply signal to the water source valve 15 based on the instruction signal. Due to this, an open-close state of water source valve 15 is controlled. As a result, the supply of irrigation water to the field 20 is controlled, or the irrigation stop is controlled.

### <Divided Area>

One monitoring unit 300 is provided for one distribution tube 133. One monitoring unit 300 may be configured to be provided corresponding to a predetermined number of distribution tubes 133. The monitoring unit 300 may be configured to be provided for each ridge. As illustrated in FIG. 1, the monitoring units 300, together with the water source valve 15 and the water pressure sensor 14, are arranged in a matrix in the field 20 with the x direction as a row direction and the y direction as a column direction. With such a configuration, the monitoring unit 300 individually monitors each divided area divided by the row direction and the column direction. The supply of irrigation water in each divided area is individually controlled by the corresponding monitoring unit 300.

### <Monitoring Unit>

As illustrated in FIG. 2, the monitoring unit 300 includes a control unit 320. A VWC sensor 311, a pF sensor 312, the water source valve 15, the water pressure sensor 14, and the like are electrically connected to the control unit 320. In the drawings, the VWC sensor 311 is denoted as VWCS, the pF sensor 312 is denoted as pFS, the water source valve 15 is denoted as WV, and the water pressure sensor 14 is denoted as WPS. The water source valve 15 includes a water source valve 150 and a water source valve 151 as specific devices provided in the water supply path. The water pressure sensor 14 includes a water pressure sensor 140, a water pressure sensor 141, and a water pressure sensor 142 as specific devices provided in the water supply path.

The VWC sensor 311 is arranged in the field 20 corresponding to a predetermined divided area. The pF sensor 312 is arranged in the field 20 corresponding to a predetermined divided area. The VWC sensor 311 and the pF sensor 312 detect an environment value related to the soil condition of the corresponding divided area. The VWC sensor 311 and the pF sensor 312 are each one of soil sensors. The water pressure sensor 142 detects the water pressure of each divided area. The environment value related to the soil condition of each divided area and the water pressure that are detected are stored in the information storage unit 500.

The control unit 320 includes a microcomputer 330, a communication unit 340, an RTC 350, and a power generation unit 360. The microcomputer is an abbreviation for microcomputer. RTC stands for real time clock. In the drawings, the communication unit 340 is denoted as CDP. An environment value related to a soil condition and a water pressure are input to the microcomputer 330. The microcomputer 330 outputs this environment value and the water pressure to the integrated communication unit 400 via the communication unit 340. An instruction signal is input from the integrated communication unit 400 to the microcomputer 330. The microcomputer 330 outputs a water supply signal to the water source valve 15 based on this instruction signal. The microcomputer 330 corresponds to a calculation processor. The microcomputer 330 is a control device that controls the operation of the water source valve 15. The microcomputer 330 has a sleep mode and a normal mode as operation modes. The sleep mode is a state in which the microcomputer 330 is stopping calculation processing. The normal mode is a state in which the microcomputer 330 is executing calculation processing. The normal mode consumes more power than the sleep mode.

The communication unit 340 performs wireless communication with the integrated communication unit 400. The communication unit 340 outputs, to the integrated communication unit 400 as a wireless signal, an electrical signal output from the microcomputer 330. Together with that, the communication unit 340 receives a wireless signal output from the integrated communication unit 400 and converts the wireless signal into an electrical signal. The communication unit 340 outputs the electrical signal to the microcomputer 330. When the electrical signal includes an instruction signal, the microcomputer 330 is switched from the sleep mode to the normal mode. The microcomputer 330 may be in the form of waking up before receiving the electrical signal.

The RTC 350 has a clock function for keeping time and a timer function for measuring time. The RTC 350 outputs a wake-up signal to the microcomputer 330 when a preset time has come or when a preset time has elapsed. When this wake-up signal is input to microcomputer 330 in the sleep mode, the microcomputer 330 is switched from the sleep mode to the normal mode.

The power generation unit 360 converts light energy acquired by a solar cell 361 into electric energy. The power generation unit 360 functions as a power supply source of the monitoring unit 300. Power supply is continuously performed from the power generation unit 360 to the RTC 350. Due to this, the clock function and the timer function of the RTC 350 are suppressed from being impaired. The solar cell 361 may be configured to be replaced with a primary battery or a secondary battery. The power generation unit 360 may be configured to convert natural energy other than light energy, for example, wind power, hydraulic power, or the like, into electric energy.

### <Environment Value Related to Soil Condition>

The watering system 1 detects an environment value related to a soil condition and controls start and stop of irrigation in accordance with this environment value. The watering system 1 controls a start timing and a stop timing of irrigation using the environment values detected by the VWC sensor 311 and the pF sensor 312. Due to this, the soil water content for each predetermined divided area is individually controlled.

The plant roots in the plowed soil layer of the field 20. Growth of the plant is dependent of the water content of the soil of this plowed soil layer. When the soil water content exceeds a growth inhibition moisture point, diseases occur in the plant. When the soil water content falls below a permanent wilting point, wilt of the plant is not recovered. The growth inhibition moisture point and the permanent wilting point vary depending on the type of the plant, and these values are stored in the information storage unit 500.

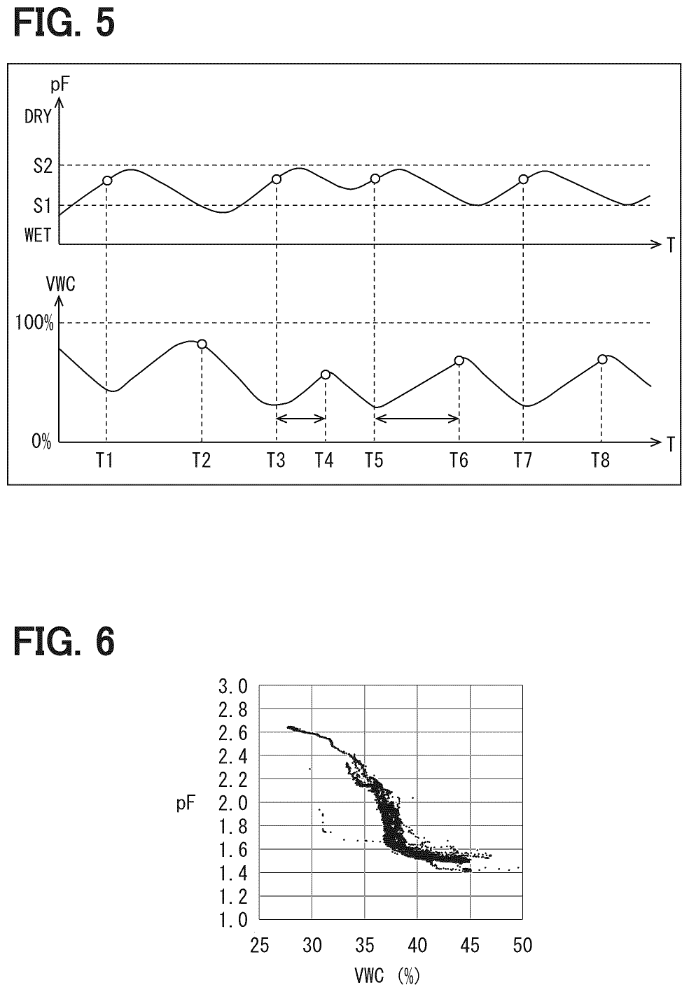

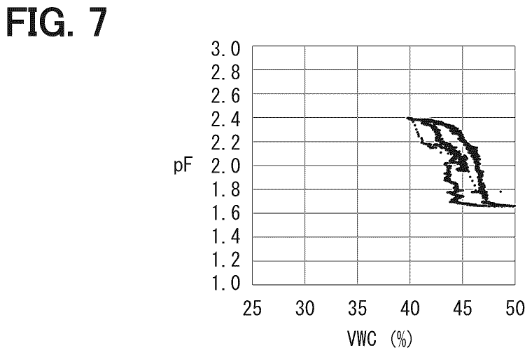

The monitor 700 displays a graph showing a change in a volume water content VWC of the soil detected by the VWC sensor 311 as shown in FIG. 5. The monitor 700 displays a graph showing a change in the pF value of the soil detected by the pF sensor 312 as shown in FIG. 5. FIG. 5 shows a time chart of the pF value and a time chart of the VWC related to the irrigation operation control. The monitor 700 displays soil moisture retention characteristic information obtained using the volume water content VWC and the pF value as illustrated in FIGS. 6 and 7. Such the display processing is performed by the integrated calculation unit 600, for example. The pF value is a value representing the degree of strength in which water in the soil is attracted by a capillary force of the soil, and is a value representing the wetness of the soil. The pF value indicates soil water content tension. When the pF value is high, the soil is in a dried state, and when the pF value is low, the soil is in a wet state.

The VWC sensor 311 and the pF sensor 312 detect a current value of the environment value related to the soil condition. This current value is utilized as soil information for obtaining a prediction value related to prediction of an increase and a decrease from the current value. These pieces of information are stored in the information storage unit 500. The information storage unit 500 stores the growth inhibition moisture point and a permanent wilting point of the plant, a water absorption amount by which the plant absorbs moisture per unit time, and a moisture retention capability of the soil. The user instruction, which is the above-described instruction from the user, is stored in the information storage unit 500. In this manner, the information storage unit 500 stores various pieces of information for determining the irrigation operation control. The watering system 1 confirms detection values of the VWC sensor 311 and the pF sensor 312 in real time, and performs control to perform start and stop of irrigation when the detection value reaches a threshold value.

### <Microcomputer>

As illustrated in FIG. 2, the microcomputer 330 includes an acquisition unit 331, a signal output unit 332, a storage unit 333, and a processor 334. In the drawings, the acquisition unit 331 is denoted as AD, the signal output unit 332 is denoted as SOU, the storage unit 333 is denoted as MU, and the processor 334 is denoted as PU. The environment values detected by the VWC sensor 311 and the pF sensor 312 are input to the acquisition unit 331. The water pressure detected by the water pressure sensor 14 is input to the acquisition unit 331. The acquisition unit 331 is electrically connected to each of the VWC sensor 311, the pF sensor 312, and the water pressure sensor 14.

The signal output unit 332 is electrically connected to the water source valve 15. A control signal (water supply signal) for controlling the valve opening degree of the water source valve 15 is output from the signal output unit 332 to the water source valve 15. The water source valve 15 is in the closed state when the water supply signal is not yet input. The water source valve 15 is in the open state when the water supply signal is input. The water source valve 15 may be configured to maintain the current state in a case where the water supply signal is not input, and to open and close in accordance with the input content in a case where the water supply signal is input. For example, when the control signal is not yet input, the valve opening degree of the water source valve 15 is maintained, and the valve opening degree of the water source valve 15 is adjusted in accordance with the control signal of the opening degree instruction input at the time of input.

The storage unit 333 is a non-transitory tangible storage medium that non-transitorily stores programs and data readable by a computer or a processor. The storage unit 333 includes a volatile memory and a nonvolatile memory. The storage unit 333 stores a program for the processor 334 to execute calculation processing. This program includes at least a part of the above-described irrigation application program. The storage unit 333 transitorily stores data when the processor 334 executes calculation processing. The storage unit 333 stores various data input to each of the acquisition unit 331 and the communication unit 340, and acquisition times of the various data.

When the wake-up signal is input from the RTC 350, the processor 334 is switched from the sleep mode to the normal mode. In the normal mode, the processor 334 reads a program and various data stored in the storage unit 333 and executes calculation processing. This calculation processing includes calculation of a valve opening degree necessary for causing water having flown through the through hole of the distribution tube 133 to reach a desired irrigation position. The processor 334 corresponds to a calculation unit. This calculation may be configured to be executed by the information processing calculation equipment 610 of the integrated calculation unit 600.

The processor 334 reads various sensor signals input to the acquisition unit 331, and reads, from the RTC 350, the acquisition time of the instruction signal input to the communication unit 340. The processor 334 causes the storage unit 333 to store the instruction signal and the acquisition time. Reading of the acquisition time may be configured such that the integrated communication unit 400 is caused to record the data acquisition time when the integrated communication unit 400 wirelessly receives data from each monitoring unit 300. The information storage unit 500 may be configured to be caused to record the data acquisition time when the information storage unit 500 wirelessly receives data from the integrated communication unit 400. The processor 334 stores the environment values and the water pressure input from the VWC sensor 311, the pF sensor 312, and the water pressure sensor 14, and the acquisition times thereof into the information storage unit 500 via the communication unit 340 and the integrated communication unit 400. The processor 334 outputs the water supply signal to the water source valve 15 via the signal output unit 332 based on the instruction signal input from the integrated calculation unit 600 via the information storage unit 500, the integrated communication unit 400, and the communication unit 340.

### <Communication Unit>

The communication unit 340 converts the electrical signal input from the processor 334 into a wireless signal. The communication unit 340 outputs this wireless signal to the integrated communication unit 400. The communication unit 340 converts, into an electrical signal, the wireless signal output from the integrated communication unit 400. The communication unit 340 outputs this electrical signal to the processor 334. The wireless signal output from the communication unit 340 contains an address and data. Wireless signals are transmitted and received between the communication units 340 and the integrated communication unit 400. The address contained in the wireless signal is an identification code indicating from which of the communication units 340 the wireless signal is output. In other words, the address contained in the wireless signal is an identification code indicating from which of the processors 334 the wireless signal is output. A unique address is saved in each of the storage units 333.

The wireless signal output from the integrated communication unit 400 also contains an address. The data of this wireless signal contains an instruction signal. This wireless signal is received by each communication unit 340. This wireless signal is converted into an electrical signal by each communication unit 340. Then, this electrical signal is input to each processor 334. Among the processors 334, only the processor 334 having an identical address to the address contained in the electrical signal executes the calculation processing based on the electrical signal. The microcomputer 330 performs intermittent drive in which the sleep mode and the normal mode are alternately repeated. Therefore, wireless communication between the communication unit 340 and the integrated communication unit 400 is not frequently performed.

### <Power Generation Unit>

The power generation unit 360 includes the solar cell 361, a power storage unit 362, a voltage sensor 363, and a power sensor 364. In the drawings, the solar cell 361 is denoted as SB, the power storage unit 362 is denoted as ESU, the voltage sensor 363 is denoted as CS, and the power sensor 364 is denoted as PS. The solar cell 361 converts light energy into electrical energy. The power storage unit 362 stores the electric energy (power). The power stored in the power storage unit 362 is utilized as drive power of the monitoring unit 300.

The voltage sensor 363 detects a voltage value output from the solar cell 361 to the power storage unit 362. The power sensor 364 detects power output from the power storage unit 362. The processor 334 stores a detected current value and a detected power value in the information storage unit 500 via the communication unit 340 and the integrated communication unit 400. The drive power of the monitoring unit 300 is dependent of the power generated by the power generation unit 360. Therefore, when the amount of light incident on the power generation unit 360 is small, the drive power of the monitoring unit 300 may be insufficient. In order to avoid this, the microcomputer 330 of the monitoring unit 300 performs intermittent drive. The voltage sensor 363 may be configured to be replaced with a current sensor that detects a current output from the solar cell 361 to the power storage unit 362. The power generation unit 360 may be configured not to include a voltage sensor or a current sensor.

### <RTC>

The RTC 350 outputs the wake-up signal to the microcomputer 330 every time a time interval (drive cycle) of the intermittent drive described above elapses. Due to this, the microcomputer 330 alternately repeats the sleep mode and the normal mode. The drive cycle described above is determined by the integrated calculation unit 600 in accordance with the power amount (power storage amount) stored in the power storage unit 362. The intermittent drive interval is determined by the integrated calculation unit 600 in accordance with the power storage amount.

The integrated calculation unit 600 calculates the power storage amount based on the power stored in the information storage unit 500. The integrated calculation unit 600 sets the intermittent drive interval to be longer as the power storage amount is smaller. The integrated calculation unit 600 sets the intermittent drive interval to be shorter as the power storage amount is greater. The integrated calculation unit 600 contains the intermittent drive interval into the instruction signal. When the processor 334 of the microcomputer 330 acquires this instruction signal, the processor 334 adjusts the intermittent drive interval. The processor 334 adjusts the drive cycle of the RTC 350.

### <Drive of Watering System>

The watering system 1 performs transmission and reception of signals between the monitoring units 300 and the integrated calculation unit 600, and saving of various data into the information storage unit 500. Each of the monitoring units 300 and the integrated calculation unit 600 executes a cycle task to be processed for each drive cycle and an event task to be processed suddenly.

These cycle task and event task have priorities in processing. When the processing timings of these tasks become the same, the processing of the event task is prioritized over the processing of the cycle task. As the cycle task, each monitoring unit 300 executes sensor processing related to acquisition of various sensor signals. The integrated calculation unit 600 executes update processing. As the event task, each monitoring unit 300 executes monitoring processing and water supply processing. The integrated calculation unit 600 executes the irrigation operation control processing, user update processing, and forcible update processing. Each of the monitoring processing, the water supply processing, and the irrigation operation control processing is executed in the daytime in order to avoid depletion of the drive power of the monitoring unit 300. Determination as to whether it is daytime can be detected based on the current time, the solar radiation amount detected by a solar radiation sensor, and the like.

### <Monitoring Processing>

Before the monitoring processing, the microcomputer 330 of each monitoring unit 300 is in the sleep mode. The instruction signal is input from the integrated calculation unit 600 to the microcomputer 330 by wireless communication. As a result, the microcomputer 330 is switched from the sleep mode to the normal mode and starts executing the monitoring processing.

First, the input instruction signal and the acquisition time thereof are stored. Next, it is determined whether the instruction signal contains a water supply instruction for bringing the water source valve 15 into the open state from the closed state. When the water supply instruction is contained in the instruction signal, the water supply processing is executed. In the water supply processing, the microcomputer 330 outputs the water supply signal to the water source valve 15 in accordance with the water supply instruction. Furthermore, the microcomputer 330 determines whether the irrigation stop condition is established. When the irrigation stop condition is not established, output of the water supply signal to the water source valve 15 is continued. When the irrigation stop condition is established, output of the water supply signal is stopped and the water supply processing is ended.

When the water supply instruction is not contained in the instruction signal, the water supply processing is not executed, and it is determined whether the instruction signal contains an update instruction for the intermittent drive interval. The update instruction for the intermittent drive interval is regularly or irregularly output as an instruction signal from the integrated calculation unit 600 or the information storage unit 500 to each monitoring unit 300. When the update instruction for the intermittent drive interval is contained in the instruction signal, the processor 334 adjusts the time interval at which the wake-up signal of the RTC 350 is output.

When the update instruction for the intermittent drive interval is not contained in the instruction signal, the sensor processing is executed. When the water supply processing is executed, an environment value after irrigation supply is detected in the sensor processing. When the water supply processing is not executed, an environment value when irrigation is not supplied is detected in the sensor processing. This environment value is stored in the information storage unit 500. Upon finishing execution of the sensor processing, the microcomputer 330 shifts to the sleep mode and ends the monitoring processing. The start condition of the monitoring processing is not limited to the instruction signal from the integrated calculation unit 600. After the RTC 350 activates the microcomputer 330, the microcomputer 330 sends sensor data to the integrated calculation unit 600 after processing. Then, the integrated calculation unit 600 may be configured to send an instruction of the timing of the next intermittent drive together with an opening degree instruction of the valve.

### <Irrigation Operation Control Processing>

The integrated calculation unit 600 executes the irrigation operation control processing at each timing of supplying irrigation in each monitoring unit 300. The timing of supplying the irrigation is a case where the irrigation start condition is established or a case where an irrigation command is generated by a user's operation. First, the integrated calculation unit 600 outputs a water supply signal containing a water supply instruction toward the monitoring unit 300 of the divided area scheduled to be supplied with irrigation, among the monitoring units 300. The water supply instruction contains output start of the water supply signal and output time (water supply time) of the water supply signal. Upon receiving this water supply instruction, the monitoring unit 300 executes the above-described monitoring processing.

The integrated calculation unit 600 is brought into a standby state until the monitoring processing of the monitoring unit 300 is ended. When the monitoring processing is ended, the update processing is executed. Determination as to whether the monitoring processing is ended is made based on, for example, whether a time for which the monitoring processing is expected to be ended has elapsed. The determination as to whether the monitoring processing is ended can be made by inquiring the monitoring unit 300. An end determination method of the monitoring processing is not particularly limited.

### <User Update Processing>

The integrated calculation unit 600 executes the user update processing when a user instruction related to adjustment of the irrigation schedule and the intermittent drive interval is input from the input equipment 800. First, the integrated calculation unit 600 stores, into the information storage unit 500, the input user instruction. Next, the above-described update processing is executed. As described above, the irrigation schedule and the intermittent drive interval are updated based on the user instruction.

### <Forcible Update Processing>

The integrated calculation unit 600 executes the forcible update processing when a user instruction related to update of the irrigation schedule and the intermittent drive interval is input. First, the integrated calculation unit 600 outputs a request signal containing a request instruction for requesting execution of the sensor processing. This request signal is output to the monitoring unit 300 by wireless communication. Next, the update processing is brought into the standby state until the sensor processing of the monitoring unit 300 is ended.

When the sensor processing is ended, the above-described update processing is executed. Determination as to whether the sensor processing is ended is made based on, for example, whether a time for which the sensor processing is expected to be ended has elapsed. Whether the sensor processing is ended can be performed by inquiring of the monitoring unit 300. An end determination method of the sensor processing is not particularly limited. The irrigation schedule and the intermittent drive interval are updated based on various data at the time of the update request of the user.

### <Individual Irrigation Operation Control Processing>

As described above, the integrated calculation unit 600 determines the irrigation schedule in each of the divided areas. The integrated calculation unit 600 controls the supply of irrigation based on each irrigation schedule. Although the irrigation schedule in each divided area is determined by the integrated calculation unit 600, a configuration in which the supply of irrigation based on each irrigation schedule is individually controlled by each monitoring unit 300 may be adopted.

### <Independent Update>

Furthermore, for example, a configuration in which the irrigation schedule in each divided area is independently determined by the corresponding monitoring unit 300 may be adopted. In such a configuration, each monitoring unit 300 executes the above-described update processing.

### <Weather Forecast>

The information storage unit 500 stores a current value of the soil water content, a prediction value of a decrease change, and a user instruction. The information storage unit 500 stores the growth inhibition moisture point and the permanent wilting point of the plant, the water absorption amount by which the plant absorbs moisture per unit time, and the moisture retention capability of the soil. In addition to them, the information storage unit 500 stores a weather forecast of the field 20 output and distributed from an external information source 1000. In the update processing, the integrated calculation unit 600 reads various pieces of information including a weather forecast from the information storage unit 500.

When a weather forecast for one week is stored in the information storage unit 500 from the external information source 1000, for example, the integrated calculation unit 600 determines an irrigation schedule for one week. During this one week, when there is no rainfall forecast by the weather forecast, it is expected that the estimate value of the soil water content gradually decreases with the lapse of time. The decrease amount per unit time of the estimate value of this soil water content is determined based on the prediction value of a decrease change in the soil water content of the plowed soil layer. Hereinafter, for simplifying the notation, the estimate value of the soil water content is simply denoted as an estimate value as necessary.

As described above, the irrigation schedule is determined based on the estimate value of the soil water content based on the environment value and the like and the weather forecast. According to this, it is possible to suppress the soil water content in the outdoor divided area from becoming unsuitable for the plant due to a weather change such as rainfall or drying.

An example of a valve device applicable to the water source valve 15 is what is called a rotary valve device. This valve device includes one fluid inflow portion and three fluid outflow portions. This valve device is mounted on the watering system 1 by connecting an upstream pipe to the fluid inflow portion and connecting the distribution tube 133 to any one of the fluid outflow portions. Furthermore, the passage may be configured to be closed by attaching a closing member to the fluid outflow portion to which the distribution tube 133 is not connected. This valve device includes a housing, a valve, a drive unit, and a drive unit cover. The valve device is configured as a ball valve that performs an open-close operation of the valve device by the valve rotating about an axial center of a shaft.

The operation of the water source valve 15 will be described. The microcomputer 330 calculates a rotation angle of the valve for supplying water of a necessary flow rate to the distribution tube 133, that is, a rotation angle of a motor. The microcomputer 330 transmits information on the calculated rotation angle of the motor to the water source valve 15. At this time, the closing member is attached to the two fluid outflow portions not connected to the distribution tube 133. The calculation of the rotation angle of the motor may be configured to be executed by the information processing calculation equipment 610 of the integrated calculation unit 600.

The water source valve 15 rotates the motor based on the information on the rotation angle received from the microcomputer 330. By rotating the motor, the water source valve 15 rotates the valve via a gear portion and the shaft, and causes a required flow rate of fluid to flow out from an unclosed opening of the three fluid outflow portions. The water source valve 15 adjusts the rotation angle of the motor by a rotation angle sensor detecting the rotation angle of the gear portion and giving feedback of information of the detected rotation angle to the microcomputer 330. As described above, the opening degree of each valve transitions in accordance with the rotation angle, and the fluid flow rate flowing out from each valve changes. Each water source valve 15 in the watering system 1 is configured to supply a fluid from only one of the three valves, thereby controlling the water flying distance and the water supply amount to the field 20 in accordance with the rotation angle.

Hereinafter, the operation of the watering system 1 for performing irrigation appropriate for growth of the plant will be described with reference to the drawings. FIG. 3 illustrates an example of the water supply path provided with the water source valve and the water pressure sensor, and the VWC sensor 311 and the pF sensor 312 installed in the soil. In the example illustrated in FIG. 3, the VWC sensor 311 and the pF sensor 312 are installed on a predetermined ridge among a plurality of ridges arranged in the field 20, and detect the soil condition of the ridge.

The watering system 1 illustrated in FIG. 3 includes the water source valve 15, the water pressure sensor 14, and the like provided in a passage on one end portion side of the distribution tubes 133 arranged side by side. Each distribution tube 133 is provided at a position where irrigation water can be discharged to the corresponding ridge via through holes. The passage on one end portion side is a passage causing the vertical pipe 131 through which the water supply from the water supply source flows down and one end portion of the distribution tube 133 to communicate with each other. The water source valve 15 controls the pressure of water supply from one end portion side flowing down from one end portion toward the other end portion of the distribution tube 133. The water source valve 15 includes the water source valve 150 and the water source valves 151. The water pressure sensor 14 includes the water pressure sensor 140, the water pressure sensor 141, and the water pressure sensors 142.

The vertical pipe 131 is coupled to a passage leading to an inlet port of each water source valve. Each distribution tube 133 is coupled to a passage leading to one of the fluid outflow portions in each water source valve. In this case, the other fluid outflow portions are closed by the closing member. The signal output unit 332 outputs, to the water source valve, a control signal for controlling the valve opening degree by feedback control using the water supply information detected at a downstream end. The signal output unit 332 outputs, to the water source valve, a control signal for controlling the valve opening degree by feedback control using the water supply information detected in an upstream passage.

The vertical pipe 131 communicates with passages leading to one end portion of the distribution tubes 133. The vertical pipe 131 is provided with the water source valve 150 that opens and closes a passage more upstream than a connection portion with the first coupling pipe 132. The passages include the branch pipes 132a each branching into one end portion of two distribution tubes 133 adjacent to each other. The branch pipes 132a constitute plural passages branching from the first coupling pipe 132. The first coupling pipe 132 is connected to the vertical pipe 131 at an upstream site and is connected to the branch pipe 132a at a downstream site.

The branch pipes 132a are passages coupling the distribution tubes 133 and the first coupling pipe 132. Each of the branch pipes 132a couples the one end portion of the two distribution tubes 133 adjacent to each other and the first coupling pipe 132. The downstream site of the branch pipe 132a is provided with the water source valve 151. One branch pipe 132a is configured to be provided so as to flow down water supply to a predetermined number of the distribution tubes 133 forming one group. The number of the distribution tubes 133 coupled to one branch pipe 132a may be one or three or more. That is, the predetermined number may be one or three or more.

The water source valve 151 includes one fluid inflow portion and two fluid outflow portions, and can control the opening degree of each of the passages branching into two. The water source valve 151 opens and closes a passage at a downstream site of the first coupling pipe 132 and controls the flow rate flowing down to the predetermined number of distribution tubes 133 forming one group. By controlling the valve opening degrees of the water source valve 150 and each water source valve 151, the watering system 1 can simultaneously perform irrigation of a plurality of groups. The watering system 1 can simultaneously irrigate one predetermined group by controlling the valve opening degrees of the water source valve 150 and each water source valve 151.

The vertical pipe 131 is provided with the water pressure sensor 140 that detects the water supply pressure in the passage more upstream than the connection portion with the first coupling pipe 132. The water pressure sensor 141 detects the water supply pressure at a site of the first coupling pipe 132 positioned more upstream than the branch pipe 132a. The water pressure sensor 142 detects the water supply pressure at a site more upstream than the through hole in each distribution tube 133. The control device 200 can obtain the flow rate in respective units using the water supply pressure detected by the water pressure sensor 140, the water pressure sensor 141, and the water pressure sensor 142.

The VWC sensor 311 and the pF sensor 312 are installed on the ridges corresponding to the predetermined number of distribution tubes 133 forming one group. In the watering system 1 illustrated in FIG. 3, the VWC sensor 311 and the pF sensor 312 are installed on the soil to be irrigated by the distribution tubes 133 forming one group. The VWC sensor 311 and the pF sensor 312 may be configured to be installed for each distribution tube 133. In the case of this configuration, it is possible to detect an environment value related to the soil condition with higher accuracy. As illustrated in FIG. 2, the water supply pressures detected by the water pressure sensor 140, the water pressure sensor 141, and the water pressure sensor 142 are output to the microcomputer 330 of the monitoring unit 300. The volume water content VWC of the soil detected by the VWC sensor 311 is output to the microcomputer 330. The pF value of the soil detected by the pF sensor 312 is output to the microcomputer 330. The processor 334 determines each timing of start and stop of irrigation using the VWC detected by the VWC sensor 311 and the pF value detected by the pF sensor 312. The signal output unit 332 outputs a control signal for controlling the valve opening degree to each of the water source valves 150 and 151 in accordance with the determination result related to the start and stop of the irrigation. The control of the valve opening degree described here may be configured to be executed by the information processing calculation equipment 610 of the integrated calculation unit 600.

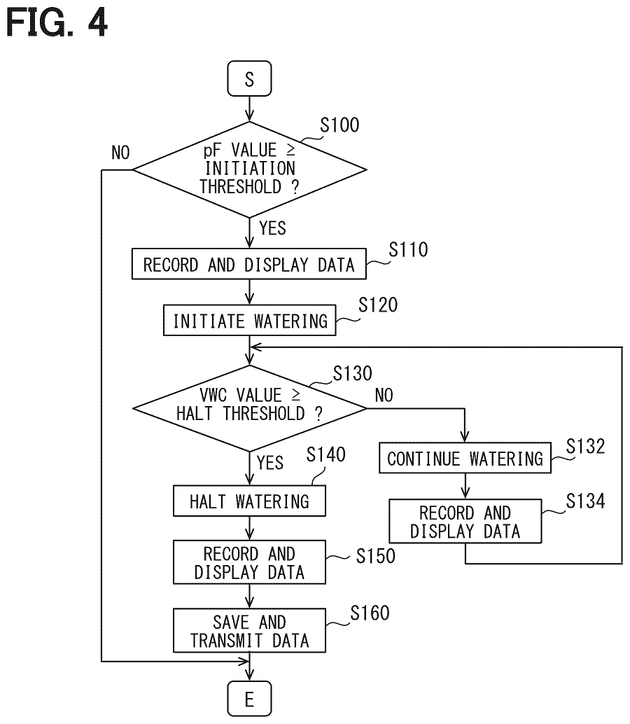

The watering system 1 executes the processing according to the flowchart shown in FIG. 4 when performing the irrigation operation control processing. FIG. 4 is a flowchart showing an example of the operation at the time of an irrigation command. The irrigation command is executed when an irrigation schedule arrives, when an irrigation command is issued by the user, and when an irrigation time by the timer comes. The control device 200 executes the processing shown in FIG. 4 by, for example, the monitoring unit 300 or the integrated calculation unit 600. Hereinafter, an example in which the monitoring unit 300 executes each processing will be described as a representative.

The integrated calculation unit 600 outputs an irrigation command to the monitoring unit 300 corresponding to the divided area where irrigation is to be performed. In this state, the water source valve 150 is controlled to be in the closed state. Upon receiving a signal related to the irrigation operation control processing output from the integrated calculation unit 600, the microcomputer 330 of the monitoring unit 300 executes the processing shown in FIG. 4. The processing shown in FIG. 4 is executed at a timing when an irrigation command by a user instruction is generated or at a timing when an irrigation time comes, and is repeated several times in one day, for example. The acquisition unit 331 acquires the VWC detected by the VWC sensor 311 and the pF value detected by the pF sensor 312.

In step S100, the processor 334 determines whether the pF value detected by the pF sensor 312 exceeds a start threshold value for irrigation. Step S100 is determination processing of determining whether the irrigation start condition is established in the irrigation operation control processing. The start threshold value is stored in advance in the storage unit 333 or the information storage unit 500. The start threshold value is a value set depending on the type of a crop or/and the type of soil. The start threshold value may be a value updated in accordance with a season, a temperature, or/and a solar radiation amount. The start threshold value may constitute an instruction value input to the integrated calculation unit 600 by the user using the input equipment 800. The processor 334 executes the determination processing of step S100 using the start threshold value updated as necessary.

When it is determined that the pF value does not exceed the start threshold value for irrigation and the irrigation start condition is not established, the flowchart is ended without starting irrigation. After the predetermined time has elapsed, the determination processing in step S100 is executed again. When it is determined that the irrigation start condition is established when the pF value exceeds the start threshold value for irrigation, processing of recording and displaying various data before starting irrigation is executed in step S110. Recording of various data is performed by being saved in the storage unit 333 or the information storage unit 500. Display of various data is performed by being displayed on the monitor 700 of a portable terminal or a computer. The monitor 700 of the portable terminal or the computer is included in a display unit browsable by the user. This enables the environment value related to the soil condition before the irrigation start to be utilized for the irrigation operation control, and enables the user to confirm the soil condition before the irrigation start.

When the irrigation start condition is established, the microcomputer 330 further executes the processing for initiating watering in step S120. The microcomputer 330 outputs a control signal for bringing, into the open state, the water source valve 151 corresponding to the divided area where irrigation is performed among the water source valves 151. The microcomputer 330 outputs a control signal for bringing, into the closed state, the water source valve 151 corresponding to the divided area where the irrigation is not performed. The irrigation from the distribution tube 133 positioned downstream of the water source valve 151 controlled to the open state is started by controlling the valve opening degree so as to satisfy a target irrigation amount and a target water flying distance. In this state, the pump 110 is driven, and the water supply from the water supply source flows down the water supply pipe 130. In step S120, the water supply simultaneously flows down from one end portion to the other end portion of the distribution tube 133, and irrigation of discharging water from each through hole toward the corresponding ridge.

This irrigation is continued until the processor 334 determines in step S130 that the stop condition of irrigation is established. The stop condition of irrigation is established when the VWC detected by the VWC sensor 311 exceeds the stop threshold value of irrigation. The stop threshold value is a value updated by calculation of the processor 334 or the integrated calculation unit 600. The processor 334 and the integrated calculation unit 600 determine the stop threshold value based on a change in the pF value. The processor 334 and the integrated calculation unit 600 determine the stop threshold value based on the pF value after the immediately preceding irrigation stop. The processor 334 and the integrated calculation unit 600 learn a change range of the pF value, and determine the h stop alt threshold value to be compared with the VWC based on this learned value. In this manner, the processor 334 and the integrated calculation unit 600 determine the stop threshold value to be compared with the VWC while detecting the pF value.

When the stop condition of irrigation is not established in step S130, the processing of continuing the irrigation operation control is executed in step S132. Furthermore, in step S134, processing of recording and displaying various data during irrigation is executed, and the processing proceeds to step S130. The recording and display of various data are performed by a method similar to that in step S110. This step enables the environment value related to the soil condition during irrigation to be utilized for the irrigation operation control, and enables the user to confirm the current soil condition during irrigation.

When the stop condition of irrigation is established in step S130, processing of irrigation is stopped in step S140. The microcomputer 330 controls the water source valve 15 into a fully closed state to end the irrigation by water supply from one end portion to the other end portion. Furthermore, in step S150, processing of recording and displaying various data after the irrigation stop is executed. Furthermore, in step S160, the various data in S110, S134, and S150 are saved in the information storage unit 500 and transmitted to an external computer, portable terminal, or the like. The user can confirm various data such as an environment value related to irrigation at any time by viewing a screen of a computer, a mobile terminal, or the like at hand. After the execution of step S160, the flowchart shown in FIG. 4 is ended, and the determination processing of step S100 is executed again after generation of the next irrigation command.

In the irrigation operation control repeated as described above, each of the pF value and the VWC changes as in the time chart shown in FIG. 5 as an example. The change in the pF value and the change in the VWC have characteristics determined based on the relationship between the pF value and the VWC that vary depending on the nature of the soil. The upper time chart in FIG. 5 shows a change in the pF value with the horizontal axis representing time T and the vertical axis representing the pF value. As the pF value increases, the soil is dry, and as the pF value decreases, the soil is wet. The pF value is preferably displaced between S1 and S2 shown in FIG. 5. The watering system 1 performs irrigation operation control for controlling the soil condition such that the pF value does not exceed this control range. S1 is a control upper limit value of the pF value, and S2 is a control lower limit value of the pF value.

The control range of the pF value is set as an appropriate fluctuation range related to the pF value. The control range of the pF value is stored in advance in the storage unit 333 or the information storage unit 500 depending on the type of the crop. The control range of the pF value is a value set depending on the type of a crop or/and the type of soil. The control range of the pF value may be a value updated in accordance with a season, a temperature, or/and a solar radiation amount. The control range of the pF value may be configured to be set to a range input to the integrated calculation unit 600 by the user using the input equipment 800.

When the pF value exceeds this control range as indicated between time T2 and time T3, the watering system 1 determines the stop threshold value such that a subsequent change in the pF value falls within the control range based on this pF value. According to the stop threshold value determined in this manner, the next irrigation operation time can be adjusted such that the soil condition is not brought into a state of being overdried or overwet.

An example of the irrigation operation control will be described while illustrating the relationship among the irrigation operation time, the start threshold value, the stop threshold value, the pF value, and the VWC with reference to FIG. 6. When the pF value exceeds the start threshold value at time T1, the first irrigation operation is started. Thereafter, the pF value slightly increases and then decreases, the VWC increases, and the moisture in the soil increases. When the VWC exceeds the stop threshold value, the first irrigation operation is stopped. The time from T1 to T2 is the first irrigation operation time. The pF value exceeds below the control range between T2 and T3 during the irrigation stop. That is, the soil condition is in the overwet state. The processor 334 and the integrated calculation unit 600 determine and update the stop threshold value to be a low value such that a subsequent change in the pF value falls within the control range based on the pF value that falls below.

Next, when the pF value exceeds the start threshold value at T3, the second irrigation operation is started. Thereafter, the pF value slightly increases and then decreases, the VWC increases, and the moisture in the soil increases. When the VWC exceeds the stop threshold value updated to be a low value, the second irrigation operation is stopped. The time from T3 to time T4 is the second irrigation operation time. The second irrigation operation time is shorter than the first irrigation operation time. The pF value is controlled so as to fall within the above control range between T4 and time T5 during the irrigation stop. Therefore, the soil condition is improved by changing from the wet state to the dried state side.

However, the pF value is displaced to a high value in the above control range during the irrigation stop. The processor 334 and the integrated calculation unit 600 determine and update the stop threshold value to be a high value such that a subsequent change in the pF value becomes a low value of the control range based on the pF value that is a relatively high value.

Next, when the pF value exceeds the start threshold value at T5, the third irrigation operation is started. In the third irrigation operation, the pF value slightly increases and then decreases, the VWC increases, and the moisture in the soil increases. When the VWC exceeds the stop threshold value updated to be a high value, the third irrigation operation is stopped. The time from T5 to time T6 is the third irrigation operation time. The third irrigation operation time is longer than the second irrigation operation time. Therefore, the soil condition is changed to the wet state side more than that after the second irrigation operation and is improved.

Next, when the pF value exceeds the start threshold value at time T7, the fourth irrigation operation is started. Thereafter, the pF value slightly increases and then decreases, the VWC increases, and the moisture in the soil increases. When the VWC exceeds the stop threshold value, the fourth irrigation operation is stopped. The time from T7 to time T8 is the fourth irrigation operation time. At and after T8 during the irrigation stop, the pF value is controlled so as to fall within the above control range.

When the pF value exceeds over the control range of the pF value during the irrigation stop, the soil condition is in the overdried state. In this case, the processor 334 and the integrated calculation unit 600 determine and updates the stop threshold value to be a high value such that a subsequent change in the pF value falls within the control range based on the pF value that exceeds.

FIG. 6 is an example of the moisture retention characteristic information obtained from the pF value and the measurement value of the VWC, and illustrates a case of soil with more sand quality. FIG. 7 is an example of the moisture retention characteristic information obtained from the pF value and the measurement value of the VWC, and illustrates a case of soil with more silt. This moisture retention characteristic information is also called a moisture retention curve of the soil. The processor 334 and the integrated calculation unit 600 obtain the moisture retention characteristic information related to soil using the measured pF value and the measurement value of the VWC. The processor 334 and the integrated calculation unit 600 may execute processing of calculating moisture retention characteristic information from the pF value and the measurement value of the VWC as processing included in the flowchart of FIG. 4.

This moisture retention characteristic information is saved in the storage unit 333 or the information storage unit 500. This moisture retention characteristic information is displayed on the monitor 700 of the portable terminal or the computer. This processing enables the user to know the moisture retention characteristic information unique to the soil, and enables the user to understand how much irrigation should be performed on the field. The user can know how hard the soil is after cultivating the field, and can grasp the deviation from the target soil. The user can utilize the moisture retention characteristic information unique to the soil as data for improving the soil in the future.

The watering system 1 of the first embodiment includes the water supply path supplied with water to be released to the plant, the pF sensor 312, the VWC sensor 311, and the control device 200. Using the pF value detected by the pF sensor 312 and the volume water content detected by the VWC sensor 311, the control device 200 controls the irrigation operation of releasing water to the plant via the water supply path. The control device 200 controls the start timing of the irrigation operation based on the detected pF value and the start threshold value. The control device 200 controls the stop timing of the irrigation operation that is in operation based on the detected volume water content and the stop threshold value. The control device 200 updates the stop threshold value based on the fluctuation of the pF value having been detected.

This system updates the stop threshold value related to the VWC using the pF value useful as an environment value of the soil condition. Therefore, it is possible to provide the irrigation operation reflected in the VWC having good responsiveness of irrigation. The watering system 1 can provide the irrigation operation control for controlling the operation time by replacing fluctuation of the pF value with fluctuation of the VWC. Therefore, this watering system 1 can perform the irrigation operation control suitable for the soil condition by the irrigation stop timing controlled in association with the pF value and the VWC. Furthermore, according to this system, since the irrigation operation control suitable for the soil condition can be performed with the minimum irrigation amount, irrigation contributing to water saving can be provided.

The acquisition unit 331 acquires the pF value, which is an environment value related to the soil condition, detected by the pF sensor 312, and the volume water content, which is an environment value related to the soil condition, detected by the VWC sensor 311. The processor 334 controls the irrigation operation of releasing water to the plant using the pF value detected by the pF sensor and the volume water content detected by the VWC sensor. The processor 334 controls the start timing of the irrigation operation based on the detected pF value and the start threshold value. The processor 334 controls the stop timing of the irrigation operation that is in operation based on the detected volume water content and the stop threshold value. The processor 334 updates the stop threshold value based on the fluctuation of the pF value having been detected.

The control device 200 updates the stop threshold value related to the VWC using the pF value useful as an environment value of the soil condition. Therefore, the control device 200 can provide the irrigation operation reflected in the VWC having good responsiveness of irrigation. The control device 200 can provide the irrigation operation control for controlling the operation time by replacing fluctuation of the pF value with fluctuation of the VWC. Therefore, the control device 200 can perform the irrigation operation control suitable for the soil condition by the irrigation stop timing controlled in association with the pF value and the VWC.

The watering system and the control device 200 having the above configuration can solve the following problems in control using only the pF value and control using only the VWC. In the case of control using only the pF value, the response of the pF value to water is slow, and therefore the pF value continues to fluctuate also after the irrigation operation is stopped. Therefore, it is difficult to determine an appropriate irrigation stop timing. For this reason, extra water is sprinkled to the soil or water is insufficient, and the yield of crop growth is reduced. Since the correlation between the VWC and the pF value depends on the nature of soil, in the case of control using only the VWC, it is difficult to control the pF value by the VWC unless soil analysis is performed after system installation. Furthermore, the nature of the soil changes with time, and therefore it is insufficient to perform the soil analysis once, and it takes cost and labor to perform the soil analysis a plurality of times.

When the detected pF value fluctuates in a direction in which the soil condition becomes wet, the control device 200 updates the stop threshold value such that the next irrigation operation time becomes shorter. For example, in the case where the detected pF value fluctuates in a direction in which the soil condition becomes wet, the control device 200 updates the stop threshold value to be a low value. Due to this, the next irrigation operation time is shortened and the wet state of the soil can be alleviated, and therefore the environment can be improved by bringing the volume water content and the pF value close to those appropriate for the crop.

When the fluctuation of the pF value having been detected fluctuates in a direction in which the soil condition is dried, the control device 200 updates the stop threshold value such that the next irrigation operation time becomes longer. For example, when the detected pF value fluctuates in a direction in which the soil condition is dried, the control device 200 updates the stop threshold value to be a high value. Due to this, the next irrigation operation time is lengthened and the dried state of the soil can be alleviated, and therefore the environment can be improved by bringing the volume water content and the pF value close to those appropriate for the crop.

The control device 200 updates the stop threshold value based on the fluctuation of the pF value detected during the irrigation operation stop. According to this, the pF value having poor responsiveness to the VWC is detected during the irrigation operation stop. Therefore, it is possible to adopt a pF value contributing to obtaining the stop timing of an irrigation operation with high accuracy.

The control device 200 updates the stop threshold value to be a lower value when the detected pF value deviates below the control range of the pF value set as an appropriate fluctuation range. According to this, it is possible to achieve a state in which the pF value fluctuates in an appropriate control range in the next irrigation operation, and it is possible to quickly return the soil condition from the overwet state to an appropriate soil condition.

The control device 200 updates the stop threshold value to be a higher value when the detected pF value deviates over the control range of the pF value set as an appropriate fluctuation range. According to this, it is possible to achieve a state in which the pF value fluctuates in an appropriate control range in the next irrigation operation, and it is possible to quickly return the soil condition from the overdried state to an appropriate soil condition.

### Second Embodiment

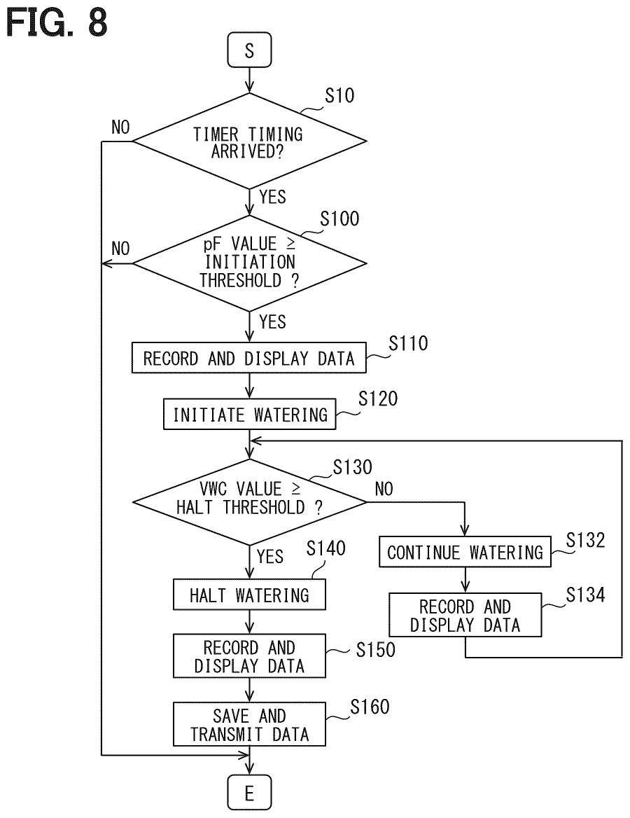

The second embodiment will be described with reference to FIG. 8. The watering system 1 of the second embodiment executes the processing according to the flowchart shown in FIG. 8 when performing the irrigation operation control processing. The watering system 1 of the second embodiment is different in executing the processing shown in FIG. 8 in place of the processing shown in FIG. 4 of the first embodiment. Configurations, actions, and effects not specifically described in the second embodiment are the same as those of the above-described embodiment, and different points will be described below.

The watering system 1 executes the processing according to the flowchart shown in FIG. 8 when performing the irrigation operation control processing. FIG. 8 is a flowchart showing an example of the operation at the time of an irrigation command. In FIG. 8, in steps having the same reference signs as those in FIG. 4, the same processing as those in the first embodiment is executed.

The control device 200 executes the processing shown in FIG. 8 by, for example, the monitoring unit 300 or the integrated calculation unit 600. First, in step S10, for example, the processor 334 determines whether the irrigation time by the timer has come.

When it is determined in step S10 that the irrigation time by the timer has not come, the flowchart is ended without starting irrigation. In the irrigation operation control of the second embodiment, the pF value of the soil is not confirmed until the irrigation time by the timer comes. When it is determined in step S10 that the irrigation time by the timer has come, the pF value is checked and it is determined in step S100 whether the irrigation start condition is established. In the subsequent processing, the same processing as the irrigation operation control described in the first embodiment is performed.

### Third Embodiment

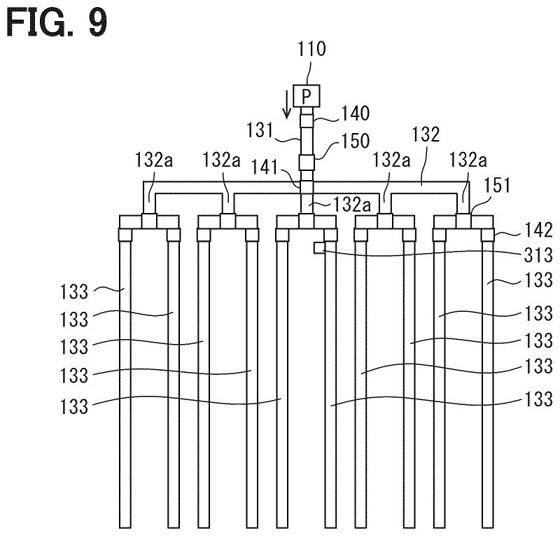

The third embodiment will be described with reference to FIG. 9. The watering system 1 of the third embodiment is different from the first embodiment in including an integrated sensor device 313 in which the pF sensor 312 and the VWC sensor 311 are integrated. Configurations, actions, and effects not specifically described in the third embodiment are the same as those of the above-described embodiment, and different points will be described below.

The integrated sensor device 313 detects an environment value related to the soil condition of the corresponding divided area. The integrated sensor device 313 detects and outputs, to the acquisition unit 331, both the pF value and the VWC related to the soil condition. The pF value and the VWC output to the acquisition unit 331 are used for the irrigation operation control as described in the above-described embodiments.

### Fourth Embodiment

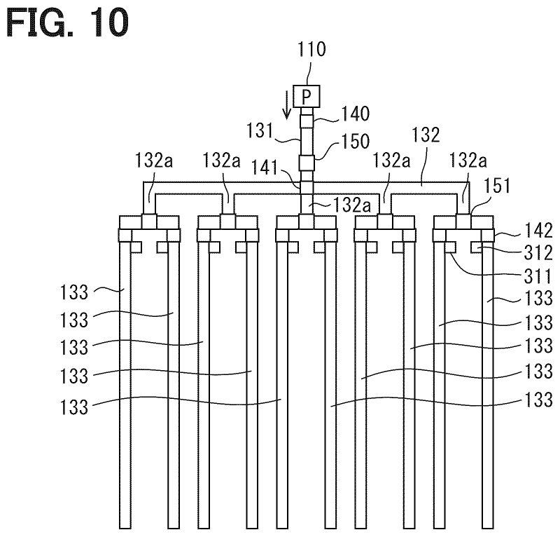

The fourth embodiment will be described with reference to FIG. 10. The watering system 1 of the fourth embodiment is different from the first embodiment in that the pF sensor 312 and the VWC sensor 311 are installed at positions illustrated in FIG. 10. Configurations, actions, and effects not specifically described in the fourth embodiment are the same as those of the above-described embodiment, and different points will be described below.

As illustrated in FIG. 10, the pF sensor 312 and the VWC sensor 311 are installed so as to correspond to each of the ridges arranged in the field 20. The VWC sensor 311 and the pF sensor 312 detect the soil condition of each ridge. This configuration enables the soil condition to be determined for each ridge, and irrigation suitable for the soil condition to be individually managed.

### Fifth Embodiment

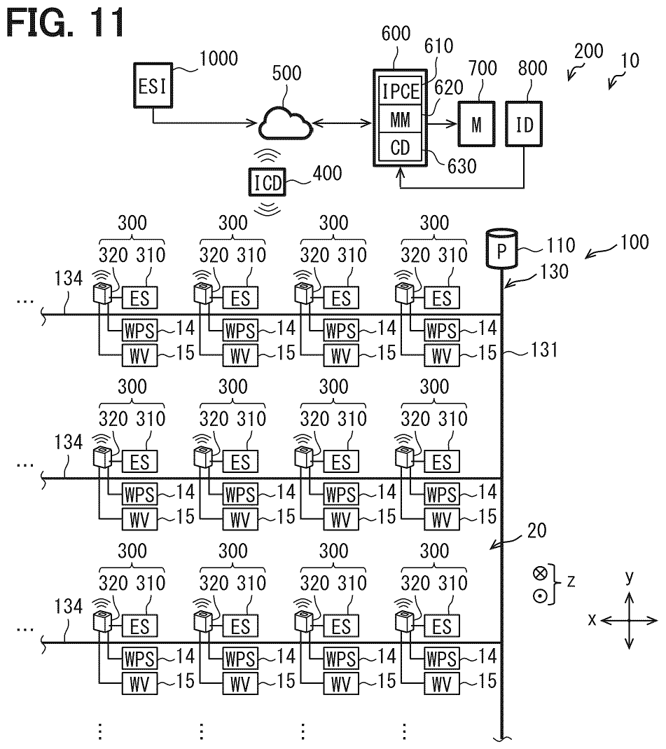

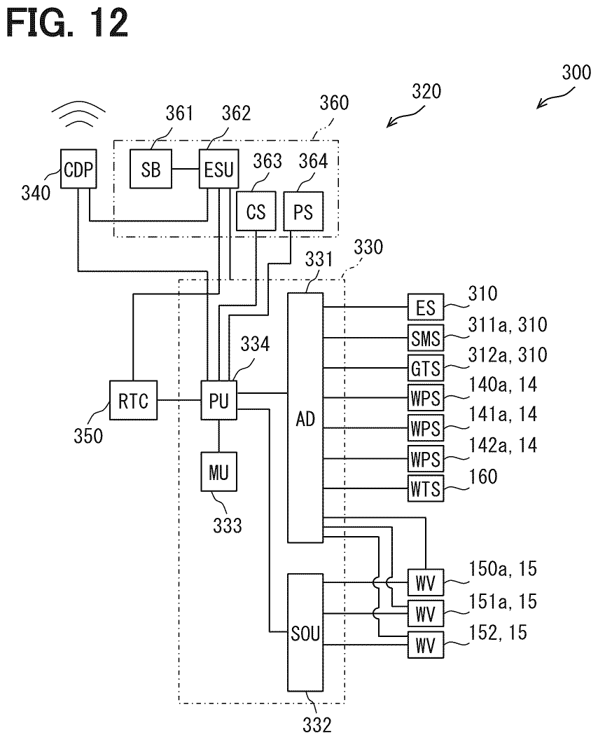

The fifth embodiment disclosing an example of the watering system will be described with reference to FIGS. 11 and 12. Hereinafter, three directions in an orthogonal relationship with one another are indicated as an x direction, a y direction, and a z direction. In this description, a plane defined by the x direction and the y direction is along a horizontal plane. The z direction is along the vertical direction. In the drawings, description of “direction” is omitted, and x, y, and z are simply described.

### FIELD

A watering system 10 is applied to the field 20 that is outdoor cultivated in a hill or a plain. As illustrated in FIG. 11, the watering system 10 is applied to the field 20 cultivated in a plain. The size of this field 20 is several ten square meters to several thousand square kilometers. The field 20 is provided with growth places such as ridges extending in the x direction. The growth places extending in the x direction are arranged apart from one another in the y direction. Plant seeds and seedlings are buried in each of the growth places. Examples of this plant include grape, corn, almond, raspberry, leaf vegetables, and cotton. The watering system 10 may have a configuration to be applied to the field 20 provided indoor such as a greenhouse. Therefore, the field 20 in this description can be applied to soil provided outdoor or indoor.

Plants are grown in one growth place. The plants are arranged in one row in the x direction. Hereinafter, the plants arranged in a row in the x direction is called a plant group. In the field 20, plural plant groups are arranged apart in the y direction. The shortest separation distance in the y direction of the plant groups is longer than the shortest separation distance in the x direction of the plants included in one plant group. The separation interval in the y direction of the plant groups is variously changed depending on the type of the growing plant and the undulations and climate of the field 20. The separation interval in the y direction of the plant groups is about 1 m to 10 m. Even if branches of the plant grow thick in the y direction, at least a width that allows a person to move in the x direction between two plant groups is secured.

### <Irrigation System>

The watering system 10 includes the water supply device 100 and the control device 200. The water supply device 100 supplies irrigation water to a plant in the field 20. The control device 200 determines a supply time and an amount of the irrigation water supplied from the water supply device 100 to the plant during an irrigation period. The control device 200 determines an irrigation schedule of the water supply device 100. The watering system 10 can detect an abnormal state such as water leakage or clogging at the time of irrigation and perform irrigation return (fail safe) in a case where the abnormal state occurs.

### <Water Supply Device>

The water supply device 100 includes a pump 110 and a water supply pipe 130. The pump 110 is a water supply source that causes irrigation water to flow down to the water supply pipe 130.

### <Pump>

The pump 110 is in a constantly driven state. Alternatively, the pump 110 is in a daytime driven state. Driving and stopping of the pump 110 are controlled by the control device 200. The pump 110 pumps out irrigation water stored in a tank or a reservoir and supplies the irrigation water to the water supply pipe 130. Examples of the irrigation water include well water, river water, rainwater, and tap water. The water supply pipe 130 is provided with the water source valves 15 that can control a flow rate of irrigation water to be discharged to the field 20. When each of these water source valves 15 is in the closed state and no irrigation water is leaked from the water supply pipe 130, the water supply pipe 130 is filled with the irrigation water. At this time, the water pressure in the water supply pipe 130 is a value (also called pump pressure) dependent of the discharge capacity of the pump 110. When the water source valve 15 is brought into an open state from the closed state, the irrigation water is discharged from the water supply pipe 130 to the field 20. When a discharge amount of the irrigation water is stabilized on a time average, the water pressure in the water supply pipe 130 becomes a flow pressure that is lower in water pressure than the pump pressure.

### <Water Supply Pipe>

The water supply pipe 130 includes a main pipe. The main pipe is coupled to the pump 110. The pump 110 supplies the main pipe with irrigation water. The irrigation water is supplied to the field 20 via the main pipe.

### <Main Pipe>

The main pipe includes the vertical pipe 131 and a first coupling pipe 134. The vertical pipe 131 extends in the y direction. The first coupling pipe 134 extends in the x direction. The vertical pipe 131 and the first coupling pipe 134 are coupled to each other. With such a configuration, the irrigation water flows in the y direction and the x direction through the main pipe. In the example illustrated in FIG. 11, one vertical pipe 131 is coupled to one pump 110. The first coupling pipes 134 extend from the vertical pipe 131 extending in this y direction.

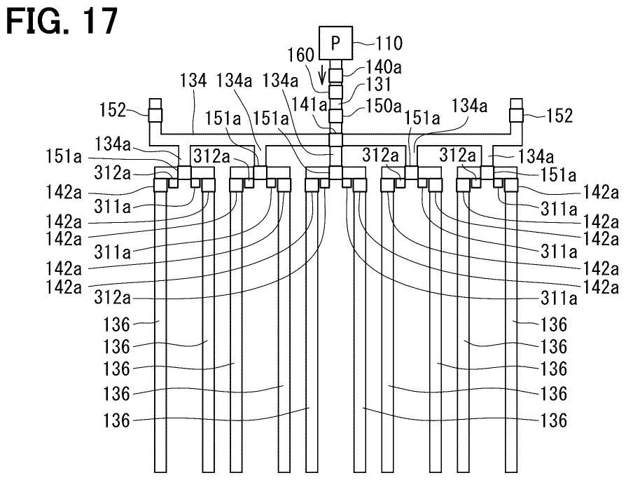

The configuration of the water supply path illustrated in FIGS. 11 and 17 is merely an example of a passage configuration related to irrigation. The number of the pumps 110 and the vertical pipes 131 provided in the field 20, the number of the vertical pipes 131 coupled to one pump 110, the number of the vertical pipes 131 coupled to one first coupling pipe 134, and the positions in the z direction of the first coupling pipe 134 and the vertical pipes 131 are not particularly limited.

The first coupling pipes 134 are arranged apart from one another in the y direction. The shortest separation distance in the y direction of the first coupling pipes 134 is equal to the shortest separation distance in the y direction of the plant groups. One of the first coupling pipes 134 is provided in one of the plant groups. The first coupling pipe 134 extends along a direction in which the plants included in the plant group are arranged. A supply pipe is coupled to this first coupling pipe 134.

The watering system 10 includes distribution tubes 136 through which irrigation water is released more downstream in the water supply path than the first coupling pipe 134. Each distribution tube 136 is a supply unit that supplies irrigation water to the plant in the field 20. Each distribution tube 136 is installed at a position where irrigation water can be supplied to a ridge provided in the field 20. The distribution tube 136 may be configured to have a pressure correction mechanism that achieves a constant discharge amount regardless of a water pressure change, or may be configured not to have the pressure correction mechanism.

In the distribution tube 136, through holes causing the inside and the outside of the tube through which irrigation water flows to communicate with each other is formed. The through holes are provided side by side at predetermined intervals in an axial direction of the tube in each tube. The through holes may be configured to be provided side by side at predetermined intervals in a circumferential direction of the tube in each tube. The separation interval in the axial direction of the through holes (e.g., the x direction) is equal to the separation interval in the x direction of the plants. The separation interval of the through holes and the separation interval of the plants may be different.

### <Flow of Irrigation Water>

The irrigation water supplied to the vertical pipe 131 by the pump 110 flows in the y direction through the vertical pipe 131. This irrigation water is supplied to each of the first coupling pipes 134 coupled to the vertical pipe 131. The irrigation water flows in the x direction through each of the first coupling pipes 134. The irrigation water flowing through the first coupling pipe 134 flows down to the distribution tube 136 via a branch pipe 134a. The irrigation water is discharged from each through hole in the distribution tube 136 and supplied to the plant. The irrigation water supplied from each through hole of the distribution tube 136 is supplied mainly to a trunk or a root of the plant.

The through hole is provided at a position higher than a part facing the ground in each distribution tube 136, for example. In this case, the irrigation water discharged from the through hole spreads in a direction radiating with respect to a center axis of the distribution tube 136, and can be sprayed to a position away from the tube.

### <Water Supply Valve>

The water source valve 15 is provided more upstream than the distribution tube 136 in the water supply path. When the water source valve 15 is brought into the open state, the water supply pipe 130 and each through hole of the distribution tube 136 communicate with each other. Due to this, irrigation water is discharged from the through hole. On the other hand, when the water source valve 15 is brought into the closed state, communication between the water supply pipe 130 and each through hole of the distribution tube 136 is interrupted. This stops the discharge of irrigation water from the through hole.

When the control device 200 controls a valve opening degree, the water source valve 15 controls the flow rate of the irrigation water to be discharged from the through hole of the distribution tube 136. The control device 200 controls the valve opening degree of the water source valve 15 to an arbitrary value from a predetermined opening degree to full opening. The water source valve 15 is a flow regulating valve or a pressure regulating valve that can precisely vary the flow rate passing therethrough by regulating the downstream or upstream pressure. The predetermined opening degree is set to a slightly opened opening degree or an opening degree of 0%, that is, a value including full close.

By controlling the valve opening degree of the water source valve 15, the control device 200 controls a discharge flow rate or a discharge flow velocity per unit time discharged from each through hole. With this control, the control device 200 can control a water flying distance, which is a distance at which the irrigation water discharged from the distribution tube 136 lands away from the distribution tube 136, or a discharge amount. The water flying distance is a distance between a soil landing point of irrigation water flying out of the distribution tube 136 through the through hole and the distribution tube 136. According to the technology for controlling this water flying distance, it is possible to perform efficient irrigation to a place needing irrigation and also contribute to water saving. The water source valve 15 is an on-off valve that controls flowing down of water supply and interruption of water supply, and functions as a flow regulating valve that can control a water supply flow rate.

The control device 200 determines the water flying distance of irrigation based on the type of a plant supplied with the irrigation, the range of a plowed soil layer of the field 20, and the like. The control device 200 controls the valve opening degree of the water source valve 15 so as to obtain the determined water flying distance. For example, the valve opening degree of the water source valve 15 is controlled to increase the water flying distance in a case where the plant has a wide root or a plowed soil layer is shallow and wide. The valve opening degree of the water source valve 15 is controlled so as to suppress the water flying distance to be small in a case where the plant roots deeply or the plowed soil layer is positioned near the distribution tube 136. The water flying distance can be paraphrased as an irrigation distance.

### <Water Pressure Sensor>

A water pressure sensor 14 is provided in a pipe included in the water supply pipe 130. The water pressure sensor 14 is a pressure sensor that detects a water pressure in the pipe. The water pressure detected by the water pressure sensor 14 is output to the control device 200. The water pressure sensor 14 is installed at a site more upstream than the distribution tube 136 in the water supply path. Furthermore, the water pressure sensor 14 may be configured to be installed at a site more downstream than the distribution tube 136 in the water supply path.

When the water source valve 15 is brought into the closed state and the pipe is filled with irrigation water, the water pressure sensor 14 detects the pump pressure. When the water source valve 15 is brought into the open state from the closed state, the irrigation water is discharged from the distribution tube 136. When a discharge amount of the irrigation water is stabilized on a time average, the water pressure sensor 14 detects the flow pressure. When the water source valve 15 is brought into the closed state from the open state, the discharge of irrigation water from water supply pipe 130 is stopped. The water pressure in the water supply pipe 130 gradually recovers from the flow pressure to the pump pressure. The water pressure sensor 14 detects the water pressure in a transition period in which the flow pressure gradually recovers to the pump pressure.

When the water supply pipe 130 or the water source valve 15 is damaged and the irrigation water leaks from the damaged portion, the water pressure detected by the water pressure sensor 14 decreases. This can detect whether damage has occurred. The detection processing of this damage is executed by the control device 200. The watering system 10 may be configured to include a flow rate sensor that detects the flow rate of the fluid flowing through the passage in place of the water pressure sensor 14. The watering system 10 performs feedback control of the valve opening degree of the water source valve 15 using detection values of the water pressure sensor 14 and the flow rate sensor.

### <Control Device>

As illustrated in FIGS. 11 and 12, the control device 200 includes the monitoring unit 300, the integrated communication unit 400, the information storage unit 500, and the integrated calculation unit 600. In the drawings, the integrated communication unit 400 is denoted as ICD. The control device 200 includes the monitoring units 300. Each of the monitoring units 300 corresponds to a predetermined divided area in the field 20.

The water pressure detected by the water pressure sensor 14 is input to the monitoring unit 300. The monitoring unit 300 detects an environment value that is a physical quantity related to the environment of the field 20. Each of the monitoring units 300 outputs the water pressure and the environment value to the integrated communication unit 400 by wireless communication.

The integrated communication unit 400 outputs, to the information storage unit 500 by wireless communication, the water pressure and the environment value input from each monitoring unit 300. The information storage unit 500 stores the water pressure and the environment value. An example of the information storage unit 500 is what is called a cloud. The integrated calculation unit 600 reads various pieces of information such as the water pressure and the environment value stored in the information storage unit 500. The integrated calculation unit 600 appropriately processes the various pieces of information that are read, and displays the various pieces of information and processing results on a monitor 700 of a user's smartphone or personal computer.

The integrated calculation unit 600 is included in the user's smartphone, personal computer, or the like. The integrated calculation unit 600 includes information processing calculation equipment 610, a memory 620, and a communication device 630. In the drawings, the information processing calculation equipment 610 is denoted as IPCE, the memory 620 is denoted as MM, and the communication device 630 is denoted as CD. The information processing calculation equipment 610 includes a processor. The information processing calculation equipment 610 performs calculation processing related to irrigation processing. Such a function is achieved by downloading an irrigation application program to the information processing calculation equipment 610. The integrated calculation unit 600 may be a calculation device mounted on a cloud. In this case, the integrated calculation unit 600 and the information storage unit 500 may be configured to be mounted together on the cloud.

The memory 620 is a non-transitory tangible storage medium that non-transitorily stores various programs and various types of information readable by a computer or a processor. The memory 620 includes a volatile memory and a nonvolatile memory. The memory 620 stores various pieces of information input to the communication device 630 and a processing result of the information processing calculation equipment 610. The information processing calculation equipment 610 executes various type of calculation processing using the information stored in the memory 620.

The communication device 630 has a wireless communication function. The communication device 630 converts a received wireless signal into an electrical signal and outputs the electrical signal to the information processing calculation equipment 610. The communication device 630 outputs a processing result of the information processing calculation equipment 610 as a wireless signal. Hereinafter, the technical content of the present embodiment will be described with the integrated calculation unit 600, which is a generic term for the information processing calculation equipment 610, the memory 620, and the communication device 630 without particularly distinguishing them. The information processing calculation equipment 610 corresponds to a processing calculation unit.

The user inputs a user instruction related to the irrigation processing and the irrigation schedule to the integrated calculation unit 600 using input equipment 800 such as a touchscreen or a keyboard. The integrated calculation unit 600 outputs an irrigation processing command and determines an irrigation schedule based on this user instruction and various pieces of information read from the information storage unit 500. When there is no instruction from the user, the integrated calculation unit 600 automatically determines the irrigation schedule based on various pieces of information.

When detecting the irrigation processing command or determining that it is an irrigation start time based on the irrigation schedule, the integrated calculation unit 600 outputs an instruction signal for controlling the water source valve 15 to the information storage unit 500. This instruction signal is input from the information storage unit 500 to the monitoring unit 300 via the integrated communication unit 400. The monitoring unit 300 controls output and non-output of a water supply signal to the water source valve 15 based on the instruction signal. Due to this, an open-close state of water source valve 15 is controlled. As a result, the supply of irrigation water to the field 20 is controlled. At least one of the instruction signal and the water supply signal corresponds to the control signal.

### <Divided Area>

One monitoring unit 300 is provided for one distribution tube 136. One monitoring unit 300 may be configured to be provided for a predetermined number of distribution tubes 136. The monitoring unit 300 may be configured to be provided for each ridge. As illustrated in FIG. 11, the monitoring units 300, together with the water source valve 15 and the water pressure sensor 14, are arranged in a matrix in the field 20 with the x direction as a row direction and the y direction as a column direction.

With such a configuration, the environment related to each of the divided areas divided by the row direction and the column direction is individually monitored by the monitoring unit 300 corresponding to respective divided areas. Furthermore, the supply of irrigation water in each divided area is individually controlled by the corresponding monitoring unit 300.

### <Monitoring Unit>

As illustrated in FIG. 12, the monitoring unit 300 includes the control unit 320. An environment sensor 310, the water source valve 15, the water pressure sensor 14, a water temperature sensor 160, and the like are electrically connected to the control unit 320. In the drawings, the environment sensor 310 is denoted as ES, the water source valve 15 is denoted as WV, and the water pressure sensor 14 is denoted as WPS. The water source valve 15 is a water source valve 150a and a water source valve 151a as specific devices provided in the water supply path. The water pressure sensor 14 is a water pressure sensor 140a, a water pressure sensor 141a, and a water pressure sensor 142a as specific devices provided in the water supply path.

The environment sensors 310 are arranged in matrix in the field 20 corresponding to the divided areas. The environment sensors 310 detect environment values of respective divided areas. The water pressure sensor 14 detects the water pressure in each divided area. The environment value and water pressure of each divided area having been detected are stored in the information storage unit 500.

The control unit 320 includes the microcomputer 330, the communication unit 340, the RTC 350, and the power generation unit 360. The microcomputer is an abbreviation for microcomputer. RTC stands for real time clock. In the drawings, the communication unit 340 is denoted as CDP.

An environment value and a water pressure are input to the microcomputer 330. The microcomputer 330 outputs the environment value and the water pressure to the integrated communication unit 400 via the communication unit 340. An instruction signal is input from the integrated communication unit 400 to the microcomputer 330. The microcomputer 330 outputs a water supply signal to the water source valve 15 based on this instruction signal. The microcomputer 330 corresponds to a calculation processor. The microcomputer 330 is a control device that controls the operation of the water source valve 15. The microcomputer 330 has a sleep mode and a normal mode as operation modes. The sleep mode is a state in which the microcomputer 330 is stopping calculation processing. The normal mode is a state in which the microcomputer 330 is executing calculation processing. The normal mode consumes more power than the sleep mode.

The communication unit 340 performs wireless communication with the integrated communication unit 400. The communication unit 340 outputs, to the integrated communication unit 400 as a wireless signal, an electrical signal output from the microcomputer 330. Together with that, the communication unit 340 receives a wireless signal output from the integrated communication unit 400 and converts the wireless signal into an electrical signal. The communication unit 340 outputs the electrical signal to the microcomputer 330. When the electrical signal includes an instruction signal, the microcomputer 330 is switched from the sleep mode to the normal mode. The microcomputer 330 may be in the form of waking up before receiving the electrical signal.

The RTC 350 has a clock function for keeping time and a timer function for measuring time. The RTC 350 outputs a wake-up signal to the microcomputer 330 when a preset time has come or when a preset time has elapsed. When this wake-up signal is input to microcomputer 330 in the sleep mode, the microcomputer 330 is switched from the sleep mode to the normal mode.

The power generation unit 360 converts light energy acquired by a solar cell 361 into electric energy. The power generation unit 360 functions as a power supply source of the monitoring unit 300. Power supply is continuously performed from the power generation unit 360 to the RTC 350. Due to this, the clock function and the timer function of the RTC 350 are suppressed from being impaired. The solar cell 361 may be configured to be replaced with a primary battery or a secondary battery.

### <Environment Sensor>

There is a soil water content as one of the environment values assumed to be different for each of the divided areas of the field 20. The environment sensor 310 detects the environment value in the corresponding divided area. The environment sensor 310 includes a soil sensor 311a that detects a soil water content and the like. The soil sensors 311a detect the soil water contents of the divided areas arranged in the field 20. In the drawings, the soil sensor 311a is denoted as SMS.

There is a solar radiation amount as one of the environment values assumed to be different for each of the divided areas depending on the undulations of the field 20 and the growth situation of the plant. In this description, each environment sensor 310 includes a solar radiation sensor that detects a solar radiation amount. The solar radiation sensors detect solar radiation amounts in the divided areas in the field 20.

The monitor 700 display a map of a soil water content distribution and a solar radiation amount distribution in the field 20 by arranging, in a matrix, the soil water contents and the solar radiation amounts detected in the divided areas. Similarly, the water pressures detected by the water pressure sensors 14 are arranged in a matrix on the monitor 700, whereby the water pressure distribution of the water supply pipe 130 in the field 20 is displayed in a map on the monitor 700. Such map display processing is performed by the integrated calculation unit 600.

The environment values in the field 20 include rainfall, temperature, humidity, atmospheric pressure, carbon dioxide concentration, and air volume. The sensors that detect these environment values are a rain sensor, a ground temperature sensor 312a, a humidity sensor, an atmospheric pressure sensor, a CO2 sensor, a wind sensor, and the like. These are included in at least one environment sensor 310 of the monitoring units 300.

The environment sensor 310 of the monitoring unit 300 includes various sensors that detect environment values of the entire field 20. In the drawings, the ground temperature sensor 312a is denoted as GTS. The wind sensor may be configured to detect not only the air volume but also the wind direction. It is also possible to adopt a configuration in which at least one of the rain sensor, the ground temperature sensor 312a, the humidity sensor, the atmospheric pressure sensor, and the wind sensor is arranged in a matrix in the field 20.

Such a configuration is effective in a case where the rainfall, the temperature, the humidity, the atmospheric pressure, and the air volume are likely to greatly change for each divided area, for example, because the field 20 is wide, the undulations of the field 20 are severe, or the climate change of the field 20 is severe. By arranging, in a matrix, the rainfall, the temperature, the humidity, the atmospheric pressure, and the air volume detected by these sensors, it is possible to display, in a map, these environment values on the monitor 700. Outputs of these sensors are output to the communication unit 340 via the integrated communication unit 400. Together with that, the outputs of these sensors are stored in the information storage unit 500 via the integrated communication unit 400.

### <Soil Water Content>

Among the various environment values described so far, the environment values controlled by the watering system 10 include the soil water content. The watering system 10 controls a supply time and a supply amount of irrigation for each divided area. Due to this, the soil water content for each divided area is individually controlled.

The plant roots in the plowed soil layer of the field 20. Growth of the plant is dependent of the water content of the soil (also called soil water content) of this plowed soil layer. When the soil water content exceeds a growth inhibition moisture point, diseases occur in the plant. When the soil water content falls below a permanent wilting point, wilt of the plant is not recovered. The growth inhibition moisture point and the permanent wilting point vary depending on the type of the plant, and these values are stored in the information storage unit 500.

The current value of the soil water content is detected by the soil sensor 311a. Examples of the physical quantity related to the soil water content include soil water content tension (pF value) and soil permittivity (8). The soil sensor 311a of this description detects the pF value.

The soil water content of the plowed soil layer increases or decreases depending on an environment change of the field 20. When it rains in the field 20, the soil water content increases. When water evaporates from the plowed soil layer, the soil water content decreases. When the plant absorbs moisture or water penetrates into a layer lower than the plowed soil layer, the soil water content decreases. The amount of rain (rainfall) falling on the plowed soil layer is detected by the rain sensor. An evaporation amount that is the water content evaporated from the plowed soil layer is dependent of the solar radiation amount, temperature, humidity, and air volume. These are detected by the solar radiation sensor, the ground temperature sensor 312a, the humidity sensor, and the wind sensor.

The water absorption amount by which the plant absorbs moisture per unit time can be estimated in advance depending on the type of the plant. The water content penetrating into a layer lower than the plowed soil layer per unit time can be estimated in advance by the moisture retention capability of the soil. This estimate value is stored in the information storage unit 500.

As described above, the environment sensor 310 detects each of the current value related to the soil water content of the plowed soil layer, and a prediction value related to increase and decrease prediction from the current value of the soil water content of the plowed soil layer due to an environment change. These are stored in the information storage unit 500 as environment values. The information storage unit 500 stores the growth inhibition moisture point and the permanent wilting point of the plant, the water absorption amount by which the plant absorbs moisture per unit time, and the moisture retention capability of the soil. The user instruction, which is the above-described instruction from the user, is stored in the information storage unit 500. In this manner, the information storage unit 500 stores various pieces of information for determining the irrigation schedule. The watering system 10 may be configured to confirm the detection value of the soil sensor in real time and perform control to stop irrigation when the detection value reaches a threshold value.

### <Microcomputer>

As illustrated in FIG. 12, the microcomputer 330 includes the acquisition unit 331, the signal output unit 332, the storage unit 333, and the processor 334. In the drawings, the acquisition unit 331 is denoted as AD, the signal output unit 332 is denoted as SOU, the storage unit 333 is denoted as MU, and the processor 334 is denoted as PU. The environment value detected by the environment sensor 310 is input to the acquisition unit 331. The water pressure detected by the water pressure sensor 14 is input to the acquisition unit 331. The acquisition unit 331 is electrically connected to each of the environment sensor 310 and the water pressure sensor 14.

The signal output unit 332 is electrically connected to the water source valve 15. A control signal (water supply signal) for controlling the valve opening degree of the water source valve 15 is output from the signal output unit 332 to the water source valve 15. The water source valve 15 is in the closed state when the water supply signal is not yet input. The water source valve 15 is in the open state when the water supply signal is input. The water source valve 15 may be configured to maintain the current state in a case where the water supply signal is not input, and to open and close in accordance with the input content in a case where the water supply signal is input. For example, when the control signal is not yet input, the valve opening degree of the water source valve 15 is maintained, and the valve opening degree of the water source valve 15 is adjusted in accordance with the control signal of the opening degree instruction input at the time of input.

The storage unit 333 is a non-transitory tangible storage medium that non-transitorily stores programs and data readable by a computer or a processor. The storage unit 333 includes a volatile memory and a nonvolatile memory. The storage unit 333 stores a program for the processor 334 to execute calculation processing. This program includes at least a part of the above-described irrigation application program. The storage unit 333 transitorily stores data when the processor 334 executes calculation processing. The storage unit 333 stores various data input to each of the acquisition unit 331 and the communication unit 340, and acquisition times of the various data.

When the wake-up signal is input from the RTC 350, the processor 334 is switched from the sleep mode to the normal mode. In the normal mode, the processor 334 reads a program and various data stored in the storage unit 333 and executes calculation processing. This calculation processing includes calculation of a valve opening degree necessary for causing water having flown through the through hole of the distribution tube 136 to reach a desired irrigation position. The processor 334 corresponds to a calculation unit. This calculation may be configured to be executed by the information processing calculation equipment 610 of the integrated calculation unit 600.

The processor 334 reads various sensor signals input to the acquisition unit 331, and the acquisition time of the instruction signal input to the communication unit 340 from the RTC 350. The processor 334 causes the storage unit 333 to store the instruction signal and the acquisition time. Reading of the acquisition time may be configured such that the integrated communication unit 400 is caused to record the data acquisition time when the integrated communication unit 400 wirelessly receives data from each monitoring unit 300. The information storage unit 500 may be configured to be caused to record the data acquisition time when the information storage unit 500 wirelessly receives data from the integrated communication unit 400.

The processor 334 stores the environment values and the water pressure input from the environment sensor 310 and the water pressure sensor 14, and the acquisition times thereof into the information storage unit 500 via the communication unit 340 and the integrated communication unit 400. The processor 334 outputs the water supply signal to the water source valve 15 via the signal output unit 332 based on the instruction signal input from the integrated calculation unit 600 via the information storage unit 500, the integrated communication unit 400, and the communication unit 340.

### <Communication Unit>

The communication unit 340 converts the electrical signal input from the processor 334 into a wireless signal. The communication unit 340 outputs this wireless signal to the integrated communication unit 400. The communication unit 340 converts, into an electrical signal, the wireless signal output from the integrated communication unit 400. The communication unit 340 outputs this electrical signal to the processor 334. The wireless signal output from the communication unit 340 contains an address and data. Wireless signals are transmitted and received between the communication units 340 and the integrated communication unit 400. The address contained in the wireless signal is an identification code indicating from which of the communication units 340 the wireless signal is output. In other words, the address contained in the wireless signal is an identification code indicating from which the processors 334 the wireless signal is output. A unique address is saved in each of the storage units 333.

The wireless signal output from the integrated communication unit 400 also contains an address. The data of this wireless signal contains an instruction signal. This wireless signal is received by each communication unit 340. This wireless signal is converted into an electrical signal by each communication unit 340. Then, this electrical signal is input to each processor 334. Among the processors 334, only the processor 334 having an identical address to the address contained in the electrical signal executes the calculation processing based on the electrical signal. The microcomputer 330 performs intermittent drive in which the sleep mode and the normal mode are alternately repeated. Therefore, wireless communication between the communication unit 340 and the integrated communication unit 400 is not frequently performed.

### <Power Generation Unit>

The power generation unit 360 includes the solar cell 361, the power storage unit 362, the voltage sensor 363, and the power sensor 364. In the drawings, the solar cell 361 is denoted as SB, the power storage unit 362 is denoted as ESU, the voltage sensor 363 is denoted as CS, and the power sensor 364 is denoted as PS. The solar cell 361 converts light energy into electrical energy. The power storage unit 362 stores the electric energy (power). The power stored in the power storage unit 362 is utilized as drive power of the monitoring unit 300.

The voltage sensor 363 detects a voltage value output from the solar cell 361 to the power storage unit 362. The power sensor 364 detects power output from the power storage unit 362. The processor 334 stores a detected current value and a detected power value in the information storage unit 500 via the communication unit 340 and the integrated communication unit 400. The drive power of the monitoring unit 300 is dependent of the power generated by the power generation unit 360. Therefore, when the amount of light incident on the power generation unit 360 is small, the drive power of the monitoring unit 300 may be insufficient. In order to avoid this, the microcomputer 330 of the monitoring unit 300 performs intermittent drive. The voltage sensor 363 may be configured to be replaced with a current sensor that detects a current output from the solar cell 361 to the power storage unit 362. The power generation unit 360 may be configured not to include a voltage sensor or a current sensor.

### <RTC>

The RTC 350 outputs the wake-up signal to the microcomputer 330 every time a time interval (drive cycle) of the intermittent drive described above elapses. Due to this, the microcomputer 330 alternately repeats the sleep mode and the normal mode. The drive cycle described above is determined by the integrated calculation unit 600 in accordance with the power amount (power storage amount) stored in the power storage unit 362. The intermittent drive interval is determined by the integrated calculation unit 600 in accordance with the power storage amount.

The integrated calculation unit 600 calculates the power storage amount based on the power stored in the information storage unit 500. The integrated calculation unit 600 sets the intermittent drive interval to be longer as the power storage amount is smaller. The integrated calculation unit 600 sets the intermittent drive interval to be shorter as the power storage amount is greater. The integrated calculation unit 600 contains the intermittent drive interval into the instruction signal. When the processor 334 of the microcomputer 330 acquires this instruction signal, the processor 334 adjusts the intermittent drive interval. The processor 334 adjusts the drive cycle of the RTC 350. It is rare that the environment of the field 20 changes extremely in units of several seconds. Therefore, the intermittent drive interval is in units of several ten seconds to several ten hours. In response to this, a time interval at which wireless communication is performed is also in units of several ten seconds to several ten hours.

### <Drive of Watering System>

The watering system 10 performs transmission and reception of signals between the monitoring units 300 and the integrated calculation unit 600, and saving of various data into the information storage unit 500. Each of the monitoring units 300 and the integrated calculation unit 600 executes a cycle task to be processed for each drive cycle and an event task to be processed suddenly.

These cycle task and event task have priorities in processing. When the processing timings of these tasks become the same, the processing of the event task is prioritized over the processing of the cycle task. As the cycle task, each monitoring unit 300 executes sensor processing. The integrated calculation unit 600 executes update processing. As the event task, each monitoring unit 300 executes monitoring processing and water supply processing. The integrated calculation unit 600 executes the irrigation processing, the user update processing, and the forcible update processing.

### <Sensor Processing>

Before the sensor processing, the microcomputer 330 of the monitoring unit 300 is in the sleep mode, and the wake-up signal is input from the RTC 350 to this microcomputer 330. By this, the microcomputer 330 is switched from the sleep mode to the normal mode. Then, the microcomputer 330 starts to execute the sensor processing. The sensor processing is executed at the intermittent drive interval of the microcomputer 330. First, sensor signals input from various sensors are acquired, and acquisition time of the sensor signals is further acquired based on the output of the RTC 350. Furthermore, each of the acquired sensor signals and the acquisition time is stored. Next, the sensor signal and the acquisition time as the sensor information are output from the communication unit 340 to the integrated communication unit 400 by wireless communication. This sensor information is stored in the information storage unit 500 by the integrated communication unit 400. The microcomputer 330 shifts to the sleep mode and ends the sensor processing.

### <Update Processing>

The integrated calculation unit 600 executes the update processing every time an update cycle elapses. This update cycle is about the same as the intermittent drive interval of the microcomputer 330. First, various pieces of information stored in the information storage unit 500 are read. Next, the irrigation schedule of each of the monitoring units 300 is updated based on the read various pieces of information. The integrated calculation unit 600 updates the sensor processing in each monitoring unit 300. The integrated calculation unit 600 updates the intermittent drive interval corresponding to the timing of executing the sensor processing. The integrated calculation unit 600 itself holds and stores, into the information storage unit 500, the updated irrigation schedule and intermittent drive interval, and ends the update processing. As described above, the sensor information, the irrigation schedule, and the intermittent drive interval are updated by the cycle task.

Each of the monitoring processing, the water supply processing, and the irrigation processing is executed in the daytime in order to avoid depletion of the drive power of the monitoring unit 300. Determination as to whether it is daytime can be detected based on the current time, the solar radiation amount detected by a solar radiation sensor, and the like.

### <Monitoring Processing>

Before the monitoring processing, the microcomputer 330 of each monitoring unit 300 is in the sleep mode. The instruction signal is input from the integrated calculation unit 600 to the microcomputer 330 by wireless communication. As a result, the microcomputer 330 is switched from the sleep mode to the normal mode and starts executing the monitoring processing.

First, the input instruction signal and the acquisition time thereof are stored. Next, it is determined whether the instruction signal contains a water supply instruction for bringing the water source valve 15 into the open state from the closed state. When the water supply instruction is contained in the instruction signal, the water supply processing is executed. In the water supply processing, the microcomputer 330 outputs the water supply signal to the water source valve 15 in accordance with the water supply instruction. The microcomputer 330 further determines whether the water supply time contained in the instruction signal has elapsed. When the water supply time has not elapsed, output of the water supply signal to the water source valve 15 is continued. When the water supply time has elapsed, output of the water supply signal is stopped and the water supply processing is ended.

When the water supply instruction is not contained in the instruction signal, the water supply processing is not executed, and it is determined whether the instruction signal contains an update instruction for the intermittent drive interval. The update instruction for the intermittent drive interval is regularly or irregularly output as an instruction signal from the integrated calculation unit 600 or the information storage unit 500 to each monitoring unit 300. When the update instruction for the intermittent drive interval is contained in the instruction signal, the processor 334 of the microcomputer 330 adjusts the time interval at which the wake-up signal of the RTC 350 is output.

When the update instruction for the intermittent drive interval is not contained in the instruction signal, the sensor processing is executed. When the water supply processing is executed, an environment value after irrigation supply is detected in the sensor processing. When the water supply processing is not executed, an environment value when irrigation is not supplied is detected in the sensor processing. This environment value is stored in the information storage unit 500. Upon finishing execution of the sensor processing, the microcomputer 330 shifts to the sleep mode and ends the monitoring processing. The start condition of the monitoring processing is not limited to the instruction signal from the integrated calculation unit 600. After the RTC 350 activates the microcomputer 330, the microcomputer 330 sends sensor data to the integrated calculation unit 600 after processing. Then, the integrated calculation unit 600 may be configured to send an instruction of the timing of the next intermittent drive together with an opening degree instruction of the valve.

### <Irrigation Processing>

The integrated calculation unit 600 executes the irrigation processing at each timing of supplying irrigation the irrigation schedule of each monitoring unit 300. First, the integrated calculation unit 600 outputs a water supply signal containing a water supply instruction toward the monitoring unit 300 of the divided area scheduled to be supplied with irrigation, among the monitoring units 300. The water supply instruction contains output start of the water supply signal and output time (water supply time) of the water supply signal. Upon receiving this water supply instruction, the monitoring unit 300 executes the above-described monitoring processing.

The integrated calculation unit 600 is brought into a standby state until the monitoring processing of the monitoring unit 300 is ended. When the monitoring processing is ended, the update processing is executed. Determination as to whether the monitoring processing is ended is made based on, for example, whether a time for which the monitoring processing is expected to be ended has elapsed. The determination as to whether the monitoring processing is ended can be made by inquiring the monitoring unit 300. An end determination method of the monitoring processing is not particularly limited.

### <User Update Processing>

The integrated calculation unit 600 executes the user update processing when a user instruction related to adjustment of the irrigation schedule and the intermittent drive interval is input from the input equipment 800. First, the integrated calculation unit 600 stores, into the information storage unit 500, the input user instruction. Next, the above-described update processing is executed. As described above, the irrigation schedule and the intermittent drive interval are updated based on the user instruction.

### <Forcible Update Processing>

The integrated calculation unit 600 executes the forcible update processing when a user instruction related to update of the irrigation schedule and the intermittent drive interval is input. First, the integrated calculation unit 600 outputs a request signal containing a request instruction for requesting execution of the sensor processing. This request signal is output to the monitoring unit 300 by wireless communication. Next, the update processing is brought into the standby state until the sensor processing of the monitoring unit 300 is ended.

When the sensor processing is ended, the above-described update processing is executed. Determination as to whether the sensor processing is ended is made based on, for example, whether a time for which the sensor processing is expected to be ended has elapsed. Whether the sensor processing is ended can be performed by inquiring of the monitoring unit 300. An end determination method of the sensor processing is not particularly limited. The irrigation schedule and the intermittent drive interval are updated based on various data at the time of the update request of the user.

### <Individual Irrigation Processing>

As described above, the integrated calculation unit 600 determines the irrigation schedule in each of the divided areas. The integrated calculation unit 600 controls the supply of irrigation based on each irrigation schedule. Although the irrigation schedule in each divided area is determined by the integrated calculation unit 600, a configuration in which the supply of irrigation based on each irrigation schedule is individually controlled by each monitoring unit 300 may be adopted.

### <Independent Update>

Furthermore, for example, a configuration in which the irrigation schedule in each divided area is independently determined by the corresponding monitoring unit 300 may be adopted. In such a configuration, each monitoring unit 300 executes the above-described update processing.

### <Weather Forecast and Irrigation Schedule>

The information storage unit 500 stores a current value of the soil water content, a prediction value of a decrease change, and a user instruction. The information storage unit 500 stores the growth inhibition moisture point and the permanent wilting point of the plant, the water absorption amount by which the plant absorbs moisture per unit time, and the moisture retention capability of the soil. In addition to them, the information storage unit 500 stores a weather forecast of the field 20 output and distributed from the external information source 1000. In FIG. 11, the external information source 1000 is denoted as ESI. In the update processing, the integrated calculation unit 600 reads various pieces of information including a weather forecast from the information storage unit 500. The integrated calculation unit 600 determines the irrigation schedule in each monitoring unit 300.

### <Target Value and Estimate Value>

When determining the irrigation schedule, the integrated calculation unit 600 calculates a target value and an estimate value of the soil water content. The target value of the soil water content is naturally set to a value between the growth inhibition moisture point and the permanent wilting point. In order to attempt sound growth of the plant, the target value of the soil water content is set to a value separated to some extent from each of the growth inhibition moisture point and the permanent wilting point that are theoretical values.

The integrated calculation unit 600 sets, as a target value of this soil water content, an upper limit target value on the growth inhibition moisture point side and a lower limit target value on the permanent wilting point side. The integrated calculation unit 600 determines the irrigation schedule such that the estimate value of the soil water content comes between the upper limit target value and the lower limit target value during the irrigation period of the irrigation schedule. Even when it is predicted that the estimate value of the soil water content exceeds the upper limit target value due to rainfall, the integrated calculation unit 600 determines the irrigation schedule such that the estimate value of the soil water content does not exceed the growth inhibition moisture point.

There is a gap between the growth inhibition moisture point and the upper limit target value. This upper limit gap width is determined based on the climate of the field 20 in consideration of sound growth of the plant described above. The climate of the field 20 includes an expected value of an average rainfall of the field 20 in the irrigation period of the irrigation schedule and a total rainfall predicted by a weather forecast in the irrigation period. The expected value of an average rainfall of the field 20 in the irrigation period is stored in the information storage unit 500.

There is a gap between the permanent wilting point and the lower limit target value. This lower limit gap width is determined based on a restoration time in which restoration is expected when a failure occurs in the water supply device 100, a decrease amount per unit time of the soil water content, and the like, in consideration of sound growth of the plant. For example, the lower limit gap width is determined based on a value in which the restoration time and the decrease amount per unit time of the soil water content are multiplied. The restoration time is stored in the information storage unit 500.

When a weather forecast for one week is stored in the information storage unit 500 from the external information source 1000, for example, the integrated calculation unit 600 determines an irrigation schedule for one week. During this one week, when there is no rainfall forecast by the weather forecast, it is expected that the estimate value of the soil water content gradually decreases with the lapse of time. The decrease amount per unit time of the estimate value of this soil water content is determined based on the prediction value of a decrease change in the soil water content of the plowed soil layer. Hereinafter, for simplifying the notation, the estimate value of the soil water content is simply denoted as an estimate value as necessary.

As described above, the irrigation schedule is determined based on the estimate value of the soil water content based on the environment value and the like and the weather forecast. According to this, it is possible to suppress the soil water content in the outdoor divided area from becoming unsuitable for the plant due to a weather change such as rainfall or drying.

The integrated calculation unit 600 supplies water at the time when the estimate value of the soil water content in the irrigation schedule reaches the lower limit target value. This can suppress the soil water content from falling below the lower limit target value. The integrated calculation unit 600 makes the rainfall forecast time different from the irrigation water supply time. According to this, even if the rainfall is greater than the rainfall forecast, it is possible to suppress the soil water content from excessively increasing. The watering system 10 may confirm a detection value of the soil sensor 311a in real time and perform control of stopping irrigation when the detection value reaches a threshold value. In this case, calculation of the estimate value of the soil water content is unnecessary.

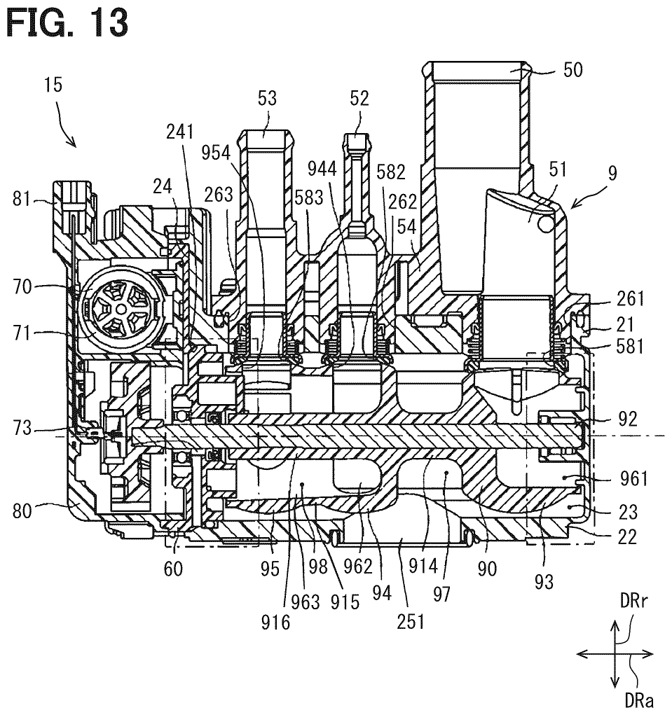

An example of a valve device applicable to the water source valve 15 will be described below with reference to FIGS. 13 to 15. This valve device is what is called a rotary valve device. This valve device includes one fluid inflow portion and three fluid outflow portions. This valve device is mounted on the watering system 10 by connecting an upstream pipe to the fluid inflow portion and connecting the distribution tube 136 to any one of the fluid outflow portions. Furthermore, the passage may be configured to be closed by attaching a closing member to the fluid outflow portion to which the distribution tube 136 is not connected.

As illustrated in FIG. 13, the valve device includes a housing 9, a valve 90, a drive unit 70, and a drive unit cover 80. The valve device is configured as a ball valve that performs an open-close operation of the valve device by the valve 90 rotating about an axial center of a shaft 92. In this description, description is given with a direction along the axial center of the shaft 92 being an axial direction DRa, and a direction orthogonal to the axial direction DRa and radially extending from the axial direction DRa being a radial direction DRr.

The housing 9 is an accommodation portion that houses the valve 90. The housing 9 is formed of, for example, a resin member. The housing 9 includes a housing body portion 21 having a hollow shape in which the valve 90 is accommodated, a pipe member 50 for allowing cooling water to flow out from the housing body portion 21, and a partition wall portion 60 attached to the housing body portion 21. The housing body portion 21 has a substantially cuboid outer appearance and is formed in a bottomed shape having an opening on the other side in the axial direction DRa. The housing body portion 21 has a housing outer wall portion 22 constituting an outer peripheral part of the housing body portion 21. The housing outer wall portion 22 forms a valve accommodation space 23 having a columnar shape having an axial center in the axial direction DRa inside the housing main portion 21.

An inlet port 251 for allowing supplied water to flow into the valve accommodation space 23 is formed on the housing outer wall portion 22. The inlet port 251 is formed to open in a circular shape and is connected to a coupling pipe 135. The inlet port 251 corresponds to the fluid inflow portion.

The housing outer wall portion 22 is attached with pipe member 50. The housing outer wall portion 22 includes a first outlet port 261, a second outlet port 262, and a third outlet port 263 for allowing the cooling water flowing into the valve accommodation space 23 via the inlet port 251 to flow out to the pipe member 50. The first outlet port 261, the second outlet port 262, and the third outlet port 263 correspond to the fluid outflow portion.

The partition wall portion 60 is attached to a housing opening surface 24 of the housing outer wall portion 22. The housing opening surface 24 is arranged on the other side in the axial direction DRa in the housing body portion 21. A housing opening 241 that allows the valve accommodation space 23 and the outside of the housing body portion 21 to communicate with each other is formed in the housing opening surface 24. The housing opening 241 is closed by attaching the housing opening surface 24 with the partition wall portion 60.

The pipe member 50 includes a first pipe portion 51, a second pipe portion 52, and a third pipe portion 53 each formed in a cylindrical shape. The first pipe portion 51, the second pipe portion 52, and the third pipe portion 53 are coupled by a pipe coupling portion 54. The pipe coupling portion 54 is a part that couples the first pipe portion 51, the second pipe portion 52, and the third pipe portion 53 and attaches the pipe member 50 to the housing outer wall portion 22. The first pipe portion 51 has the upstream side arranged inside the first outlet port 261. The second pipe portion 52 has the upstream side arranged inside the second outlet port 262. The third pipe portion 53 has the upstream side arranged inside the third outlet port 263.

The partition wall portion 60 closes the housing opening 241 and holds the valve 90 accommodated in the valve accommodation space 23. The partition wall portion 60 has a disk shape in which the axial direction DRa is a plate thickness direction, and is arranged so as to be fitted from the other side toward one side in the axial direction DRa to the housing opening 241. When the partition wall portion 60 is fitted into the housing opening 241, the outer peripheral portion of the partition wall portion 60 abuts on a housing inner peripheral surface, thereby closing the housing opening 241.

The drive unit cover 80 accommodates the drive unit 70. The drive unit cover 80 has a hollow shape made of resin, and a drive unit space for accommodating the drive unit 70 is formed inside. The drive unit cover 80 includes a connector portion 81 for connecting to the microcomputer 330. The connector portion 81 is for connecting the valve device to the microcomputer 330, and incorporates terminals to which the drive unit 70 and a rotation angle sensor 73 are connected.

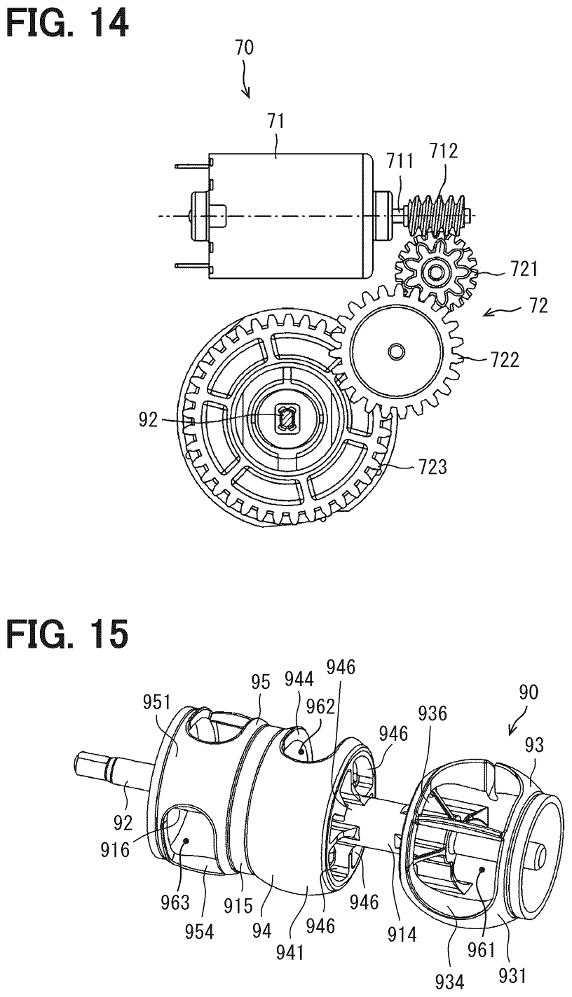

The drive unit 70 includes a motor 71 that outputs a rotational force for rotating the valve 90, a gear portion 72 that transmits the output of the motor 71 to the valve 90, and the rotation angle sensor 73 that detects a rotation angle of the gear portion 72. As illustrated in FIG. 14, the motor 71 includes a motor body, a motor shaft 711, a worm gear 712, and a motor side terminal. The motor 71 is configured such that the motor body can output power when the motor side terminal is supplied with power. The motor body is formed in a substantially cylindrical shape, and the motor shaft 711 protrudes from an end portion on the other side of the motor body. Power output from the motor body is output to the gear portion 72 via the motor shaft 711 and the worm gear 712.

The gear portion 72 is constituted by a speed reduction mechanism having resin gears, and is configured to be able to transmit, to the shaft 92, power output from the worm gear 712. The gear portion 72 includes a first gear 721, a second gear 722 meshing with the first gear 721, and a third gear 723 meshing with the second gear 722. The shaft 92 is connected to the third gear 723. The gear portion 72 has the outer diameter of the second gear 722 being formed larger than the outer diameter of the first gear 721, and the outer diameter of the third gear 723 being formed larger than the outer diameter of the second gear 722.

The first gear 721, the second gear 722, and the third gear 723 are arranged such that their axial centers are orthogonal to the axial center of the worm gear 712. The third gear 723 is arranged such that the axial center of the third gear 723 is on the same axial center as the axial center of the shaft 92. The shaft 92 is connected to the third gear 723. The drive unit 70 is configured such that the worm gear 712, the first gear 721, the second gear 722, and the third gear 723, and the valve 90 rotate integrally, and their rotations have a correlation with one another. These gears and the shaft 92 are configured such that the respective rotation angles have a correlation, and the rotation angle of any one component having the correlation can be calculated from the rotation angles of the other components.

In an inner peripheral portion of the drive unit cover 80, a site opposing the third gear 723 is attached with the rotation angle sensor 73 that detects the rotation angle of the third gear 723. The rotation angle sensor 73 is a Hall sensor incorporating a Hall element, and is configured to be able to detect the rotation angle of the third gear 723 in a non-contact manner. The rotation angle sensor 73 is connected to the microcomputer 330 via the connector portion 81. The rotation angle of the third gear 723 having been detected is transmitted to the microcomputer 330. The processor 334 of the microcomputer 330 is configured to be able to calculate the rotation angle of the valve 90 based on the rotation angle of the third gear 723 transmitted from the rotation angle sensor 73.

The shaft 92 and the valve 90 will be described with reference to FIGS. 13 and 15. The shaft 92 is configured to be rotatable about the axial center by a rotational force output from the drive unit 70. The shaft 92 is connected to the valve 90, and is configured to be able to rotate the valve 90 integrally with the shaft 92 when the shaft 92 rotates. The shaft 92 is formed to extend in a cylindrical shape along the axial center, and penetrates from one side to the other side of the valve 90. One side in the axial direction DRa of the shaft 92 is connected to a shaft support portion of the housing body portion 21, and the other side is connected to the gear portion 72. The valve 90 is fixed to a shaft outer peripheral portion.

The valve 90 is configured to be able to adjust the flow rate of the fluid to be output by rotating about the axial center. The valve 90 has the shaft 92 inserted internally, and is rotatably accommodated integrally with the shaft 92 in the valve accommodation space 23. The valve 90 has a tubular shape having an axial center extending along the axial direction DRa. The valve 90 is formed by connecting a first valve 93, a second valve 94, and a third valve 95, each of which has a tubular shape, a tubular connection portion 914, and a tubular valve connection portion 915. In the valve 90, the first valve 93, the tubular connection portion 914, the second valve 94, the tubular valve connection portion 915, and the third valve 95 are arranged in this order from one side to the other side in the axial direction DRa. The first valve 93 and the second valve 94 are connected via the tubular connection portion 914. The second valve 94 and the third valve 95 are connected via the tubular valve connection portion 915.

In the valve accommodation space 23 of the valve 90, the second valve 94 and the tubular connection portion 914 oppose the inlet port 251 in the radial direction DRr. The valve 90 includes a shaft connection portion 916 having a cylindrical shape into which the shaft 92 is inserted at the center. The valve 90 is connected to the shaft 92 by inserting the shaft 92 into the shaft connection portion 916. In the valve 90, for example, the first valve 93, the second valve 94, the third valve 95, the tubular connection portion 914, the tubular valve connection portion 915, and the shaft connection portion 916 are integrally molded by injection molding.

The valve 90 is a valve body for causing the cooling water flowing into the valve 90 to flow out to the first outlet port 261, the second outlet port 262, and the third outlet port 263. When the valve 90 rotates, the first valve 93 opens and closes the first outlet port 261, the second valve 94 opens and closes the second outlet port 262, and the third valve 95 opens and closes the third outlet port 263.

The axial centers of each of the first valve 93, the second valve 94, and the third valve 95 are arranged on the same axial center as the axial center of the shaft 92. In each of the first valve 93, the second valve 94, and the third valve 95, the center part in the axial direction DRa bulges outward in the radial direction DRr compared to both end sides. Each of the first valve 93, the second valve 94, and the third valve 95 is configured to allow a fluid to flow inside.

As illustrated in FIG. 15, the first valve 93 has a first valve outer peripheral portion 931 forming an outer peripheral portion, and a first flow path portion 961 is formed inside the first valve outer peripheral portion 931. In the first valve 93, a first inner opening 936 through which a fluid flows into the first flow path portion 961 is formed. In the first valve 93, the fluid flowing into the valve accommodation space 23 flows into the first flow path portion 961 through the first inner opening 936. The first flow path portion 961 corresponds to the flow path portion in the valve device.

As illustrated in FIG. 15, in the first valve outer peripheral portion 931, a first outer peripheral opening 934 that causes the first flow path portion 961 to communicate with the first outlet port 261 via a first seal opening 581 when the shaft 92 rotates is formed. The first valve 93 causes the fluid flowing into the first flow path portion 961 to flow out from the first outlet port 261 by the first outer peripheral opening 934 communicating with the first outlet port 261. The first outer peripheral opening 934 formed in the first valve outer peripheral portion 931 corresponds to the outer peripheral opening formed in the valve outer peripheral portion. The first outer peripheral opening 934 is formed to extend along the circumferential direction of the axial center of the shaft 92 in the first valve outer peripheral portion 931. The flow rate of the fluid flowing out of the device from the first valve 93 is adjusted in accordance with the area where the first outer peripheral opening 934 and the first seal opening 581 overlap when the shaft 92 rotates. The first inner opening 936 functions as a communication path for causing the outside of the first valve 93 and the first flow path portion 961 to communicate with each other.

As illustrated in FIG. 15, the second valve 94 has a second valve outer peripheral portion 941 forming an outer peripheral portion, and a second flow path portion 962 is formed inside the second valve outer peripheral portion 941. In the second valve 94, a second inner opening 946 through which a fluid flows into the second flow path portion 962 is formed on one side in the axial direction DRa. The second valve 94 is configured such that the fluid flowing into the valve accommodation space 23 via the inlet port 251 can flow through the second flow path portion 962 via the second inner opening 946. The second flow path portion 962 corresponds to the flow path portion in the valve device.

As illustrated in FIG. 15, in the second valve outer peripheral portion 941, a second outer peripheral opening 944 that causes the second flow path portion 962 to communicate with the second outlet port 262 via a second seal opening 582 when the shaft 92 rotates is formed. The second valve 94 causes the fluid flowing into the second flow path portion 962 to flow out from the second outlet port 262 by the second outer peripheral opening 944 communicating with the second outlet port 262. The second outer peripheral opening 944 formed in the second valve outer peripheral portion 941 corresponds to the outer peripheral opening formed in the valve outer peripheral portion.

The second outer peripheral opening 944 is formed to extend in the circumferential direction of the axial center of the shaft 92. The flow rate of the fluid flowing out of the device from the second valve 94 is adjusted in accordance with the area where the second outer peripheral opening 944 and the second seal opening 582 overlap when the shaft 92 rotates. The second inner opening 946 functions as a communication path for causing the outside of the second valve 94 and the second flow path portion 962 to communicate with each other. The second inner opening 946 opposes the first inner opening 936. The tubular connection portion 914 is for connecting the first valve 93 and the second valve 94. The tubular connection portion 914 forms a first inter-valve space 97 between the outer peripheral portion of the tubular connection portion 914 and the housing inner peripheral surface. The first flow path portion 961 and the second flow path portion 962 communicate with each other via the first inter-valve space 97.

In the second valve 94, the shaft connection portion 916 that covers the outer peripheral portion of the shaft 92 is arranged substantially at the center of the inside. In the second valve 94, the tubular valve connection portion 915 is connected to the other side in the axial direction DRa of the second valve outer peripheral portion 941. The second valve 94 is configured to allow the fluid flowing into the second flow path portion 962 to flow into the third valve 95 via the tubular valve connection portion 915.

A second inter-valve space 98 is formed inside the tubular valve connection portion 915. The second inter-valve space 98 communicates with the second flow path portion 962 and a third flow path portion 963. The tubular valve connection portion 915 has the outer diameter on one side in the axial direction DRa being the same in size as the outer diameter of a site on the other side in the axial direction DRa of the second valve 94. The tubular valve connection portion 915 has the outer diameter on the other side in the axial direction DRa being the same in size as the outer diameter of a site on one side in the axial direction DRa of the third valve 95. The tubular valve connection portion 915 is formed continuously with the second valve outer peripheral portion 941 and a third valve outer peripheral portion 951.

As illustrated in FIG. 15, the third valve 95 has a third valve outer peripheral portion 951 forming an outer peripheral portion of the third valve 95, and a third flow path portion 963 is formed inside the third valve outer peripheral portion 951. The third valve 95 has one side in the axial direction DRa of the third valve outer peripheral portion 951 being connected to the tubular valve connection portion 915. In the third valve 95, the fluid flowing into the second flow path portion 962 flows into the third flow path portion 963 via the second inter-valve space 98. The third flow path portion 963 corresponds to the flow path portion in the valve device.

As illustrated in FIG. 15, in the third valve outer peripheral portion 951, a third outer peripheral opening 954 that causes the third flow path portion 963 to communicate with the third outlet port 263 via a third seal opening 583 when the shaft 92 rotates is formed. The third valve 95 causes the fluid flowing into the third flow path portion 963 to flow out from the device from the third outlet port 263 by the third outer peripheral opening 954 communicating with the third outlet port 263. The third outer peripheral opening 954 formed in the third valve outer peripheral portion 951 corresponds to the outer peripheral opening formed in the valve outer peripheral portion.

The third outer peripheral opening 954 is formed to extend along the circumferential direction of the axial center in the third valve outer peripheral portion 951. The flow rate of the fluid flowing out of the device from the third valve 95 is adjusted in accordance with the area where the third outer peripheral opening 954 and the third seal opening 583 overlap when the shaft 92 rotates. The shaft connection portion 916 has a tubular shape, and connects the valve 90 and the shaft 92 by fixing the inserted shaft 92. When the shaft 92 rotates, the shaft connection portion 916 transmits the rotational force of the shaft 92 to the valve 90 via the shaft connection portion 916. The shaft connection portion 916 is formed to extend toward the other side in the axial direction DRa from the second valve 94 to the third valve 95.

The operation of the water source valve 15 will be described. The microcomputer 330 calculates the rotation angle of the valve 90 for supplying water of a necessary flow rate to the distribution tube 136, that is, the rotation angle of the motor 71. The microcomputer 330 transmits information on the calculated rotation angle of the motor 71 to the water source valve 15. At this time, the closing member is attached to the two fluid outflow portions not connected to the distribution tube 136. The calculation of the rotation angle of the motor 71 may be configured to be executed by the information processing calculation equipment 610 of the integrated calculation unit 600.

The water source valve 15 rotates the motor 71 based on the information on the rotation angle received from the microcomputer 330. By rotating the motor 71, the water source valve 15 rotates the valve 90 via the gear portion 72 and the shaft 92, and causes a required flow rate of fluid to flow out from the first outer peripheral opening 934, the second outer peripheral opening 944, and the third outer peripheral opening 954.

For example, a case where the first outlet port 261 is adopted as a fluid outflow portion communicating with the distribution tube 136 will be described. By rotating the valve 90, the water source valve 15 causes the first outer peripheral opening 934 of the first valve 93 to communicate with the first outlet port 261. The water source valve 15 adjusts the rotational position of valve 90, thereby adjusting the area where the first outer peripheral opening 934 and the first seal opening 581 overlap. The water source valve 15 causes the fluid flowing into the valve accommodation space 23 from the inlet port 251 to flow into the first flow path portion 961 via the first inner opening 936 and to flow out from the first outer peripheral opening 934 to the first outlet port 261. By controlling the valve opening degree that is an overlapping area of the first outer peripheral opening 934 and the first seal opening 581, the microcomputer 330 controls a water flying distance of irrigation and supplies irrigation water to a necessary position.

For example, a case where the second outlet port 262 is adopted as a fluid outflow portion communicating with the distribution tube 136 will be described. By rotating the valve 90, the water source valve 15 causes the second outer peripheral opening 944 of the second valve 94 to communicate with the second outlet port 262. The water source valve 15 adjusts the rotational position of valve 90, thereby adjusting the area where the second outer peripheral opening 944 and the second seal opening 582 overlap. The water source valve 15 causes the fluid flowing into the valve accommodation space 23 from the inlet port 251 to flow into the second flow path portion 962 via the second inner opening 946 and to flow out from the second outer peripheral opening 944 to the second outlet port 262. By controlling the valve opening degree that is an overlapping area of the second outer peripheral opening 944 and the second seal opening 582, the microcomputer 330 controls a water flying distance of irrigation and supplies irrigation water to a necessary position.

For example, a case where the third outlet port 263 is adopted as a fluid outflow portion communicating with the distribution tube 136 will be described. By rotating the valve 90, the water source valve 15 causes the third outer peripheral opening 954 of the third valve 95 to communicate with the third outlet port 263. The water source valve 15 adjusts the rotational position of valve 90, thereby adjusting the area where the third outer peripheral opening 954 and the third seal opening 583 overlap. The water source valve 15 causes the fluid flowing into the valve accommodation space 23 from the inlet port 251 to flow into the third flow path portion 963 via the second flow path portion 962 of the second valve 94 and to flow out from the third outer peripheral opening 954 to the third outlet port 263. By controlling the valve opening degree that is an overlapping area of the third outer peripheral opening 954 and the third seal opening 583, the microcomputer 330 controls a water flying distance of irrigation and supplies irrigation water to a necessary position. The control of these valve opening degrees may be configured to be executed by the information processing calculation equipment 610 of the integrated calculation unit 600.

The water source valve 15 adjusts the rotation angle of the motor 71 by the rotation angle sensor 73 detecting the rotation angle of third gear 723 and giving feedback of information of the detected rotation angle to the microcomputer 330.

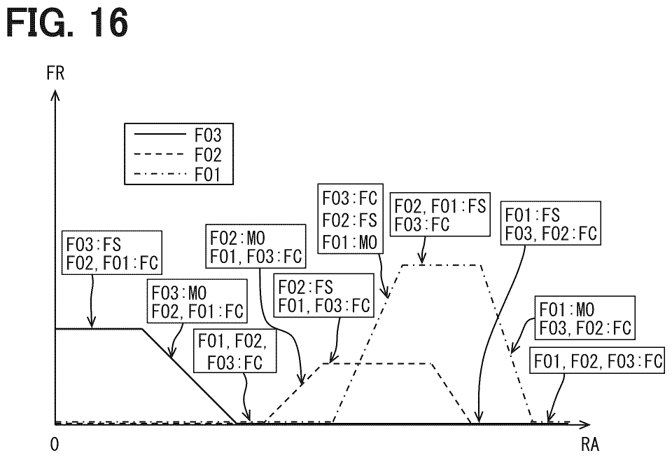

The relationship between the rotation angle of the shaft 92 and the flow rate of the valve device will be described with reference to the graph of FIG. 16. In FIG. 16, a rotation angle RA of the motor 71 is the horizontal axis, and a flow rate FR of the fluid flowing out from the valve device is the vertical axis. In FIG. 16, FO1 is the first valve 93, FO2 is the second valve 94, and FO3 is the third valve 95. In FIG. 16, FS indicates that the valve opening degree is in a fully open state, FC indicates that the valve opening degree is in a fully closed state, and MO indicates that the valve opening degree is an intermediate opening degree. The intermediate opening degree is an opening degree between the fully closed state and the fully open state. The graph of the solid line in FIG. 16 indicates the relationship between the flow rate of the fluid flowing out from the third valve 95 and the rotation angle. The graph of the broken line in FIG. 16 indicates the relationship between the flow rate of the fluid flowing out from the second valve 94 and the rotation angle. The graph of the one-dot chain line in FIG. 16 indicates the relationship between the flow rate of the fluid flowing out from the first valve 93 and the rotation angle.

As shown in FIG. 16, near the rotation angle of 0 degrees, the third valve 95 is in the fully open state, the other valves are in the fully closed state, and the fluid flows out of the device only through the third valve 95. When the rotation angle is increased from this state, the third valve 95 shifts to the intermediate opening degree, and when the rotation angle is further increased, all the three valves are brought into the fully closed state.

As the rotation angles of all the three valves increase from the fully closed state, only the second valve 94 shifts to the fully open state via the intermediate opening degree. When the rotation angle is further increased, the first valve 93 shifts to the fully open state via the intermediate opening degree, and the first valve 93 and the second valve 94 are brought into the fully open state. When the rotation angle is increased from this state, the second valve 94 shifts to the fully closed state via the intermediate opening degree, and the second valve 94 and the third valve 95 are brought into the fully closed state. When the rotation angle is further increased, the first valve 93 shifts to the fully closed state via the intermediate opening degree, and all the valves are brought into the fully closed state.

As described above, the opening degree of each valve transitions in accordance with the rotation angle, and the fluid flow rate flowing out from each valve changes. Each water source valve 15 in the watering system 10 is configured to supply the fluid from only one of the three valves, thereby controlling the water flying distance and the water supply amount to the field 20 in accordance with the rotation angle.

Next, the operation of the watering system 10 for performing irrigation with suppressed adverse effects on the growth of the plant will be described with reference to FIGS. 17 to 20. FIG. 17 illustrates an example of a water supply path provided with a water source valve, a water pressure sensor, and a water temperature sensor, a ground temperature sensor, and a soil sensor. The watering system 10 illustrated in FIG. 17 includes the water source valve 15, the water pressure sensor 14, the water temperature sensor 160, and the like provided in a passage on one end portion side of the distribution tubes 136 arranged side by side. Each distribution tube 136 is provided at a position where irrigation water can be discharged to the corresponding ridge via through holes. The passage on one end portion side is a passage causing the vertical pipe 131 through which the water supply from the water supply source flows down and one end portion of the distribution tube 136 to communicate with each other. The first water source valve controls the pressure of water supply from one end portion side flowing down from one end portion toward the other end portion of the distribution tube 136. The first water source valve includes the water source valve 150a and the water source valves 151a.

The vertical pipe 131 is coupled to a passage leading to the inlet port 251 of each water source valve. Each distribution tube 136 is coupled to a passage to the first pipe portion 51, which is one of the fluid outflow portions in each water source valve. In this case, the second pipe portion 52 and the third pipe portion 53, which are the other fluid outflow portions, are closed by the closing member. The signal output unit 332 outputs, to the water source valve, a control signal for controlling the valve opening degree by feedback control using the water supply information detected at a downstream end. The signal output unit 332 outputs, to the water source valve, a control signal for controlling the valve opening degree by feedback control using the water supply information detected in an upstream passage.

The vertical pipe 131 communicates with passages leading to one end portion of the distribution tubes 136. The vertical pipe 131 is provided with the water source valve 150a that opens and closes a passage more upstream than a connection portion with the first coupling pipe 134. The passages include the branch pipes 134a each branching into one end portion of two distribution tubes 136 adjacent to each other. The branch pipes 134a constitute passages branching from the first coupling pipe 134. The first coupling pipe 134 is connected to the vertical pipe 131 at an upstream site and is connected to the branch pipe 134a at a downstream site.

The branch pipes 134a are passages coupling the distribution tubes 136 and the first coupling pipe 134. Each of the branch pipes 134a couples the one end portion of the two distribution tubes 136 adjacent to each other and the first coupling pipe 134. The downstream site of the branch pipe 134a is provided with the water source valve 151a. One branch pipe 134a is provided so as to flow down water supply to the predetermined number of the distribution tubes 136 forming one group. The number of the distribution tubes 136 coupled to one branch pipe 134a may be one or three or more. That is, the predetermined number may be one or three or more. The first coupling pipe 134 is provided with one or plural drainage valves 152 that open and close a passage more downstream than a connection portion with the branch pipe 134a. When the drainage valve 152 is in the open state, water in the first coupling pipe 134 or the like can be emitted to the outside through the drainage valve 152.

The water source valve 151a includes one fluid inflow portion and two fluid outflow portions, and can control the opening degree of each of the passages branching into two. The water source valve 151a opens and closes a passage at a downstream site of the first coupling pipe 134 and controls the flow rate flowing down to the predetermined number of distribution tubes 136 forming one group. By controlling the valve opening degrees of the water source valve 150a and each water source valve 151a, the watering system 10 can simultaneously perform irrigation of a plurality of groups.

The vertical pipe 131 is provided with the water pressure sensor 140a that detects the water supply pressure in the passage more upstream than the connection portion with the first coupling pipe 134. The vertical pipe 131 is provided with the water temperature sensor 160 that detects the water supply temperature in the passage more upstream than the connection portion with the first coupling pipe 134. The water pressure sensor 141a detects the water supply pressure at a site of the first coupling pipe 134 positioned more upstream than the branch pipe 134a. The water pressure sensor 142a detects the water supply pressure at a site more upstream than the through hole in each distribution tube 136. The control device 200 can obtain the flow rate in respective units using the water supply pressure detected by the water pressure sensor 140a, the water pressure sensor 141a, and the water pressure sensor 142a.

The soil sensor 311a and the ground temperature sensor 312a are installed on the ridges corresponding to the predetermined number of distribution tubes 136 forming one group. In the watering system 10 illustrated in FIG. 17, the soil sensor 311a and the ground temperature sensor 312a are installed on the soil to be irrigated by the distribution tubes 136 forming one group. The soil sensor 311a and the ground temperature sensor 312a may be configured to be installed for each distribution tube 136. In the case of this configuration, it is possible to detect the soil water content and the soil temperature with higher accuracy.

As illustrated in FIG. 12, the water supply pressures detected by the water pressure sensor 140a, the water pressure sensor 141a, and the water pressure sensor 142a are output to the microcomputer 330 of the monitoring unit 300. The temperature of the soil detected by the ground temperature sensor 312a is output to the microcomputer 330. The water temperature detected by the water temperature sensor 160 is output to the microcomputer 330. The processor 334 compares the temperature of the soil detected by the ground temperature sensor 312a with the water temperature of the water supply path detected by the water temperature sensor 160, and determines whether to perform irrigation. The processor 334 determines whether to perform irrigation in accordance with the level of the water temperature of the water supply path detected by the water temperature sensor 160. The signal output unit 332 outputs a control signal for controlling the valve opening degree to each of the water source valves 150a and 151a and the drainage valve 152 in response to the determination result as to whether to perform irrigation. The control of the valve opening degree described here may be configured to be executed by the information processing calculation equipment 610 of the integrated calculation unit 600.

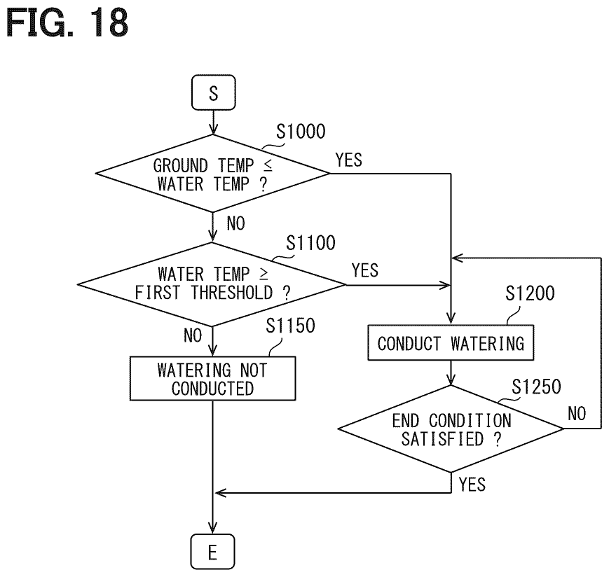

In the irrigation processing according to FIGS. 18 to 20 and the irrigation processing described in the sixth embodiment and thereafter, the temperature of the soil and the water temperature of the water supply path can be replaced as follows. The temperature of the soil may be configured to be replaced with the ground temperature detected by the ground temperature sensor 312a. This ground temperature includes not only the temperature of the soil but also the temperature of, for example, a natural lawn ground and the temperature of an artificial ground such as artificial lawn, which are not soil. The soil includes soil properties such as orchards. The water temperature of the water supply path detected by the water temperature sensor 160 may be configured to be replaced with the temperature of the water supply path detected by the temperature sensor. The temperature of the water supply path includes not only the water temperature but also the temperature of a pipe or the like forming the water supply path. Therefore, the processor 334 compares the ground temperature detected by the ground temperature sensor 312a with the temperature of the water supply path, and determines whether to perform irrigation. The processor 334 determines whether to perform irrigation in accordance with the level of the water temperature of the water supply path.

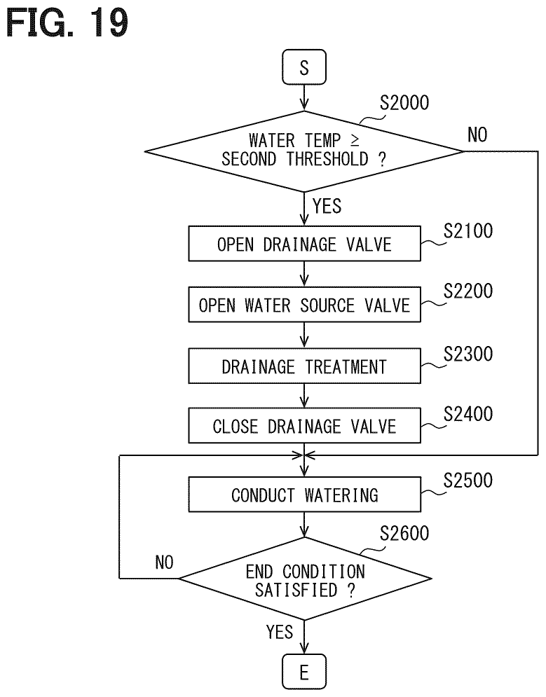

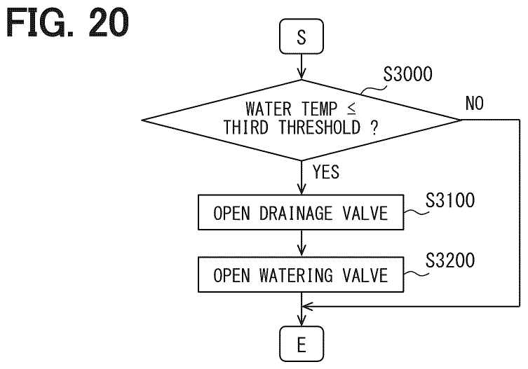

The watering system 10 executes the processing according to the flowcharts illustrated in FIGS. 18 to 20 when performing the irrigation processing. Each of FIGS. 18 to 20 is a flowchart showing the example of an operation at the time of an irrigation command. The processing shown in FIG. 18, the processing shown in FIG. 19, and the processing shown in FIG. 20 described below are executed concurrently at the execution timing of the irrigation processing. Alternatively, the watering system 10 may be configured such that the control device 200 executes at least one of these processing. The control device 200 executes the processing shown in FIG. 18, the processing shown in FIG. 19, and the processing shown in FIG. 20 by, for example, the monitoring unit 300 or the integrated calculation unit 600. Hereinafter, an example in which the monitoring unit 300 executes each processing will be described as a representative.

The integrated calculation unit 600 outputs an irrigation performing command to the monitoring unit 300 corresponding to the divided area where irrigation is to be performed. In this state, the drainage valve 152 and the water source valve 150a are controlled to be in the closed state. Upon receiving the signal related to the irrigation processing output from the integrated calculation unit 600, the microcomputer 330 of the monitoring unit 300 executes the processing shown in FIG. 18. The processing shown in FIG. 18 is executed at the timing when the irrigation time comes or at the timing when the irrigation performing command is output, and is repeated several times a day, for example. The processing shown in FIG. 18 is executed in a period such as early spring or late autumn, for example. The acquisition unit 331 acquires the temperature of the soil detected by the ground temperature sensor 312a and the temperature of the water in the water supply path detected by the water temperature sensor 160. In step S1000, the processor 334 determines whether the detection value of the temperature of the soil is equal to or less than the detection value of the water temperature. In this description, the temperature of the soil detected by the ground temperature sensor 312a may be called “ground temperature”.

When the detection value of the temperature of the soil is equal to or less than the detection value of the water temperature, the microcomputer 330 executes the processing of performing irrigation in step S1200. The microcomputer 330 outputs a control signal for bringing, into the open state, the water source valve 151a corresponding to the divided area where irrigation is performed among the water source valves 151a. The microcomputer 330 outputs a control signal for bringing, into the closed state, the water source valve 151a corresponding to the divided area where the irrigation is not performed. The irrigation from the distribution tube 136 positioned downstream of the water source valve 151a controlled to the open state is started by controlling the valve opening degree so as to satisfy a target irrigation amount and a target water flying distance. In this state, the pump 110 is driven, and the water supply from the water supply source flows down the water supply pipe 130. In step S1200, the water supply simultaneously flows down from one end portion to the other end portion of the distribution tube 136, and irrigation of discharging water from each through hole toward the ridge.

This irrigation is continued until the processor 334 determines in step S1250 that the end condition of irrigation is established. The end condition of irrigation is established, for example, when the irrigation flow rate from the irrigation start reaches the target irrigation amount. The end condition of irrigation is established, for example, when the irrigation time from the irrigation start reaches the target irrigation time. When it is determined in step S1250 that the end condition of irrigation is established, the microcomputer 330 controls the first water source valve into the fully closed state and ends the irrigation by water supply from the one end portion to the other end portion. Due to this, the flowchart shown in FIG. 18 is ended.

When the detection value of the temperature of the soil exceeds the detection value of the water temperature, the processor 334 determines in step S1100 whether the detection value of the water temperature is equal to or greater than a first threshold value. When the detection value of the water temperature is equal to or greater than the first threshold value, step S1200 described above is executed to perform irrigation until the above-described end condition is established. In this case, the water temperature is not low enough to inhibit the growth of the plant, and irrigation is performed. The first threshold value is an irrigation suppression threshold value for determining whether to prohibit irrigation. In step S1200, the irrigation amount may be controlled to be greater than the irrigation amount in step S1150.

When the detection value of the water temperature falls below the first threshold value, the microcomputer 330 executes the processing of not performing irrigation in step S1150 and ends the flowchart. The microcomputer 330 outputs a control signal for controlling all the water source valves 151a into the closed state. Alternatively, the microcomputer 330 outputs a control signal for bringing the water source valve 150a into the closed state. Due to this, the water supply path positioned more upstream than the water source valve 151a is interrupted from the distribution tube 136, and it is possible to prevent low-temperature water in the pipe from being discharged to the plant. In step S1150, in place of not performing irrigation, the irrigation amount may be controlled to be narrower than the irrigation amount in step S1200. This contributes to suppressing the amount of water discharged from the low-temperature water in the pipe to the plant.

When the detection value of the temperature of the soil exceeds the detection value of the water temperature, the temperature of the water existing in the water supply path is in a state of being lower than the ground temperature. When low-temperature water is discharged to the plant in this manner, poor root taking is caused, and the yield of plant shipment is reduced.

The first threshold value is stored in the storage unit 333. For example, the first threshold value is set to a low temperature lower than the ground temperature and having a high possibility of inhibiting the growth of the plant based on the past actual value. For example, the first threshold value is a value set based on a past actual value of the ground temperature and water temperature data with which growth inhibition can be predicted based on the type of plant. This first threshold value is set to a temperature below the ground temperature and a growth inhibition temperature at which growth inhibition can be predicted based on the type of plant. The growth inhibition temperature is, for example, a temperature lower than the ground temperature and causing poor root taking of the plant.

The watering system 10 can automatically and forcibly stop irrigation when the water temperature in the pipe of the water supply path falls below such the first threshold value at the performing timing of irrigation. When the water temperature in the pipe of the water supply path shifts to either state of exceeding the first threshold value or exceeding the ground temperature, the watering system 10 can automatically release the irrigation stop and perform the irrigation. The watering system 10 can automatically return from the irrigation stop to the irrigation performing when the water temperature in the pipe is changed to a state of exceeding the first threshold value or exceeding the ground temperature at the performing timing of irrigation of the next time or thereafter. By executing the processing shown in FIG. 18 over again at each irrigation performing timing in one day, the watering system 10 can postpone inappropriate irrigation performing until the air temperature or the water temperature increases. The watering system 10 contributes to suppressing the inappropriate irrigation performing for the growth of the plant when the water temperature is low such as morning and evening in early spring by control of postponing the irrigation performing until the air temperature rises.

The first threshold value needs not be a value stored in the storage unit 333, and may be configured to be input to the integrated calculation unit 600 by the user operating the input equipment 800. In this case, it is possible to set, at any time, the first threshold value based on user's experience or the like and to provide the watering system 10 that can control stopping and performing of irrigation depending on conditions suitable for the climate and environment of the land.

Next, the processing shown in FIG. 19 will be described. Upon receiving the signal related to the irrigation processing output from the integrated calculation unit 600, the microcomputer 330 executes the processing shown in FIG. 19. The processing shown in FIG. 19 is executed at the timing when the irrigation time comes or at the timing when the irrigation performing command is output, and is repeated several times a day, for example. The acquisition unit 331 acquires the temperature of the water in the water supply path detected by the water temperature sensor 160. In step S2000, the processor 334 determines whether the detection value of the water temperature of the water supply path is equal to or greater than a second threshold value. The second threshold value is set to be a value higher than the first threshold value and is stored in the storage unit 333. The processing shown in FIG. 19 is executed in a period such as summer, for example. The second threshold value is a water temperature that may cause root damage of the plant, and is a drainage threshold value for determining whether to perform drainage.

When the detection value of the water temperature falls below the second threshold value, the microcomputer 330 proceeds to step S2500 and executes the processing of performing irrigation. When the detection value of the water temperature is equal to or greater than the second threshold value, in step S2100, the microcomputer 330 outputs a control signal for bringing the drainage valve 152 installed in the first coupling pipe 134 into the open state. Furthermore, in step S2200, the microcomputer 330 outputs a control signal for bringing the water source valve 150a (also called a water source valve) installed more upstream than the first coupling pipe 134 into the open state. By the processing of these steps, in step S2300, the retained water in the pipe of the water supply path is emitted to the outside from the drainage valve 152 that is opened, and is not discharged to the plant. Since the pressure is released to the drainage valve 152 that is opened, the water retained in the distribution tube 136 can also be emitted to the outside through the drainage valve 152.

The retained water in the pipe of the water supply path is emitted when a predetermined time elapses, and in step S2400 the microcomputer 330 outputs a control signal for bringing the drainage valve 152 into the closed state. By this, the drainage treatment is ended. Next, step S2500 is executed to perform irrigation, and when the determination processing of step S2600 is established, the irrigation is completed and the present flowchart is ended. Steps S2500 and S2600 are processing similar to those in steps S1200 and S1250 in FIG. 18, respectively.

When the temperature of the water retained in the pipe is equal to or greater than the second threshold value, the air temperature and the ground temperature are high, and when this water is discharged to the plant, root damage is caused and the yield of plant shipment is reduced. For example, the second threshold value is set to a temperature higher than the first threshold value and having a high possibility of inhibiting the growth of the plant based on the past actual value. For example, the second threshold value is a value set based on a past actual value of the ground temperature and water temperature data with which growth inhibition such as root damage can be predicted based on the type of plant. For example, the second threshold value is set to a growth inhibition temperature that is equal to or greater than a predetermined temperature falling below the ground temperature or equal to or greater than the ground temperature, the growth inhibition temperature at which growth inhibition can be predicted based on the type of plant. This growth inhibition temperature is, for example, a temperature lower than the ground temperature, the growth inhibition temperature at which root damage of the plant is caused.

The watering system 10 can automatically and forcibly drain water when the water temperature in the pipe of the water supply path is equal to or greater than such the second threshold value at the performing timing of irrigation. When the water temperature in the pipe of the water supply path exceeds the second threshold value, the watering system 10 can perform irrigation after automatically draining the retained water.

When the retained water in the pipe exceeds the second threshold value, after automatically draining the retained water, the watering system 10 may postpone irrigation performing until the time when the retained water in the pipe falls below the second threshold value. By executing the processing shown in FIG. 19 over again at each irrigation performing timing in one day, the watering system 10 can eliminate inappropriate irrigation performing until the air temperature and the water temperature decrease. The watering system 10 contributes to suppressing irrigation performing inappropriate for growth of the plant when the water temperature is high such as the summer season or daytime.

The second threshold value needs not be a value stored in the storage unit 333, and may be configured to be input to the integrated calculation unit 600 by the user operating the input equipment 800. In this case, it is possible to set, at any time, the second threshold value based on user's experience or the like and to provide the watering system that can control drainage and stopping and performing of irrigation depending on conditions suitable for the climate of the land and the like.

Next, the processing shown in FIG. 20 will be described. Upon receiving the signal related to the irrigation processing output from the integrated calculation unit 600, the microcomputer 330 executes the processing shown in FIG. 20. The processing shown in FIG. 20 is executed at the timing when the irrigation time comes or at the output timing of the irrigation performing command, and is repeated several times a day, for example. The processing shown in FIG. 20 may be configured to be executed at a predetermined timing in one day. The processing shown in FIG. 20 may be configured to be executed a predetermined time before the performing timing of irrigation.

First, the acquisition unit 331 acquires the temperature of the water in the water supply path detected by the water temperature sensor 160. In step S3000, the processor 334 determines whether the detection value of the water temperature of the water supply path is equal to or less than a third threshold value. The third threshold value is set to be a value lower than the first threshold value and is stored in the storage unit 333. The processing shown in FIG. 20 is executed, for example, in winter when water can be frozen. The third threshold value is a threshold value set to a temperature higher than the freezing temperature of water, and is a threshold value before freezing for determining whether to perform drainage before freezing.

When the detection value of the water temperature exceeds the third threshold value, the microcomputer 330 ends the present flowchart. When the detection value of the water temperature is equal to or less than the third threshold value, in step S3100, the microcomputer 330 outputs a control signal for bringing the drainage valve 152 installed in the first coupling pipe 134 into the open state. Furthermore, in step S3200, the microcomputer 330 outputs a control signal for bringing the watering valve such as the water source valve 151a installed more downstream than the first coupling pipe 134 into the open state. By these processing, the retained water accumulated in the water supply path is emitted to the outside from the drainage valve 152 that is opened, and is not discharged to the plant. When the predetermined time elapses, emission of the retained water in the pipe is completed. By this, the present flowchart is ended.

When the temperature of the water retained in the pipe is equal to or less than the third threshold value, the retained water may be frozen in the future. For example, the third threshold value is set to a temperature at which the retained water in the pipe is likely to be frozen by the performing timing of the next irrigation based on the past actual values of water temperature and air temperature. The third threshold value is set to a value at which the drainage treatment can be completed by draining water from the pipe before the retained water freezes on the assumption that the air temperature will decrease from now on. The third threshold value is a value set based on past actual values related to air temperature and water temperature. The third threshold value is set to, for example, a temperature higher by a predetermined temperature than 0° C. at which freezing of water starts.

The watering system 10 can automatically and forcibly drain water when the water temperature of the retained water in the pipe is equal to or less than such the third threshold value at the performing timing of irrigation. When the water temperature of the retained water in the pipe falls below the third threshold value at which the retained water is likely to be frozen in the future based on the change in the air temperature decrease from now on and the freezing temperature of the water, the watering system 10 automatically performs drainage regardless of a high/low relationship between the ground temperature and the water temperature. Due to this, since the frozen state is eliminated at the performing timing of the next irrigation, smooth irrigation can be performed, and pipe breakage due to freezing can be prevented in advance.

The watering system 10 provides a state in which irrigation can be smoothly performed at the time of performing the next irrigation by removing the water from the pipe before the retained water freezes in the future in the evening or at night in winter. When the water temperature falls below the threshold value before freezing at the timing of performing irrigation, the control device drains the retained water in the water supply path without releasing the water to the plant regardless of the high/low relationship between the ground temperature and the water temperature. The control device drains the retained water in the water supply path without releasing the retained water to the plant when the water temperature falls below the threshold value before freezing or the water temperature exceeds the drainage threshold value at the timing of performing irrigation.

The third threshold value needs not be a value stored in the storage unit 333, and may be configured to be input to the integrated calculation unit 600 by the user operating the input equipment 800. This system can set, at any time, the third threshold value based on user's experience and weather information, and enables smooth irrigation performing of the next time and protection of the pipe depending on conditions suitable for the climate of the land and the like.

The watering system 10 of the fifth embodiment includes a water supply path supplied with irrigation water to be released to the plant, a temperature sensor that detects the temperature of the water supply path, and the ground temperature sensor 312a that detects the ground temperature. The watering system 10 includes the control device 200 that controls the irrigation amount using the ground temperature detected by the ground temperature sensor and the temperature detected by the temperature sensor.

This system can perform control in which the irrigation amount is changed between a case where the temperature of the water supply path is higher than the ground temperature and a case where the temperature of the water supply path is lower than the ground temperature. This system can perform irrigation to suppress adverse effects if the water supply temperature is predicted to adversely affect growth of the plant.

The control device 200 performs control so as to reduce an irrigation amount when the ground temperature exceeds a temperature of the water supply path and the temperature of the water supply path falls below an irrigation suppression threshold value at the timing of performing irrigation. Furthermore, when the ground temperature is equal to or less than the temperature of the water supply path, or when the ground temperature exceeds the temperature of the water supply path and the temperature of the water supply path exceeds the irrigation suppression threshold value, the control device 200 performs control so as to increase an irrigation amount more than a case where the ground temperature exceeds the temperature of the water supply path and the temperature of the water supply path falls below the irrigation suppression threshold value.

This system can suppress the irrigation amount when the temperature of the water supply path is a low temperature having not risen to the ground temperature, and can suppress the irrigation until the time when the water temperature rises. On the other hand, when the ground temperature is equal to or less than the temperature of the water supply path, it is possible to supply an irrigation amount that promotes growth while suppressing adverse effects on the growth of the plant.

The watering system 10 includes the control device that determines whether to perform irrigation using the ground temperature detected by the ground temperature sensor 312a and the temperature of the water supply path. The control device 200 prohibits irrigation when the ground temperature exceeds the temperature of the water supply path and the temperature of the water supply path falls below the irrigation suppression threshold value at the timing of performing irrigation. The control device 200 performs irrigation when the ground temperature is equal to or less than the temperature of the water supply path or when the ground temperature exceeds the temperature of the water supply path and the temperature of the water supply path exceeds the irrigation suppression threshold value.

According to this system, it is possible to suppress irrigation when the temperature of the water supply path is a low temperature that does not rise to the ground temperature, and it is possible to postpone the irrigation until the time when the temperature of the water supply path rises. On the other hand, when the condition for performing irrigation is established as described above, it is possible to achieve appropriate moisture supply that promotes growth while suppressing adverse effects on the growth of the plant.

The control device 200 performs irrigation after draining retained water in the water supply path without releasing the retained water to the plant when a temperature of the water supply path exceeds a drainage threshold value, and performs irrigation containing the retained water when the temperature of the water supply path falls below the drainage threshold value at the timing of performing irrigation. The control device 200 can perform this control even when the timing to perform irrigation has not arrived.

According to this system, it is possible to perform appropriate-temperature irrigation after draining high-temperature retained water without releasing the retained water to the plant when the temperature of the water supply path exceeds the drainage threshold value. On the other hand, by performing irrigation containing appropriate-temperature retained water when the temperature of the water supply path falls below the drainage threshold value, it is possible to achieve appropriate moisture supply that promotes growth while suppressing adverse effects on the growth of the plant.

The control device includes the processor 334 that determines whether to perform irrigation using the temperature of the water supply path of the water supply existing in the water supply path supplied with the irrigation water and the ground temperature of the field, and the signal output unit 332. The signal output unit 332 outputs a signal of irrigation prohibition when the processor 334 determines, at the performing timing of irrigation, that the ground temperature exceeds the temperature of the water supply path and the temperature of the water supply path falls below the irrigation suppression threshold value. The signal output unit 332 outputs the signal of irrigation prohibition when the processor 334 determines that the ground temperature is equal to or less than the temperature of the water supply path. The signal output unit 332 outputs a signal to perform irrigation when the processor determines that the ground temperature is equal to or less than the temperature of the water supply path, or when the processor determines that the ground temperature exceeds the temperature of the water supply path and the temperature of the water supply path exceeds the irrigation suppression threshold value.

This control device can suppress the irrigation when the temperature of the water supply path is a low temperature having not risen to the ground temperature, and can postpone the irrigation until the time when the water temperature rises. On the other hand, when the temperature of the water supply path is higher than the ground temperature, or when the ground temperature exceeds the temperature of the water supply path and the temperature of the water supply path exceeds the irrigation suppression threshold value, this control device performs irrigation. By the control in which this prohibition of irrigation and performing of irrigation are combined, it is possible to achieve appropriate moisture supply that promotes growth while suppressing adverse effects on the plant.

The control device includes the processor 334 that determines whether to perform irrigation using the temperature of the water supply path of the water supply existing in the water supply path supplied with the irrigation water, and the signal output unit 332. The signal output unit 332 outputs a signal for draining the retained water in the water supply path when the processor 334 determines, at the performing timing of irrigation, that the temperature of the water supply path exceeds the drainage threshold value. Thereafter, the signal output unit 332 outputs a signal for performing irrigation. The signal output unit 332 outputs a signal for performing irrigation containing retained water when the processor 334 determines, at the performing timing of irrigation, that the temperature of the water supply path falls below the drainage threshold value.

This control device can perform appropriate-temperature irrigation after draining high-temperature retained water without releasing the retained water to the plant when the temperature of the water supply path exceeds the drainage threshold value. On the other hand, this control device performs irrigation containing appropriate-temperature retained water when the temperature of the water supply path falls below the drainage threshold value. By this control in which this drainage and performing of irrigation are combined, it is possible to achieve appropriate moisture supply that promotes growth while suppressing adverse effects on the growth of the plant.

### Sixth Embodiment

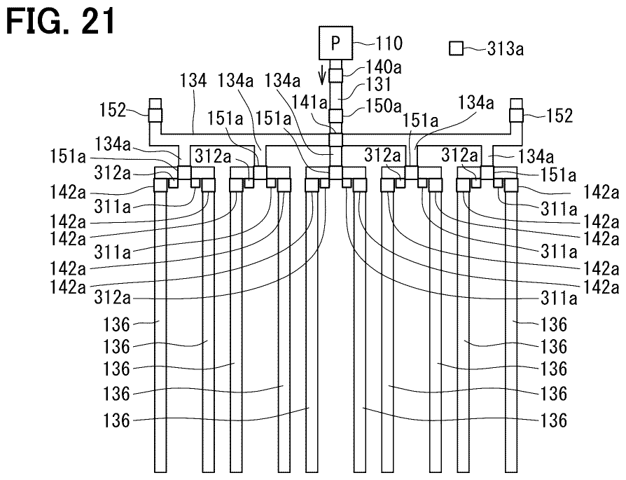

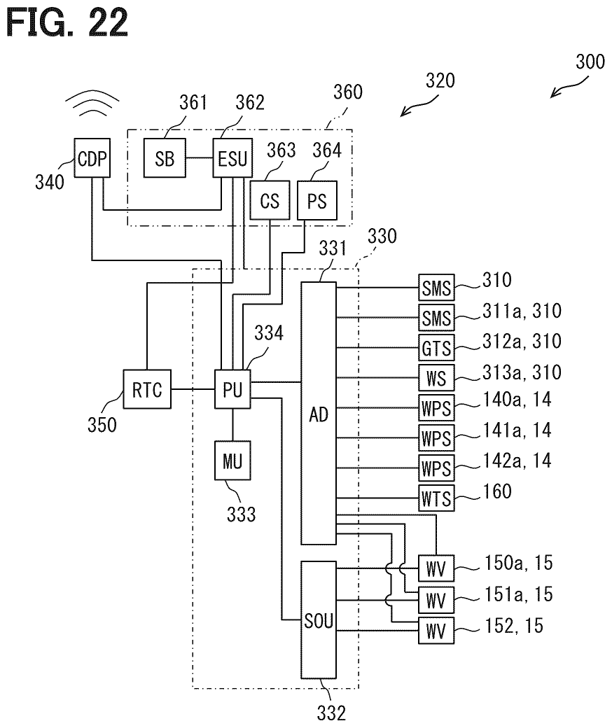

The sixth embodiment will be described with reference to FIGS. 21 and 22. The watering system 10 of the sixth embodiment is different from the fifth embodiment in including a weather sensor 313a in place of the water temperature sensor 160 illustrated in FIG. 17. Configurations, actions, and effects not specifically described in the sixth embodiment are the same as those of the above-described embodiment, and different points will be described below.

Specifically, the weather sensor 313a illustrated in FIGS. 21 and 22 is a sensor that detects information related to air temperature and solar radiation. The control device 200 acquires a detection value of the weather sensor 313a, and estimates the water temperature in the pipe of the water supply path using this detection value. The control device 200 uses the estimate value of this water temperature in place of the detection value of the water temperature in each processing of FIGS. 18 to 20. The control device 200 obtains a water temperature estimate value in the pipe from characteristic data stored in the storage unit 333 and the detection value of the weather sensor 313a. The characteristic data is data indicating the correlation between water temperature information and information related to air temperature and solar radiation. The control device 200 may be configured to acquire characteristic data from the outside via the integrated communication unit 400.

The control device 200 may be configured to acquire, in place of the detection value of the water temperature sensor 160 illustrated in FIG. 17, a weather forecast from the outside, and estimate the water temperature from data of the weather forecast.

### Seventh Embodiment

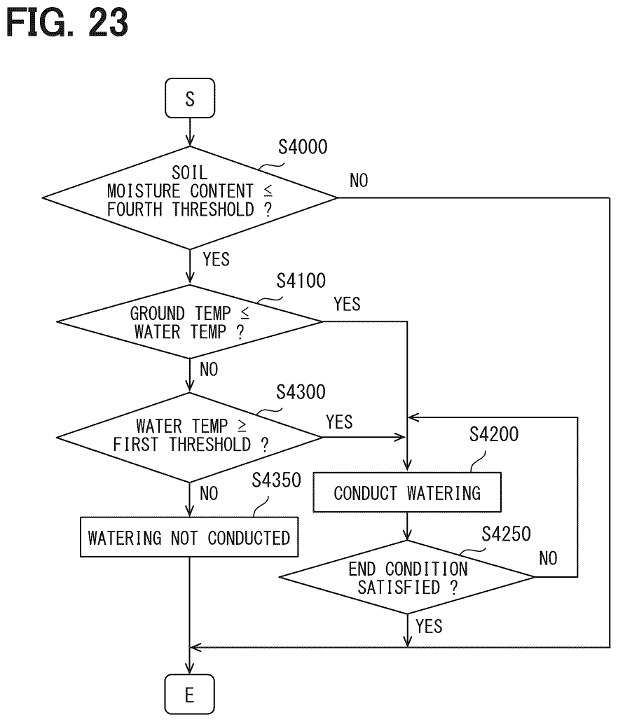

The seventh embodiment will be described with reference to FIG. 23. The watering system 10 of the seventh embodiment executes the processing according to the flowchart shown in FIG. 23 when performing the irrigation processing. The watering system 10 of the seventh embodiment is different in executing the processing shown in FIG. 23 in place of the processing shown in FIG. 18 of the fifth embodiment. Configurations, actions, and effects not specifically described in the seventh embodiment are the same as those of the above-described embodiment, and different points will be described below.

The control device 200 executes the processing shown in FIG. 23, the processing shown in FIG. 19, and the processing shown in FIG. 20 by, for example, the monitoring unit 300 or the integrated calculation unit 600. The processing shown in FIG. 23 is different from the processing shown in FIG. 18 only in step S4000. Therefore, steps S4100, S4200, S4250, S4300, and S4350 are similar to steps S1000, S1100, S1150, S1200, and S1250, respectively. That is, in the processing shown in FIG. 23, the determination processing of step S4000 is executed before the processing corresponding to FIG. 18 is performed.

Upon receiving the signal related to the irrigation processing output from the integrated calculation unit 600, the microcomputer 330 of the monitoring unit 300 executes the processing shown in FIG. 23. The processing shown in FIG. 23 is executed at the timing when the irrigation time comes or at the timing when the irrigation performing command is output, and is repeated several times a day, for example. The processing shown in FIG. 23 is executed in a period such as early spring or late autumn, for example. The acquisition unit 331 acquires the soil moisture content detected by the soil sensor 311a. In step S4000, the processor 334 determines whether the detection value of the soil moisture content is equal to or less than a fourth threshold value.

When the detection value of the soil water content exceeds the fourth threshold value, this flowchart is ended without performing irrigation. When the detection value of the soil water content is equal to or less than the fourth threshold value, the determination processing of step S4100 is executed. Hereinafter, steps S1000, S1100, S1150, S1200, and S1250, which are processing similar to those in FIG. 18, are executed.

When the soil water content exceeds the fourth threshold value, it is a state in which the water content of the soil that can be absorbed by the plant is sufficient to such an extent that it is not necessary to irrigate from now. In this state, when irrigation is performed to the plant, the soil is brought into an excessive water content state, which adversely affects the growth and causes a decrease in the yield of plant shipment.

The fourth threshold value is stored in the storage unit 333. For example, the fourth threshold value is a growth inhibition threshold value at which the soil water content has high possibility of inhibiting the growth of the plant if the irrigation is performed based on the past actual value. For example, the fourth threshold value is a value set based on past actual values of the soil water content and the irrigation amount, and soil water content data with which growth inhibition can be predicted based on the type of plant.

The watering system 10 can automatically and forcibly prohibit irrigation when the soil water content exceeds such the fourth threshold value at the performing timing of irrigation. When the soil water content shifts to a state of falling below the fourth threshold value, the watering system 10 can automatically release the irrigation stop and shift to necessity determination of performing irrigation. The watering system 10 can automatically shift from an irrigation prohibition state to the necessity determination of performing irrigation if the soil water content changes to a state of falling below the fourth threshold value at the performing timing of irrigation of the next time or thereafter. By executing this processing over again at each irrigation performing timing in one day, the watering system 10 can prohibit excessive irrigation, and can postpone inappropriate irrigation performing until the air temperature and water temperature increase. Before determining whether the ground temperature exceeds the water temperature, the control device 200 forcibly prohibits irrigation when the soil water content exceeds the growth inhibition threshold value.

The fourth threshold value needs not be a value stored in the storage unit 333, and may be configured to be input to the integrated calculation unit 600 by the user operating the input equipment 800. The watering system 10 can set, at any time, the fourth threshold value based on user's experience or the like. The watering system 10 can achieve both prohibition of an excessive irrigation amount and stopping and performing of irrigation depending on conditions suitable for the climate and environment of the land.

### Eighth Embodiment

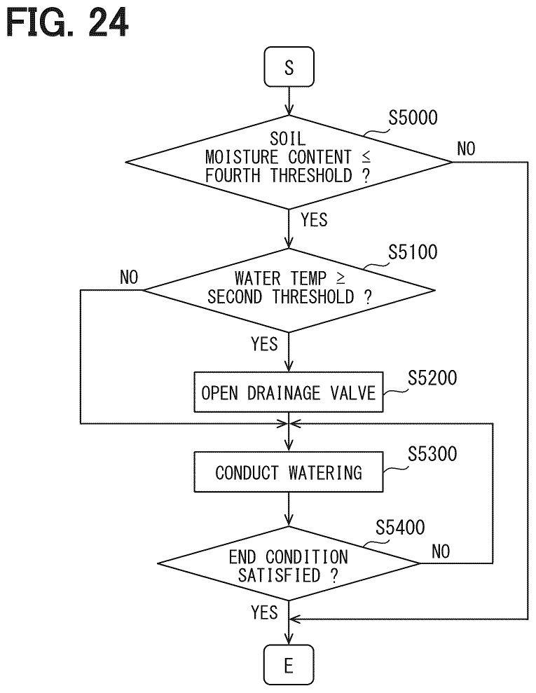

Then eighth embodiment will be described with reference to FIG. 24. The watering system 10 of the eighth embodiment executes the processing according to the flowchart shown in FIG. 24 when performing the irrigation processing. The watering system 10 of the eighth embodiment is different from the fifth embodiment in executing the processing shown in FIG. 24 in place of the processing shown in FIG. 19. Configurations, actions, and effects not specifically described in the eighth embodiment are the same as those of the fifth embodiment and the seventh embodiment, and different points will be described below.

The control device 200 executes the processing shown in FIG. 24, the processing shown in FIG. 18, and the processing shown in FIG. 20 by, for example, the monitoring unit 300 or the integrated calculation unit 600. That is, the processing shown in FIG. 24 can be replaced with the processing shown in FIG. 19 described in the fifth embodiment.

Upon receiving the signal related to the irrigation processing output from the integrated calculation unit 600, the microcomputer 330 executes the processing shown in FIG. 24. The processing shown in FIG. 24 is executed at the timing when the irrigation time comes or at the timing when the irrigation performing command is output, and is repeated several times a day, for example. The acquisition unit 331 acquires the soil water content detected by the soil sensor 311a. The processor 334 executes in step S5000 determination processing similar to that in step S4000 described above. Through this determination processing, the watering system 10 of the eighth embodiment achieves the same actions and effects as those described in the seventh embodiment. The seventh embodiment will be referred to for the content of the actions and effects.

When the soil water content falls below the fourth threshold value, the processor 334 determines in step S5100 whether the detection value of the temperature of the water supply path is equal to or greater than a second threshold value. The processing shown in FIG. 24 is executed in a period such as summer, for example.

When the detection value of the temperature of the water supply path falls below the second threshold value, the microcomputer 330 proceeds to step S5300 and executes the processing of performing irrigation. When the detection value of the temperature of the water supply path is equal to or greater than the second threshold value, in step S5200, the microcomputer 330 outputs a control signal for bringing the drainage valve 152 installed in the first coupling pipe 134 into the open state. By this processing, the retained water in the pipe of the water supply path is emitted to the outside from the drainage valve 152 that is opened, and is not discharged to the plant. Furthermore, since the pressure is released to the drainage valve 152 that is opened, the water retained in the distribution tube 136 is also drained to the outside through the drainage valve 152.

Next, step S5300 is executed to perform irrigation, and this irrigation is continued until the processor 334 determines in step of step S5400 that the end condition of irrigation is established. This end condition is the same as the end condition of the fifth embodiment. When it is determined in step S5400 that the end condition of irrigation is established, the microcomputer 330 controls the first water source valve into the fully closed state and ends the irrigation by water supply from the one end portion to the other end portion. Due to this, the flowchart shown in FIG. 24 is ended. By executing this processing over again at each irrigation performing timing in one day, the watering system 10 can prohibit excessive irrigation, and can postpone inappropriate irrigation performing until the air temperature and water temperature decrease. Before determining whether the temperature of the water supply path exceeds the drainage threshold value, the control device 200 forcibly prohibits irrigation when the soil water content exceeds the growth inhibition threshold value.

### Ninth Embodiment

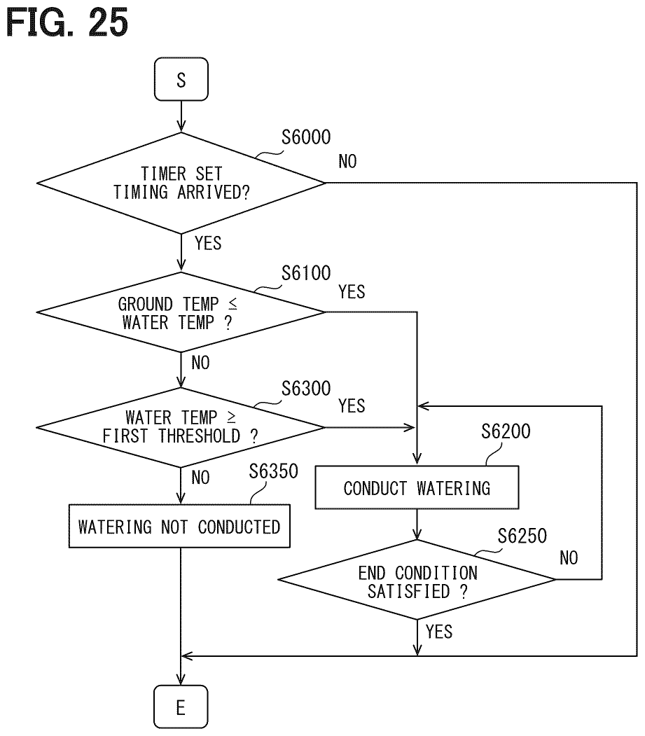

The ninth embodiment will be described with reference to FIG. 25. The watering system 10 of the ninth embodiment executes the processing according to the flowchart shown in FIG. 25 when performing the irrigation processing. The watering system 10 of the ninth embodiment is different in executing the processing of step S6000 shown in FIG. 25 in place of the processing of step S4000 of the seventh embodiment. Configurations, actions, and effects not specifically described in the ninth embodiment are the same as those of the above-described embodiment, and different points will be described below.

The control device 200 executes the processing shown in FIG. 25, the processing shown in FIG. 19, and the processing shown in FIG. 20 by, for example, the monitoring unit 300 or the integrated calculation unit 600. The processing shown in FIG. 25 is different from the processing shown in FIG. 23 only in step S6000. Therefore, steps S6100, S6200, S6250, S6300, and S6350 are similar to steps S1000, S1100, S1150, S1200, and S1250 in FIG. 18, respectively. That is, in the processing shown in FIG. 25, the determination processing of step S6000 is executed before the processing corresponding to FIG. 18 is performed.

Upon receiving the signal related to the irrigation processing output from the integrated calculation unit 600, the microcomputer 330 of the monitoring unit 300 executes the processing shown in FIG. 25. The processing shown in FIG. 25 is executed at the timing when the irrigation time comes or at the timing when the irrigation performing command is output, and is repeated several times a day, for example. The processing shown in FIG. 25 is executed in a period such as early spring or late autumn, for example. In step S6000, the processor 334 determines whether a timer setting time has come.

The processor 334 ends this flowchart when determining that the timer setting time has not come. When it is determined that the timer setting time has come, the determination processing of step S6100 is executed. Hereinafter, steps S1000, S1100, S1150, S1200, and S1250, which are processing similar to those in FIG. 18, are executed.

A signal indicating that the timer setting time has come is output from the RTC 350 to the processor 334. When acquiring this signal, the processor 334 determines that the timer setting time has come. The timer setting time is a time at which the ground temperature is detected, and is set in advance. The timer setting time may be configured to be input to the integrated calculation unit 600 by the user operating the input equipment 800. The watering system 10 can set, at any time, the timer setting time based on user's experience or the like.

### Tenth Embodiment

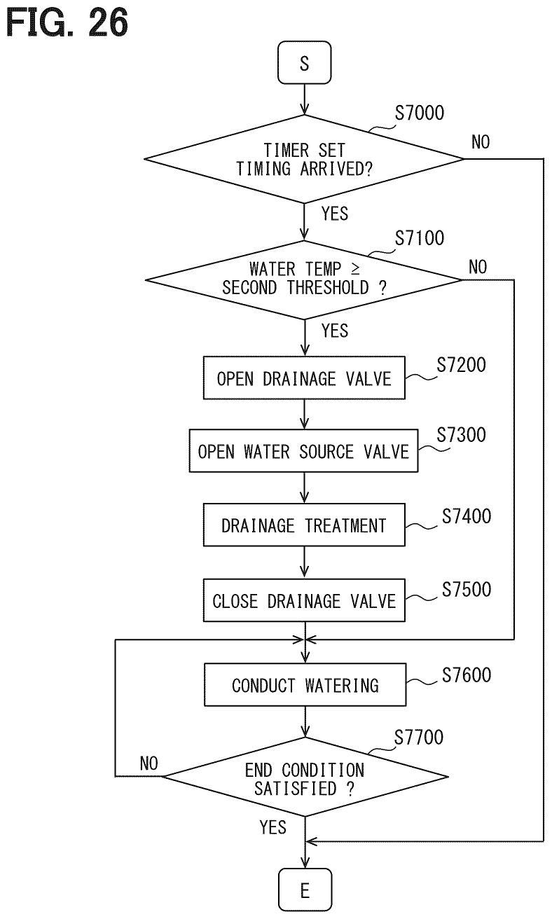

The tenth embodiment will be described with reference to FIG. 26. The watering system 10 of the tenth embodiment executes the processing according to the flowchart shown in FIG. 26 when performing the irrigation processing. The watering system 10 of the tenth embodiment is different in executing the processing shown in FIG. 26 in place of the processing shown in FIG. 18 of the fifth embodiment. Configurations, actions, and effects not specifically described in the tenth embodiment are the same as those of the above-described embodiment, and different points will be described below.

The control device 200 executes the processing shown in FIG. 26, the processing shown in FIG. 18, and the processing shown in FIG. 20 by, for example, the monitoring unit 300 or the integrated calculation unit 600. The processing shown in FIG. 26 is different from the processing shown in FIG. 18 only in step S7000. Therefore, steps S7100, S7200, S7300, S7400, S7500, S7600, and S7700 are similar to steps S2000, S2100, S2200, S2300, S2400, S2500, and S2600, respectively. That is, in the processing shown in FIG. 26, the determination processing of step S7000 is executed before the processing corresponding to FIG. 19 is performed.

The processing shown in FIG. 26 is executed at the timing when the irrigation time comes or at the timing when the irrigation performing command is output, and is repeated several times a day, for example. The processor 334 executes in step S7000 determination processing similar to that in step S6000 described above. Through this determination processing, the watering system 10 of the tenth embodiment achieves the same actions and effects as those described in the ninth embodiment. The ninth embodiment will be referred to for the content of the actions and effects.

### Eleventh Embodiment

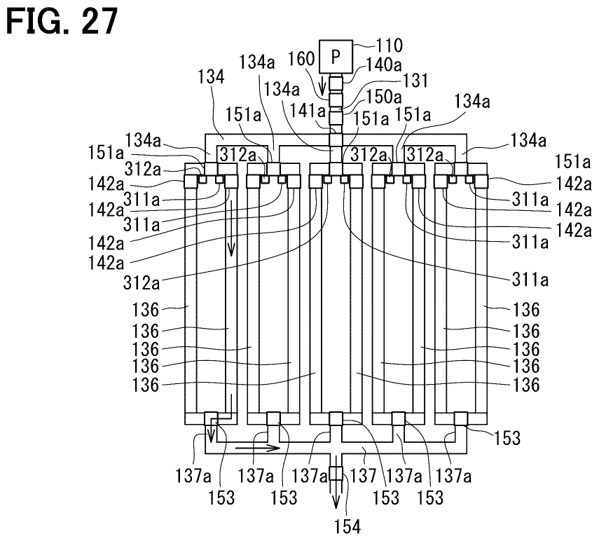

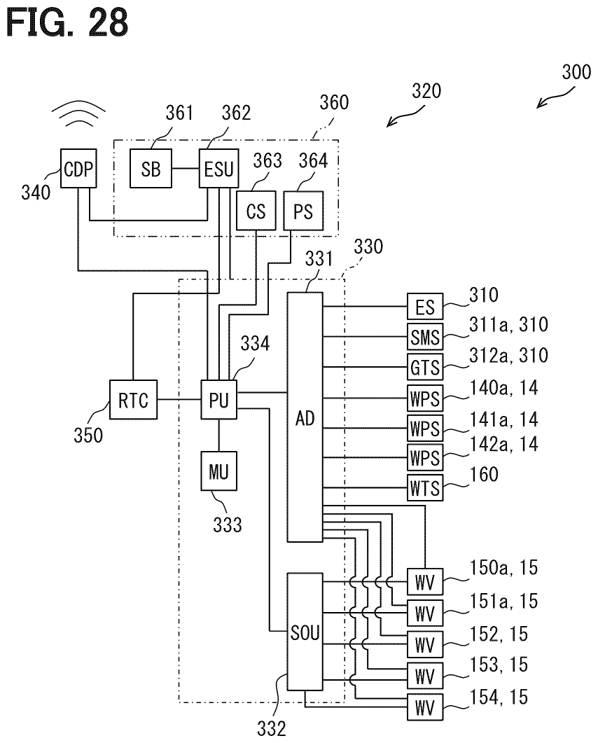

The eleventh embodiment will be described with reference to FIGS. 27 and 28. The watering system 10 of the eleventh embodiment is different from the fifth embodiment in the passage configuration on the other end portion side of the distribution tube 136. Configurations, actions, and effects not specifically described in the eleventh embodiment are the same as those of the above-described embodiment, and different points will be described below.

The watering system 10 of the eleventh embodiment illustrated in FIG. 27 includes a drainage passage more downstream than the distribution tubes 136. The other end portions of the distribution tubes 136 communicate with a second coupling pipe 137. The other end portion of the distribution tube 136 is also a downstream end portion of the distribution tube 136. The second coupling pipe 137 is connected to one drain pipe at a downstream site, and is connected to branch pipes 137a at an upstream site. The branch pipes 137a constitute passages joined to the second coupling pipe 137. Each branch pipe 137a couples the downstream end portions of the predetermined number of distribution tubes 136 forming one group and the second coupling pipe 137. The branch pipes 137a are passages coupling the distribution tubes 136 and the second coupling pipe 137.

The upstream site of the branch pipe 137a is provided with a water source valve 153 for opening and closing the passage. One branch pipe 137a is provided so as to flow down drainage from the predetermined number of distribution tubes 136 forming one group flows down. The drain pipe more downstream than the second coupling pipe 137 is provided with a drainage valve 154 that opens and closes the passage. When drainage valve 152 is in the open state, the water in the water supply path can be emitted to the outside through the distribution tube 136, the second coupling pipe 137, the branch pipe 137a, and the drainage valve 154. The water source valve 153 and the drainage valve 154 are second water source valves that open and close the passage on the other end portion side of the distribution tube 136.

By controlling the valve opening degree of each water source valve 151a, the watering system 10 causes the water source valve 151a to function as a flow regulating valve to perform water supply at a low flow rate. Each distribution tube 136 has a characteristic of discharging water from each through hole in a predetermined pressure range.

FIG. 28 illustrates a control configuration in the watering system 10 of the eleventh embodiment. As described above, when draining retained water and retained water in the pipe, the microcomputer 330 outputs a control signal for bringing the water source valve 151a leading to the drainage path among the water source valves 151a into the open state. At this time, the microcomputer 330 controls the valve opening degree of the water source valve 151a so as to have internal pressure outside the predetermined pressure range where no water is discharged from the distribution tube 136. Furthermore, the microcomputer 330 outputs a control signal for bringing the water source valve 153 leading to the drainage path and the drainage valve 154 into the open state. This enables the watering system 10 to drain the retained water in the water supply path or the like from the other end portion side of the distribution tube 136 to the outside while suppressing discharge of water to the ridge.

### Twelfth Embodiment

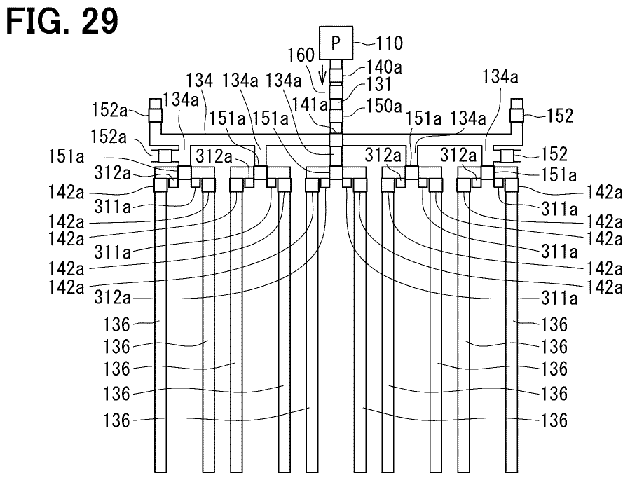

The twelfth embodiment will be described with reference to FIG. 29. The watering system 10 of the twelfth embodiment is different from each of the above-described embodiments in the number of the drainage valves 152. Configurations, actions, and effects not specifically described in the twelfth embodiment are the same as those of the above-described embodiment, and different points will be described below.

The watering system 10 of the twelfth embodiment illustrated in FIG. 29 includes more drainage valves 152 than the configuration illustrated in FIG. 17 does. The watering system 10 of the twelfth embodiment includes one or plural drainage valves 152 that open and close a passage branching from the branch pipe 134a. When this drainage valve 152 is in the open state, water in the branch pipe 134a or the like can be emitted to the outside through the drainage valve 152.

### OTHER EMBODIMENTS

The disclosure of this description is not limited to the illustrated embodiments. The disclosure includes the illustrated embodiments and modifications based thereon by those skilled in the art. For example, the disclosure is not limited to the combination of components and elements presented in the embodiments, and various modifications can be made. The disclosure can be performed by various combinations. The disclosure can have additional parts that can be added to the embodiments. The disclosure includes those in which components and elements of the embodiments are omitted. The disclosure includes replacement or combination of components and elements between one embodiment and other embodiments. The disclosed technical scope is not limited to the description of the embodiments. The disclosed technical scope is indicated by the description of the claims, and should be understood to include meanings equivalent to the description of the claims and all modifications within the scope.

Each constituent element illustrated in FIGS. 1 and 2 is functionally conceptual, and does not necessarily need to be physically configured as illustrated in the drawings. For example, specific forms of distribution and integration of functional blocks are not limited to those illustrated in the drawings, and all or some of them can be functionally or physically distributed or integrated in arbitrary units in accordance with various loads, usage conditions, and the like.

The control device 200 may be configured to concurrently execute all of the processing shown in FIG. 18, the processing shown in FIG. 19, and the processing shown in FIG. 20 at the performing timing of irrigation. In this case, when the condition for performing drainage or prohibiting irrigation is established in any processing, the processing for performing drainage or prohibiting irrigation is executed according thereto.

The above-described embodiments may be configured to include a sensor device in which a water pressure sensor and a water temperature sensor are integrated, and configured such that this sensor device detects the water pressure and the water temperature in the pipe. The above-described embodiments may be configured to include a device in which various sensors and valves are integrated, and configured such that this device detects various types of water supply information and performs a passage open-close function.

The devices and the methods thereof described in the present disclosure may be implemented by a dedicated computer constituting a processor programmed so as to execute one or plural functions embodied by a computer program. Alternatively, the devices and the methods thereof described in the present disclosure may be implemented by a dedicated hardware logic circuit. Alternatively, the devices and the methods thereof described in the present disclosure may be implemented by one or more dedicated computers configured by a combination of a processor that executes a computer program and one or more hardware logic circuits. The computer program may be stored in a computer-readable non-transitory tangible recording medium as an instruction executed by the computer.

What is claimed is:

1. A watering system comprising:
a water supply path supplied with water to be released to a plant;
a pF sensor that detects a pF value, which is an environment value related to a soil condition;
a VWC sensor that detects a volume water content, which is an environment value related to a soil condition; and
a control device configured to control an irrigation operation of releasing water to a plant via the water supply path using the pF value detected by the pF sensor and the volume water content detected by the VWC sensor, wherein
the control device controls a start timing of the irrigation operation based on the pF value that is detected and a start threshold value, and controls a stop timing of the irrigation operation, that is in operation, based on the volume water content that is detected and a stop threshold value, and
the control device updates the stop threshold value based on fluctuation of the pF value that is detected.

2. The watering system according to claim 1, wherein the control device updates the stop threshold value such that a next irrigation operation time is shortened when the pF value that is detected fluctuates in a direction in which a soil condition is wetted.

3. The watering system according to claim 1, wherein the control device updates the stop threshold value such that a next irrigation operation time is lengthened when the pF value that is detected fluctuates in a direction in which the soil condition is dried.

4. The watering system according to claim 1, wherein the control device updates the stop threshold value based on fluctuation of the pF value that is detected while an irrigation operation is stopped.

5. The watering system according to claim 1, wherein the control device updates the stop threshold value to be a lower value when the pF value that is detected deviates below a control range of the pF value that is set as an appropriate fluctuation range.

6. The watering system according to claim 1, wherein the control device updates the stop threshold value to be a higher value when the pF value that is detected deviates over a control range of the pF value that is set as an appropriate fluctuation range.

7. The watering system according to claim 1, wherein the control device stores the pF value and the volume water content that are detected during an irrigation operation and while an irrigation operation is stopped, or displays the pF value and the volume water content on a display unit browsable by a user.

8. The watering system according to claim 1, wherein
the control device obtains moisture retention characteristic information indicating a soil condition by using the pF value that is detected and the volume water content that is detected, and
the control device stores the moisture retention characteristic information or displays the moisture retention characteristic information on a display unit browsable by a user.

9. A control device comprising:
an acquisition unit configured to acquire a pF value, which is an environment value related to a soil condition, detected by a pF sensor, and a volume water content, which is an environment value related to a soil condition, detected by a VWC sensor; and
a processor configured to control an irrigation operation of releasing water to a plant via a water supply path using the pF value detected by the pF sensor and the volume water content detected by the VWC sensor, wherein
the processor controls a start timing of the irrigation operation based on the pF value that is detected and a start threshold value, and controls a stop timing of the irrigation operation that is in operation based on the volume water content that is detected and a stop threshold value, and
the processor updates the stop threshold value based on fluctuation of the pF value that is detected.

10. A watering system comprising:
a water supply path supplied with irrigation to be released to a plant;
a temperature sensor that detects a temperature of the water supply path;
a ground temperature sensor that detects a ground temperature; and
a control device configured to control an irrigation amount using a ground temperature detected by the ground temperature sensor and a temperature detected by the temperature sensor, wherein
at a timing of performing irrigation, the control device is configured to
reduce an irrigation amount when the ground temperature exceeds a temperature of the water supply path and the temperature of the water supply path falls below an irrigation suppression threshold value, and
increase an irrigation amount more than a case where the ground temperature exceeds the temperature of the water supply path and the temperature of the water supply path falls below the irrigation suppression threshold value, when the ground temperature is equal to or less than the temperature of the water supply path, or when the ground temperature exceeds the temperature of the water supply path and the temperature of the water supply path exceeds the irrigation suppression threshold value.

11. A watering system comprising:
a water supply path supplied with irrigation to be released to a plant;
a temperature sensor that detects a temperature of the water supply path;
a ground temperature sensor that detects a ground temperature; and
a control device configured to control an irrigation amount using a ground temperature detected by the ground temperature sensor and a temperature detected by the temperature sensor, wherein
at a timing of performing irrigation, the control device is configured to
prohibit irrigation when the ground temperature exceeds a temperature of the water supply path and the temperature of the water supply path falls below an irrigation suppression threshold value, and
perform the irrigation when the ground temperature is equal to or less than the temperature of the water supply path or when the ground temperature exceeds the temperature of the water supply path and the temperature of the water supply path exceeds the irrigation suppression threshold value.

12. The watering system according to claim 11, wherein
before determining whether the ground temperature exceeds the temperature of the water supply path, the control device forcibly prohibits irrigation when a soil water content exceeds a growth inhibition threshold value, which is a value at which a possibility of inhibiting growth of the plant is high.

13. The watering system according to claim 11, wherein the temperature of the water supply path is a water temperature of water supply existing in the water supply path.

14. The watering system according to claim 11, wherein the temperature of the water supply path is a temperature of a pipe forming the water supply path.

15. The watering system according to claim 11, wherein the ground temperature detected by the ground temperature sensor is a temperature of soil in a field.

16. The watering system according to claim 11, wherein the ground temperature detected by the ground temperature sensor is a temperature of a natural lawn ground.

17. A control device comprising:
a processor configured to determine whether to perform irrigation using a temperature of a water supply path supplied with irrigation to be released to a plant and a ground temperature; and
a signal output unit configured to, at a timing of performing irrigation,
output a signal to prohibit irrigation when the processor determines that the ground temperature exceeds the temperature of the water supply path and the temperature of the water supply path falls below an irrigation suppression threshold value, and
output a signal to prohibit irrigation when the processor determines that the ground temperature is equal to or less than the temperature of the water supply path, and output a signal to perform irrigation when the processor determines that the ground temperature is equal to or less than the temperature of the water supply path, or when the processor determines that the ground temperature exceeds the temperature of the water supply path and the temperature of the water supply path exceeds the irrigation suppression threshold value.

18. A control device comprising:
a processor configured to determine whether to perform irrigation using a temperature of a water supply path supplied with irrigation to be released to a plant; and
a signal output unit configured to, at a timing of performing irrigation,
output a signal to perform irrigation after outputting a signal to drain retained water in the water supply path without releasing the retained water to the plant when the processor determines that the temperature of the water supply path exceeds a drainage threshold value, and
output a signal to perform irrigation containing the retained water when the processor determines that the temperature of the water supply path falls below the drainage threshold value.
